(19) United States
(12) Patent Application Publication
(10) Pub. No.: US 2023/0390826 A1
(43) Pub. Date: Dec. 7, 2023

(54) COORDINATED CONTROL FOR FORMING THREE-DIMENSIONAL OBJECTS

(71) Applicant: Velo3D, Inc., Campbell, CA (US)

(72) Inventors: Benyamin Buller, Cupertino, CA (US); Tasso Lappas, Pasadena, CA (US); Sergey Korepanov, Los Altos, CA (US); Clarke S. Watson, San Carlos, CA (US); Roman Novoselov, San Jose, CA (US)

(21) Appl. No.: 18/197,861

(22) Filed: May 16, 2023

Related U.S. Application Data
(63) Continuation of application No. 18/096,721, filed on Jan. 13, 2023.
Application No. 18/096,721 is a continuation of application No. 17/951,239, filed on Sep. 23, 2022, now abandoned.
Application No. 17/951,239 is a continuation of application No. 17/841,804, filed on Jun. 16, 2022, now abandoned.
Application No. 17/841,804 is a continuation of application No. 17/690,722, filed on Mar. 9, 2022, now abandoned.
Application No. 17/690,722 is a continuation of application No. 17/534,784, filed on Nov. 24, 2021, now abandoned.
Application No. 17/534,784 is a continuation of application No. 17/394,500, filed on Aug. 5, 2021, now abandoned.
Application No. 17/394,500 is a continuation of application No. 17/222,232, filed on Apr. 5, 2021, now abandoned.
Application No. 17/222,232 is a continuation of application No. PCT/US19/54837, filed on Oct. 4, 2019.
(60) Provisional application No. 62/742,248, filed on Oct. 5, 2018.

(51) Int. Cl. B22F 12/90; B22F 10/28

(52) U.S. Cl. CPC B22F 12/90; B22F 10/28

(57) ABSTRACT

Provided herein are apparatuses, and non-transitory computer readable media regarding at least one controller that provides a capability to coordinate (e.g., integrate) control of a plurality of process variables for forming a 3D object, and methods associated therewith. The process variable may comprise a process parameter of the forming process and/or an attribute of the forming process. The control may comprise an integrated and/or adaptive control scheme of a plurality control variables.

### CROSS-REFERENCE

This application is a continuation of U.S. patent application Ser. No. 18/096,721 filed Jan. 12, 2023, which is a continuation of U.S. patent application Ser. No. 17/951,239 filed Sep. 23, 2022, which is a continuation of U.S. patent application Ser. No. 17/841,804 filed Jun. 16, 2022, which is a continuation of U.S. patent application Ser. No. 17/690,722 filed Mar. 9, 2022, which is a continuation of U.S. patent application Ser. No. 17/534,784 filed Nov. 24, 2021, which is a continuation of U.S. patent application Ser. No. 17/394,500 filed Aug. 5, 2021, which is a continuation of U.S. patent application Ser. No. 17/222,232 filed Apr. 5, 2021, which is a continuation of PCT/US19/054837 filed Oct. 4, 2019, which claims the benefit of U.S. Provisional Patent Application No. 62/742,248, filed Oct. 5, 2018, which are each incorporated by reference in its entirety.

### BACKGROUND

Three-dimensional objects may be formed using various methodologies, for example, molding, sculpting, or three-dimensional printing. Three-dimensional (3D) printing (e.g., additive manufacturing) is a process for making a three-dimensional object of any shape from a design. The design may be in the form of a data source, such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed, and thereafter successive layers of hardened material are added one by one, wherein each new layer of hardened material is added on a pre-formed layer of hardened material, until the entire designed three-dimensional structure (3D object) is layer-wise materialized.

3D models may be generated with a computer-aided design package, via a 3D scanner, or manually. The modeling process of preparing geometric data for 3D computer graphics may be similar to those of the plastic arts, such as sculpting or animating. 3D scanning is a process of analyzing and collecting digital data on the shape and appearance of a real object (e.g., real-life object). Based on these data, 3D models of the scanned object can be produced.

Many additive processes are currently available. They may differ in the manner layers are deposited and/or formed to create the materialized structure. They may vary in the material(s) that are used to generate the designed structure. Some methods melt and/or soften material to produce the layers. Examples of 3D printing methods comprise selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, and/or metal) are cut to shape and joined together.

In some instances, a plurality of (e.g., process) variables affect formation of at least a portion of a 3D object. Some of these variables may be controlled in a coordinated or a non-coordinated manner. Lack of coordination between some control variables may promote manifestation of at least one defect in the formed 3D object. For example, lack of coordination between two or more control variables may form a 3D object that deviates from at least one requested geometry parameter and/or material property. The geometry parameter may comprise a shape, or a fundamental length scale in a given direction. The material property may include surface roughness and/or microstructure. At times, a processing operation for generating a selected effect in at least a portion of a 3D object proceeds quicker or slower than an estimated time for generating the selected effect. Inaccurate timing for execution of a processing operation to achieve a selected effect may promote manifestation of at least one defect in the formed 3D object.

### SUMMARY

At times, a capability to coordinate control of one or more process variables for forming at least a portion of a 3D object (e.g., the entire 3D object) is provided by at least one controller. The control variable may be a process variable that may be (e.g., at least indirectly) controlled. In some embodiments, a controller provides integrated and/or adaptive control of at least one control variable. In some embodiments, integrated control comprises coordinated control of at least two control variables to form one or more portions of 3D object (e.g., the entire 3D object). In some embodiments, adaptive control comprises adaptive timing for execution of a sequence of material processing operations (e.g., adaptive control) for generating at least a portion of a 3D object. Adaptive control may contrast a timing of pre-determined duration, Adaptive control may comprise deterministic timing for at least one processing operation of a plurality of material processing operations.

The operations of any of the methods, non-transitory computer readable media, and/or controller directions described herein can be in any order. At least two of the operations in any of the methods, non-transitory computer readable media, and/or controller(s) can be performed simultaneously.

In another aspect, a method for forming a three-dimensional object comprises: executing a first process parameter at a first time according to a first plan; executing a second process parameter at a second time according to a second plan; measuring an attribute of the forming; and coordinating the first time with the second time to reach a target attribute profile of the attribute.

In some embodiments, the attribute of the forming comprises a temperature at a target surface, or an intensity of a transforming agent. In some embodiments, the attribute of the forming comprises a temperature at a footprint of the transforming agent on the target surface. In some embodiments, the transforming agent is an energy beam. In some embodiments, executing the first process parameter and executing the second process parameter is while measuring the attribute of the forming. In some embodiments, measuring the attribute is in real time during the forming the three-dimensional object. In some embodiments, the method further comprises changing a control command to the first process parameter or to the second process parameter. In some embodiments, changing the control command to the first process parameter is during (a) and/or (b). In some embodiments, changing the control command is for reaching a target temperature profile. In some embodiments, changing the control command occurs while coordinating the first time with the second time. In some embodiments, coordinating the first time with the second time comprises fixing or substantially fixing a relative time between (a) and (b). In some embodiments, the relative time is zero or greater than zero. In some embodiments, substantially fixing comprises a variability (e.g., error) between executing in (a) and executing in (b), between executing in (a) and executing in (c), or between exacting in (b) and executing in (c). In some embodiments, the variability is at most 100 microseconds. In some embodiments, the variability is at most 300 microseconds. In some embodiments, the variability is at most 1000 microseconds. In some embodiments, the method further comprises before (d), executing a third process parameter at a third time according to a third plan. In some embodiments, coordinating is of the first time with the second time and with the third time, to optimize forming of the three-dimensional object. In some embodiments, (i) executing the first process parameter, (ii) executing the second process parameter, and/or (iii) executing the third process parameter, is during forming of the three-dimensional object. In some embodiments, (i) executing the first process parameter, (ii) executing the second process parameter, and/or (iii) executing the third process parameter, is to print the three-dimensional object. In some embodiments, the third plan comprises a third profile of the third process parameter. In some embodiments, the method comprises: (I) executing the first process parameter (e.g., profile of motion commands of a scanner), while (II) executing the second process parameter (e.g., a profile of motion commands of a focusing element), while (III) executing the third process parameter (e.g., controlling a power profile of a laser), while (IV) measuring the attribute (e.g., a temperature, e.g., at a target surface); and (V) changing a control command of the third process parameter (e.g., power control commands to the laser), to reach a target profile of the attribute (e.g., such that a relative time between all these control profiles is fixed). In some embodiments, executing the first process parameter comprises executing a profile of motion commands of a scanner. In some embodiments, executing the second process parameter comprises executing a profile of motion commands of a focusing element. In some embodiments, executing the second process parameter comprises controlling a power profile of a laser. In some embodiments, measuring the attribute comprises measuring a temperature. In some embodiments, the attribute is at and/or from a target surface. In some embodiments, changing the control command comprises changing a power control command to an energy source. In some embodiments, the target profile of the attribute comprises a target temperature profile. In some embodiments, the method further comprises fixing a relative time between at least two of (e.g., all of) (I)-(V). In some embodiments, the first plan comprises a first profile of the first process parameter. In some embodiments, the second plan comprises a second profile of the second process parameter. In some embodiments, the first process parameter is (i) a motion command of a guidance element (e.g., a scanner), (ii) a motion command of an optical (e.g., focusing) element, or (iii) a power profile of a transforming agent generator. In some embodiments, the guidance element is operatively coupled with an actuator. In some embodiments, the first process parameter and the second process parameter are selected from a group consisting of: a characteristic of a transforming agent, a characteristic of a transforming agent generator, and a metrology. In some embodiments, the first process parameter is different from the second process parameter. In some embodiments, the first process parameter and the second process parameter are selected from a group consisting of: a characteristic of an energy beam, a characteristic of an energy source, and a position of a footprint of the energy beam on a target surface. In some embodiments, the first process parameter is different from the second process parameter. In some embodiments, the first process parameter and the second process parameter are selected from a group consisting of: a position of a footprint of an energy beam at a target surface, a power of an energy source that generates the energy beam, a power density of the energy beam, a fluence of the energy beam, and a focus of the footprint of the energy beam at the target surface. In some embodiments, the first process parameter is different from the second process parameter. In some embodiments, the first process parameter and the second process parameter are selected from a group consisting of: a position, a power, and a motion. In some embodiments, the first process parameter is different from the second process parameter. In some embodiments, the position may comprise a position profile. In some embodiments, the motion may comprise a motion profile. In some embodiments, the power may comprise a power profile. In some embodiments, the motion is: of a guiding mechanism (e.g., scanner), and/or of an optical element (e.g., lens, e.g., focusing lens). In some embodiments, the first process parameter relates to a first component utilized in the forming. In some embodiments, the second process parameter relates to a second component utilized in the forming. In some embodiments, coordination of the first time with the second time comprises sequential, or concurrent execution of the first plan with respect to the second plan. In some embodiments, coordination of the first time with the second time comprises sequential, or concurrent occurrence of the first time with respect to the second time. In some embodiments, coordination of the first time with the second time comprises adjusting execution of the first plan with respect to the second plan. In some embodiments, coordination of the first time with the second time comprises adjusting occurrence of the first time with respect to the second time. In some embodiments, during at least a portion of the second time, the first process parameter is not engaged with forming the three-dimensional object. In some embodiments, during the second time, the first process parameter is not engaged with forming the three-dimensional object. In some embodiments, during at least a first portion of the second time, the first process parameter transitions from a first state to a second state. In some embodiments, the second state is a requested state of the first process parameter, which first process parameter is engaged in the forming (i) after the second time and/or (ii) during at least a second portion of the second time that precedes the first portion of the second time. In some embodiments, the first process parameter includes at least one characteristic of: an energy beam, an energy source, a scanner, or an actuator. In some embodiments, the at least one characteristic of the energy source comprises power. In some embodiments, the at least one characteristic of the scanner comprises a position of an optical element of the scanner, or an actuator that is operatively coupled to the scanner. In some embodiments, the at least one characteristic of the energy beam comprises a trajectory, a speed, a power density, a focus at a target surface, or a fundamental length scale of a footprint of the energy beam on the target surface. In some embodiments, executing the first process parameter and/or the second process parameter considers a signal from a sensor. In some embodiments, the signal is related to a position of the footprint relative to the target surface, a temperature of target surface at the footprint, a power of the energy source, a position of at least one optical element of the scanner, a status of the actuator, a focus of the energy beam at the target surface. In some embodiments, the status of the actuator comprises a power of the actuator and/or a position of at least one component of the actuator. In some embodiments, the first process parameter and the second process parameter are the same. In some embodiments, the first process parameter and the second process parameter are different.

In another aspect, an apparatus for forming a three-dimensional object comprises: at least one controller that is configured to be operatively coupled to (e.g., using a communication component) a first component utilized during formation of a three-dimensional object, a second component utilized during formation of the three-dimensional object, and to at least one sensor, which at least one controller is configured to: direct the first component to execute a first process parameter at a first time according to a first plan; direct the second component to execute a second process parameter at a second time according to a second plan; direct the at least one sensor to measure an attribute of the forming; and coordinate the first time with the second time to reach a target attribute profile of the attribute.

In some embodiments, at least one of (i) the first component and (ii) the second component comprises or is configured to generate a transforming agent. In some embodiments, the attribute of the forming comprises a temperature at a target surface, or an intensity of the transforming agent. In some embodiments, the attribute of the forming comprises a temperature at a footprint of the transforming agent on the target surface. In some embodiments, the transforming agent is an energy beam. In some embodiments, the at least one controller is configured to direct the first component to execute the first process parameter and the second component to execute the second process parameter while directing the at least one sensor to measure the attribute of the forming. In some embodiments, the at least one controller is configured to direct the at least one sensor to measure the attribute in real time during the forming the three-dimensional object. In some embodiments, the at least one controller is configured to modify a control command to the first component to change the first process parameter, or to the second component to change the second process parameter. In some embodiments, the at least one controller is configured to modify the control command to the first component during (a) and/or (b). In some embodiments, the at least one controller is configured to modify the control command to reach a target temperature profile. In some embodiments, the at least one controller is configured to modify the control command and to coordinate the first time with the second time, at a same time (e.g., concurrently). In some embodiments, the at least one controller is configured to fix (or substantially fix) a relative time between (a) and (b) to coordinate the first time with the second time. In some embodiments, the relative time is zero or greater than zero. In some embodiments, to substantially fix comprises a variability (e.g., error) between an execution in (a) and an execution in (b), between the execution in (a) and an execution in (c), or between the execution in (b) and the execution in (c). In some embodiments, the variability is at most 100 microseconds. In some embodiments, the variability is at most 300 microseconds. In some embodiments, the variability is at most 1000 microseconds. In some embodiments, the at least one controller is operatively coupled with a third component utilized during formation of the three-dimensional object. In some embodiments, the at least one controller is configured to direct, before (d), the third component to execute a third process parameter at a third time according to a third plan. In some embodiments, the at least one controller is configured to coordinate the first time with the second time and with the third time, to optimize forming of the three-dimensional object. In some embodiments, the at least one controller is configured to (i) direct the first component to execute the first process parameter, (ii) direct the second component to execute the second process parameter, and/or (iii) direct the third component to execute the third process parameter, during forming of the three-dimensional object. In some embodiments, the at least one controller is configured to (i) direct the first component to execute the first process parameter, (ii) direct the second component to execute the second process parameter, and/or (iii) direct the third component to execute the third process parameter, to print the three-dimensional object. In some embodiments, the third plan comprises a third profile of the third process parameter. In some embodiments, the at least one controller is configured to direct (I) the first component to execute the first process parameter (e.g., profile of motion commands of a scanner), (II) the second component to execute the second process parameter (e.g., a profile of motion commands of a focusing element), (III) the third component to execute the third process parameter (e.g., controlling a power profile of a laser), (IV) the at least one sensor to measure the attribute (e.g., a temperature, e.g., at a target surface), during a same time (e.g., concurrently); and (V) to modify a control command to the third component to change the third process parameter (e.g., power control commands to the laser), to reach a target profile of the attribute (e.g., such that a relative time between all these control profiles is fixed). In some embodiments, to execute the first process parameter comprises execution of a profile of motion commands of a scanner. In some embodiments, to execute the second process parameter comprises execution of a profile of motion commands of a focusing element. In some embodiments, to execute the second process parameter comprises direction of the third component to control a power profile of a laser. In some embodiments, to measure the attribute comprises to measure a temperature. In some embodiments, the attribute is at and/or from a target surface. In some embodiments, to modify the control command comprises to modify a power control command to an energy source. In some embodiments, the target profile of the attribute comprises a target temperature profile. In some embodiments, the apparatus (e.g., the at least one controller) is further configured to fix a relative time between at least two of (e.g., all of) (I)-(V). In some embodiments, the first plan comprises a first profile of the first process parameter. In some embodiments, the second plan comprises a second profile of the second process parameter. In some embodiments, the first component comprises a guidance element (e.g., a scanner), an optical (e.g., focusing) element, or a transforming agent generator. In some embodiments, the first process parameter is (i) a motion command of the guidance element, (ii) a motion command of the optical element, or (iii) a power profile of the transforming agent generator. In some embodiments, the at least one controller is operatively coupled with an actuator, which actuator is operatively coupled with the guidance element. In some embodiments, the first component and/or the second component are selected from a group consisting of: a transforming agent generator, a transforming agent, and a metrology. In some embodiments, the first process parameter and the second process parameter are selected from a group consisting of: a characteristic of the transforming agent, a characteristic of the transforming agent generator, and the metrology. In some embodiments, the first process parameter is different from the second process parameter. In some embodiments, the first component and/or the second component are selected from a group consisting of: an energy source, an energy beam, and a guiding mechanism (e.g., a scanner). In some embodiments, the first process parameter and the second process parameter are selected from a group consisting of: a characteristic of the energy beam, a characteristic of the energy source, and a position of a footprint of the energy beam on a target surface. In some embodiments, the first process parameter is different from the second process parameter. In some embodiments, the first component and/or the second component are selected from a group consisting of: an energy source, an energy beam, and a guiding mechanism (e.g., a scanner). In some embodiments, the first process parameter and the second process parameter are selected from a group consisting of: a position of a footprint of the energy beam at a target surface, a power of the energy source that generates the energy beam, a power density of the energy beam, a fluence of the energy beam, and a focus of the footprint of the energy beam at the target surface. In some embodiments, the first process parameter is different from the second process parameter. In some embodiments, the first process parameter and the second process parameter are selected from a group consisting of: a position, a power, and a motion, and wherein the first process parameter is different from the second process parameter. In some embodiments, the position may comprise a position profile. In some embodiments, the motion may comprise a motion profile. In some embodiments, the power may comprise a power profile. In some embodiments, the first component and/or the second component comprise a guiding mechanism (e.g., a scanner) or an optical element (e.g., lens, e.g., focusing lens). In some embodiments, the motion is: of the guiding mechanism (e.g., scanner), and/or of the optical element (e.g., lens, e.g., focusing lens). In some embodiments, the at least one controller is configured to sequentially or concurrently execute the first plan with respect to the second plan, to coordinate the first time with the second time. In some embodiments, to coordinate the first time with the second time comprises sequential, or concurrent occurrence of the first time with respect to the second time. In some embodiments, the at least one controller is configured to adjust an execution of the first plan with respect to the second plan, to coordinate the first time with the second time. In some embodiments, the at least one controller is configured to adjust an occurrence of the first time with respect to the second time, to coordinate the first time with the second time. In some embodiments, the at least one controller is configured to direct the first component to execute the first process parameter to not be engaged with forming the three-dimensional object during at least a portion of the second time. In some embodiments, the at least one controller is configured to direct the first component to execute the first process parameter to not be engaged with forming the three-dimensional object during the second time. In some embodiments, the at least one controller is configured to direct the first component to execute the first process parameter to transition from a first state to a second state during at least a first portion of the second time. In some embodiments, the second state is a requested state of the first process parameter. In some embodiments, the at least one controller is configured to direct the first component to execute the first process parameter to engage in the forming (i) after the second time and/or (ii) during at least a second portion of the second time that precedes the first portion of the second time. In some embodiments, the first component and/or the second component are selected from a group consisting of: an energy source, an energy beam, a guiding mechanism (e.g., a scanner), and an actuator. In some embodiments, the first process parameter includes at least one characteristic of: the energy beam, the energy source, the scanner, or the actuator. In some embodiments, the at least one characteristic of the energy source comprises power. In some embodiments, the at least one characteristic of the scanner comprises a position of an optical element of the scanner, or an actuator that is operatively coupled to the scanner. In some embodiments, the at least one characteristic of the energy beam comprises a trajectory, a speed, a power density, a focus at a target surface, or a fundamental length scale of a footprint of the energy beam on the target surface. In some embodiments, the at least one controller is configured to consider a signal from a sensor to perform (a) and/or (b). In some embodiments, the signal is related to a position of the footprint relative to the target surface, a temperature of target surface at the footprint, a power of the energy source, a position of at least one optical element of the scanner, a status of the actuator, a focus of the energy beam at the target surface. In some embodiments, the status of the actuator comprises a power of the actuator and/or a position of at least one component of the actuator. In some embodiments, the first process parameter and the second process parameter are the same. In some embodiments, the first process parameter and the second process parameter are different. In some embodiments, the first component and the second component are the same. In some embodiments, the first component and the second component are different. In some embodiments, the at least one controller comprises an electrical circuit. In some embodiments, the at least one controller is operatively coupled with a communication component, the communication component configured to communicate with the first component and/or the second component by a signal. In some embodiments, the communication component is configured to communicate wireless or via a wired connection. In some embodiments, the at least one controller comprises a socket. In some embodiments, the at least one controller a motherboard. In some embodiments, the motherboard comprises an electronic board. In some embodiments, the at least one controller comprises a graphical processing unit (GPU), system-on-chip (SOC), application specific integrated circuit (ASIC), application specific instruction-set processor (ASIPs), programmable logic device (PLD), or field programmable gate array (FPGA).

In another aspect, a non-transitory computer-readable medium storing program instructions for forming a three-dimensional object that, when the program instructions are executed by a processing unit, cause the processing unit to perform operations that comprise: direct execution of a first process parameter at a first time according to a first plan; direct execution of a second process parameter at a second time according to a second plan; direct measurement of an attribute of the forming; and coordinate the first time with the second time to reach a target attribute profile.

In some embodiments, the attribute of the forming comprises a temperature at a target surface, or an intensity of the transforming agent. In some embodiments, the attribute of the forming comprises a temperature at a footprint of the transforming agent on the target surface. In some embodiments, the transforming agent is an energy beam. In some embodiments, the program instructions cause the processing unit to direct execution of the first process parameter, execution of the second process parameter, and measurement of the attribute of the forming, to occur at a same time (e.g., concurrently). In some embodiments, the program instructions, when executed, cause the processing unit to direct the measurement of the attribute in real time, during the forming the three-dimensional object. In some embodiments, the non-transitory computer-readable medium program instructions that, when executed, cause the processing unit to change a control command to the first process parameter, or to the second process parameter. In some embodiments, the program instructions cause the processing unit to change the control command to the first process parameter during (a) and/or (b). In some embodiments, the program instructions cause the processing unit to change the control command to reach a target temperature profile. In some embodiments, the program instructions cause the processing unit to change the control command and to coordinate the first time with the second time, at a same time (e.g., concurrently). In some embodiments, the program instructions cause the processing unit to fix (or substantially fix) a relative time between (a) and (b) to coordinate the first time with the second time. In some embodiments, the relative time is zero or greater than zero. In some embodiments, to substantially fix comprises a variability (e.g., error) between an execution in (a) and an execution in (b), between the execution in (a) and an execution in (c), or between the execution in (b) and the execution in (c). In some embodiments, the variability is at most 100 microseconds. In some embodiments, the variability is at most 300 microseconds. In some embodiments, the variability is at most 1000 microseconds. In some embodiments, the non-transitory computer-readable medium program instructions that, when executed, cause the processing unit to direct, before (d), execution of a third process parameter at a third time according to a third plan. In some embodiments, the program instructions cause the processing unit to coordinate the first time with the second time and with the third time, to optimize forming of the three-dimensional object. In some embodiments, the program instructions cause the processing unit to (i) direct execution of the first process parameter, (ii) direct execution of the second process parameter, and/or (iii) direct execution of the third process parameter, during forming of the three-dimensional object. In some embodiments, the program instructions cause the processing unit to (i) direct execution of the first process parameter, (ii) direct execution of the second process parameter, and/or (iii) direct execution of the third process parameter, to print the three-dimensional object. In some embodiments, the third plan comprises a third profile of the third process parameter. In some embodiments, the non-transitory computer-readable medium comprises program instructions that, when executed, cause the processing unit to direct; (I) execution of the first process parameter (e.g., profile of motion commands of a scanner), (II) execution of the second process parameter (e.g., a profile of motion commands of a focusing element), (III) execution of the third process parameter (e.g., controlling a power profile of a laser), and (IV) the measurement of the attribute (e.g., a temperature, e.g., at a target surface), during a same time (e.g., concurrently); and (V) to change a control command to the third process parameter (e.g., power control commands to the laser), to reach a target profile of the attribute (e.g., such that a relative time between all these control profiles is fixed). In some embodiments, execution of the first process parameter comprises execution of a profile of motion commands of a scanner. In some embodiments, execution of the second process parameter comprises execution of a profile of motion commands of a focusing element. In some embodiments, execution of the second process parameter comprises program instructions that, when executed, cause the at least one processing unit to control a power profile of a laser. In some embodiments, the measurement of the attribute comprises a measurement of a temperature. In some embodiments, the attribute is at and/or from a target surface. In some embodiments, to change the control command comprises program instructions that, when executed, cause the at least one processing unit to change a power control command to an energy source. In some embodiments, the target profile of the attribute comprises a target temperature profile. In some embodiments, the non-transitory computer-readable medium comprise program instructions that, when executed, cause the at least one processing unit to fix a relative time between at least two of (e.g., all of the) (I)-(V). In some embodiments, the first plan comprises a first profile of the first process parameter. In some embodiments, the second plan comprises a second profile of the second process parameter. In some embodiments, the first process parameter is (i) a motion command of a guidance element (e.g., a scanner), (ii) a motion command of an optical (e.g., focusing) element, or (iii) a power profile of a transforming agent generator. In some embodiments, the guidance element is operatively coupled with an actuator. In some embodiments, second process parameter are selected from a group consisting of: a characteristic of a transforming agent, a characteristic of a transforming agent generator, and a metrology. In some embodiments, the first process parameter is different from the second process parameter. In some embodiments, the first process parameter and the second process parameter are selected from a group consisting of: a characteristic of an energy beam, a characteristic of an energy source, and a position of a footprint of the energy beam on a target surface. In some embodiments, the first process parameter is different from the second process parameter. In some embodiments, the first process parameter and the second process parameter are selected from a group consisting of: a position of a footprint of an energy beam at a target surface, a power of an energy source that generates the energy beam, a power density of the energy beam, a fluence of the energy beam, and a focus of the footprint of the energy beam at the target surface. In some embodiments, the first process parameter is different from the second process parameter. In some embodiments, the first process parameter and the second process parameter are selected from a group consisting of: a position, a power, and a motion. In some embodiments, the first process parameter is different from the second process parameter. In some embodiments, the position may comprise a position profile. In some embodiments, the motion may comprise a motion profile. In some embodiments, the power may comprise a power profile. In some embodiments, the motion is: of a guiding mechanism (e.g., scanner), and/or of an optical element (e.g., lens, e.g., focusing lens). In some embodiments, the first process parameter relates to a first component utilized in the forming. In some embodiments, the second process parameter relates to a second component utilized in the forming. In some embodiments, the program instructions cause the processing unit to direct sequential or concurrent execution of the first plan with respect to the second plan, to coordinate the first time with the second time. In some embodiments, to coordinate the first time with the second time comprises sequential, or concurrent occurrence of the first time with respect to the second time. In some embodiments, the program instructions cause the processing unit to direct an adjustment to an execution of the first plan with respect to the second plan, to coordinate the first time with the second time. In some embodiments, the program instructions cause the processing unit to adjust an occurrence of the first time with respect to the second time, to coordinate the first time with the second time. In some embodiments, the program instructions cause the processing unit to direct the execution of the first process parameter to not be engaged with forming the three-dimensional object during at least a portion of the second time. In some embodiments, the program instructions cause the processing unit to direct the execution of the first process parameter to not be engaged with forming the three-dimensional object during the second time. In some embodiments, the program instructions cause the processing unit to direct the execution of the first process parameter to transition from a first state to a second state during at least a first portion of the second time. In some embodiments, the second state is a requested state of the first process parameter. In some embodiments, the program instructions cause the processing unit to direct the execution of the first process parameter to engage in the forming (i) after the second time and/or (ii) during at least a second portion of the second time that precedes the first portion of the second time. In some embodiments, the first process parameter includes at least one characteristic of: an energy beam, an energy source, a guiding mechanism (e.g., a scanner), or an actuator. In some embodiments, the at least one characteristic of the energy source comprises power. In some embodiments, the at least one characteristic of the scanner comprises a position of an optical element of the scanner, or an actuator that is operatively coupled to the scanner. In some embodiments, the at least one characteristic of the energy beam comprises a trajectory, a speed, a power density, a focus at a target surface, or a fundamental length scale of a footprint of the energy beam on the target surface. In some embodiments, the non-transitory computer-readable medium, comprise program instructions that, when executed, cause the processing unit to consider a signal from a sensor to perform (a) and/or (b). In some embodiments, the signal is related to a position of the footprint relative to the target surface, a temperature of target surface at the footprint, a power of the energy source, a position of at least one optical element of the scanner, a status of the actuator, a focus of the energy beam at the target surface. In some embodiments, the status of the actuator comprises a power of the actuator and/or a position of at least one component of the actuator. In some embodiments, the first process parameter and the second process parameter are the same. In some embodiments, the first process parameter and the second process parameter are different.

Another aspect of the present disclosure provides a system for effectuating the methods disclosed herein.

Another aspect of the present disclosure provides an apparatus for effectuating the methods disclosed herein.

Another aspect of the present disclosure provides an apparatus comprising a controller that directs effectuating one or more operations (e.g., steps) in the method disclosed herein, wherein the controller is operatively coupled to the apparatuses, systems, and/or mechanisms that it controls to effectuate the method.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods above or elsewhere herein.

Another aspect of the present disclosure provides an apparatus for printing one or more 3D objects comprising a controller that is programmed to direct a mechanism used in a 3D printing methodology to implement (e.g., effectuate) any of the method disclosed herein, wherein the controller is operatively coupled to the mechanism.

Another aspect of the present disclosure provides a computer software product, comprising a non-transitory computer-readable medium in which program instructions are stored, which instructions, when read by a computer, cause the computer to direct a mechanism used in the 3D forming procedure to implement (e.g., effectuate) any of the method disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.,” Figs.,” “Fig.” or “Figs.” herein), of which:

FIG. 1 shows a schematic cross-sectional view of a three-dimensional (3D) printing system and its components;

FIG. 2 illustrates a detection system and its components;

FIG. 3A schematically illustrates an optical setup; FIG. 3B schematically illustrates an energy beam; and FIG. 3C schematically illustrates a control scheme;

FIG. 4 schematically illustrates a task queue for several control variables;

FIG. 5 schematically illustrates progression of various variables over time;

FIG. 6 schematically illustrates a progression of various variables over time;

FIG. 7 schematically illustrates progression of various variables over time;

FIGS. 8A and 8B schematically illustrate several trajectories of a transforming agent;

FIG. 9 schematically illustrates a control scheme;

FIG. 10 schematically illustrates a control scheme;

FIG. 11 schematically illustrates a control scheme;

FIG. 12 schematically illustrates progression of various variables over time;

FIG. 13A-13C schematically illustrates progression of various variables over time;

FIGS. 14A-14D show various schematic representations of measured processing variable profiles as a function of time;

FIG. 15 schematically illustrates a cross section of a portion of a 3D object in various layering planes;

FIG. 16A shows a cross sectional view of a 3D object with a support member; and FIG. 16B schematically a horizontal view of a 3D object;

FIG. 17A schematically illustrates a cross section of a 3D object; FIG. 17B schematically illustrates an example of a 3D plane; and FIG. 17C schematically illustrates a cross section in portion of a 3D object;

FIG. 18 shows schematics of various vertical cross sectional views of different 3D objects, and a guiding circle;

FIG. 19 schematically illustrates an optical system;

FIG. 20 schematically illustrates a computer system;

FIG. 21 schematically illustrates a computer system; and

FIG. 22 shows a schematic representation of a target surface.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

At times, a capability to coordinate control of one or more process variables for forming at least a portion of a 3D object (e.g., the entire 3D object) is provided by at least one controller. The at least one controller may be a separate or integrated component of a manufacturing device, e.g., that is configured to form the 3D object. The at least one controller may comprise a plurality of controllers. The plurality of controllers may be operatively coupled to each other in at least one communication directionality. For example a first controller of the plurality of controllers may be configured to receive a communication signal from a second controller of the plurality of controllers, which may constitute a first communication directionality (e.g., 2^{nd} controller to 1^{st} controller communication direction may take place). The second controller may or may not be configured to receive a communication signal from the first controller (e.g., 1^{st} controller to 2^{nd} controller communication direction may or may not be able to take place). As used herein, a control variable may be a process variable that may be (e.g., at least indirectly) controlled. The control may be through control of a component (e.g., mechanism) utilized during formation of the 3D object. In some embodiments, a controller provides integrated and/or adaptive control of at least one control variable. For example, integrated and/or adaptive control can be between (i) at least one characteristic of a transforming agent, (ii) at least one metrology and/or (iii) a temperature (measured at a target surface location, e.g., by a sensor). The control may be to achieve a setpoint of an attribute. The attribute may be of the formation (e.g., formation process) of the 3D object. For example, the attribute may comprise: (1) a temperature, (2) a metrology, (3) an optical characteristic, or (4) a spectroscopic characteristic. The attribute may be related to a forming area that is at least a portion of the 3D object. The forming area may be of a melt pool. For example, the attribute may be a temperature, reflectivity, specularity, height, position, and/or a wavelength of emitted/radiated radiation. The attribute may be measured at the forming area, at the vicinity of the forming area, or may be a gradient between the center for the forming position to its vicinity. The vicinity may be any vicinity disclosed herein. The forming area may correspond to a footprint of a transforming agent (e.g., energy beam) at a target surface where the forming area is disposed. The setpoint of the attribute may be a value, a profile, a progression, and/or a function. At times control of at least two process parameters may be coordinated relative to each other. The coordinated control of the at least two process parameters may be to control (e.g., achieve and/or maintain) the setpoint of the attribute (e.g., that is manifested during formation of the 3D object). For example, the one or more controllers may direct at least two of: (1) execution of a profile of motion commands of a scanner of an energy beam, (2) execution of a profile of motion commands of a focusing element of the energy beam, and (3) control of a power profile of the energy, while directing measurement of a temperature at a footprint of the energy beam at a target surface. Directing measurement of the temperature may be by directing a detector and/or sensor, e.g., that is operatively coupled to the one or more controllers. The one or more controllers may direct at least two of (1), (2), and (3), to control (e.g., maintain and/or achieve) a temperature setpoint. Controlling the temperature setpoint may take into account the temperature measurements (e.g., by a sensor). Controlling the temperature setpoint may utilize a feedback control scheme. The one or more controllers may direct at least two of (1), (2), and (3) by coordinating at least two of them with respect to each other. The coordination may comprise maintaining a fixed time gap between the at least two of (1), (2), and (3). Fixed can be within an acceptable range (e.g., within an error of about and millisecond to an error of about a tenth of a millisecond). For example, the one or more controllers may direct (a) execution of a profile of motion commands of a scanner of an energy beam, while (b) execution of a profile of motion commands of a focusing element of the energy beam, while (c) control of a power profile of the energy, and while directing measurement of a temperature at a footprint of the energy beam at a target surface; in order to control (e.g., maintain and/or achieve) a temperature setpoint, e.g., by maintaining a fixed time gap between at least two of (a), (b), and (c). Maintaining a fixed time gap between at least two of (a), (b), and (c) may comprise: (I) a fixed time gap between (a) and (b), (II) a fixed time gap between (a) and (c), (III) a fixed time gap between (b) and (c), or (IV) a fixed time gap between (a), (b), and (c).

In some embodiments, the integrated and/or adaptive control considers a feedback parameter. The feedback parameter may comprise a detected signal (e.g., from an area, e.g., from a position). The detected signal(s) may correlate to an optical characteristic (e.g., reflectivity or specularity), a temperature, a wavelength of radiation (e.g., a color), a metrology (e.g., height), and/or a detected position of a transforming agent, e.g., on a build region. The optical characteristic may indicate a state of matter at the detected area/position (e.g., liquid, partial liquid and partial solid, or solid state). In some embodiments, integrated control comprises coordinated control of at least two control variables to form one or more portions of 3D object (e.g., the entire 3D object). The control variable may be a process variable. The integrated control may be synchronous or asynchronous. Synchronous control may comprise low jitter between at least two of a plurality of outputs (e.g., controlled variables) or inputs (e.g., sensor readings). In some embodiments, integrated control can be between at least two characteristics of a transforming agent (e.g., energy beam). In some embodiments, characteristics of the transforming agent may comprise: (I) a transforming agent flux (e.g., energy beam fluence), (II) transforming agent motion (e.g., energy beam position, velocity and/or acceleration), (III) a transforming agent intensity (e.g., energy beam power density), (IV) transforming agent persistence (e.g., dwell) time, (V) transforming agent area of effect (e.g., energy beam footprint) (e.g., on an exposed surface of a material bed), (VI) transforming agent focus, or (VII) a fundamental length scale of a transforming agent footprint (e.g., on a target surface, e.g., an exposed surface of a material bed). For example, integrated control may comprise motion planning (e.g., timing thereof) for providing a movement of a transforming agent across a target surface (e.g., on an exposed surface of a material bed), with a specified transforming agent intensity considering (e.g., as a function of) its position on the target surface. In some embodiments, jitter may comprise a variability (e.g., error) in a timing of execution of commands between at least two control variables (e.g., commanded for simultaneous execution). In some embodiments, a low jitter comprises a variability that is at most about 1 microsecond (μs), 5 μs, 10 μs, 100 μs, 200 μs, 300 μs, 400 μs, 500 μs, 600 μs, 700 μs, 800 μs, 900 μs or 1000 μs. The variability in the timing of execution of commands may be any value between the afore-mentioned values (e.g., from about 1 μs to about 5 μs, from about 1 μs to about 100 μs, from about 1 μs to about 1000 μs, from about 5 μs to about 100 μs, from about 5 μs to about 1000 μs, or from about 100 μs to about 1000 μs).

At times, adaptive control comprises adaptive timing for execution of a sequence of material processing operations (e.g., adaptive control) for generating at least a portion of a 3D object. A timing of pre-determined duration may be contrastive to adaptive control. Adaptive control may comprise deterministic timing for at least one processing operation of a plurality of material processing operations. A deterministic timing may comprise (a) a deterministic duration of at least one processing operation, or (b) a deterministic delay between at least two (e.g., sequential) processing operations in a plurality of processing operations. Adaptive control may consider at least one attribute, e.g., that is characteristic of the forming process. The adaptive control may be utilized to control (e.g., maintain, achieve, or strive to achieve) a setpoint of the attribute. For example, adaptive control may consider at least one (1) metrology (e.g., a detected signal) achieving a threshold value, (2) a reflectivity, specularity, or wavelength (e.g., indicative of transformation solid formation, and/or liquid formation), and/or (3) a (e.g., detected) state of a physical process during formation of at least a portion of a 3D object. For example, (a) a detected size (e.g., extent and/or depth) and/or (b) temperature, e.g., of a transforming material (e.g., melt pool). The adaptive control may be altered in real time during forming of at least a portion of the 3D object (e.g., by utilizing sensor data).

Terms such as “a,” “an,” and “the” are not intended to refer to only a singular entity, but may include the general class of which a specific example may be used for illustration. The terminology herein is used to describe specific embodiments of the invention, but their usage does not delimit the invention.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2.

The term “between” as used herein is meant to be inclusive unless otherwise specified. For example, between X and Y is understood herein to mean from X to Y.

The term “adjacent” or “adjacent to,” as used herein, includes ‘next to’, ‘adjoining’, ‘in contact with,’ and ‘in proximity to.’ In some instances, adjacent to may be ‘above’ or ‘below.’

The term “operatively coupled” or “operatively connected” refers to a first mechanism that is coupled (or connected) to a second mechanism to allow the intended operation of the second and/or first mechanism, including a first mechanism that is in signal communication with a second mechanism. The term “configured to” refers to an object or apparatus that is (e.g., structurally) configured to bring about an intended result. The phrase “is/are structured,” or “is/are configured,” when modifying an article, refers to a structure of the article that is able to bring about the enumerated result.

Fundamental length scale (abbreviated herein as “FLS”) can refer to any suitable scale (e.g., dimension) of an object. For example, a FLS of an object may comprise a length, a width, a height, a diameter, a spherical equivalent diameter, or a diameter of a bounding sphere.

The phrase “a three-dimensional object” as used herein may refer to “one or more three-dimensional objects,” as applicable.

“Real time” as understood herein may be during at least part of the forming (e.g., printing) of a 3D object. Real time may be during a print operation. Real time may be during a print cycle. Real time may comprise during formation of: a 3D object, a layer of hardened material as part of the 3D object, a hatch line, a single-digit number of melt pools, a melt pool, or any combination thereof.

The phrase “a target surface” may refer to (1) a surface of a build plane (e.g., an exposed surface of a material bed), (2) an exposed surface of a platform, (3) an exposed surface of a 3D object (or a portion thereof), (4) any exposed surface adjacent to an exposed surface of the material bed, platform, or 3D object, and/or (5) any targeted surface. Targeted may be by a transforming agent. For example, by at least one energy beam, or by a printing head (e.g., of a dispenser).

The methods, systems, apparatuses, and/or software may effectuate the formation of one or more objects (e.g., 3D objects). In some cases, the one or more objects comprise an elemental metal, metal alloy, ceramic, or an allotrope of elemental carbon. In some embodiments, the 3D object includes an overhang structure. An overhang structure (also referred to herein as “overhang” or “overhang region”) can refer to a structure of a 3D object that protrudes a distance from another structure (e.g., a core structure). An overhang structure may comprise (e.g., correspond to) a ceiling (e.g., cavity ceiling), bottom (e.g., cavity bottom), protrusion, ledge, blade, hanging structure, undercut, projection, protuberance, balcony, wing, leaf, extension, shelf, jut, hook, or step, of a 3D object. The overhang may be free of auxiliary supports, e.g., during the forming of the overhang. For example, the overhang may be formed on (e.g., attached to) a previously formed (e.g., already hardened) portion of the 3D object. A surface (e.g., bottom surface) of an overhang may have a surface roughness at or below a prescribed roughness measurement. Bottom may be in the direction of the global vector and/or face the platform during forming of the 3D object.

In some embodiments, the 3D object includes a skin, which can correspond to a portion of the 3D object that includes an exterior surface of the 3D object. The skin is may be formed by an outer contour of a layer of the 3D object, and may be referred herein as “outer portion” or “exterior portion.” The contour of the layer can be referred herein as a “rim,” “contour,” “contour portion,” “perimeter,” or “perimeter portion.” In some embodiments, the skin is a “bottom” skin, which can correspond to a skin on a bottom of an overhang with respect to a platform surface during formation (e.g., printing) of the one or more 3D objects. Bottom may be in the direction of the global vector and/or face the platform during printing of the 3D object.

Three-dimensional forming (also “3D printing”) generally refers to a method for generating a 3D object. The apparatuses, methods, controllers, and/or software described herein pertaining to generating (e.g., forming, or printing) a 3D object, pertain also to generating one or more 3D objects. For example, 3D printing may refer to sequential addition of material layers or joining of material layers (or parts of material layers) to form a 3D structure, in a controlled manner. The controlled manner may comprise manual or automated control. In the 3D printing process, the deposited material can be transformed (e.g., fused, sintered, melted, bound, or otherwise connected) to subsequently harden and form at least a part of the 3D object. Fusing (e.g., sintering or melting) binding, or otherwise connecting the material is collectively referred to herein as transforming a pre-transformed material (e.g., powder material) into a transformed material. Fusing the material may include melting or sintering the material. Binding can comprise chemical bonding. Chemical bonding can comprise covalent bonding. Examples of 3D printing may include additive printing (e.g., layer by layer printing, or additive manufacturing). 3D printing may include layered manufacturing. 3D printing may include rapid prototyping. 3D printing may include solid freeform fabrication. The 3D printing may include binding pre-transformed material with a binder (e.g., polymer or resin). The 3D printing may further comprise subtractive printing.

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition. 3D printing methodologies may comprise forming a green-body. 3D printing methodologies may comprise a binder that binds pre-transformed material (e.g., binding a powder). The binder may remain in the 3D object, or may be (e.g., substantially) absent from the 3D printing (e.g., due to heating, extracting, evaporating, and/or burning).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

“Pre-transformed material,” as understood herein, is a material before it has been first transformed (e.g., once transformed) by an energy beam during the formation (e.g., printing) of one or more 3D objects. The pre-transformed material may be a material that was, or was not, transformed prior to its use in the 3D printing process. The pre-transformed material may be a material that was partially transformed prior to its use in the 3D printing process. The pre-transformed material may be a starting material for the 3D printing process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The FLS of the formed (e.g., printed) 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m or 1000 m. In some cases, the FLS of the printed 3D object may be between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some instances, it is requested to control the manner in which at least a portion of a layer of hardened material is formed. The layer of hardened material may comprise a plurality of melt pools. In some instances, it may be requested to control one or more characteristics of the melt pools that form the layer of hardened material. The characteristics may comprise a depth of a melt pool, a microstructure, or the repertoire of microstructures of the melt pool. The microstructure of the melt pool may comprise the grain (e.g., crystalline and/or metallurgical) structure, or grain structure repertoire that makes up the melt pool. The grain structure may be referred to herein as microstructure.

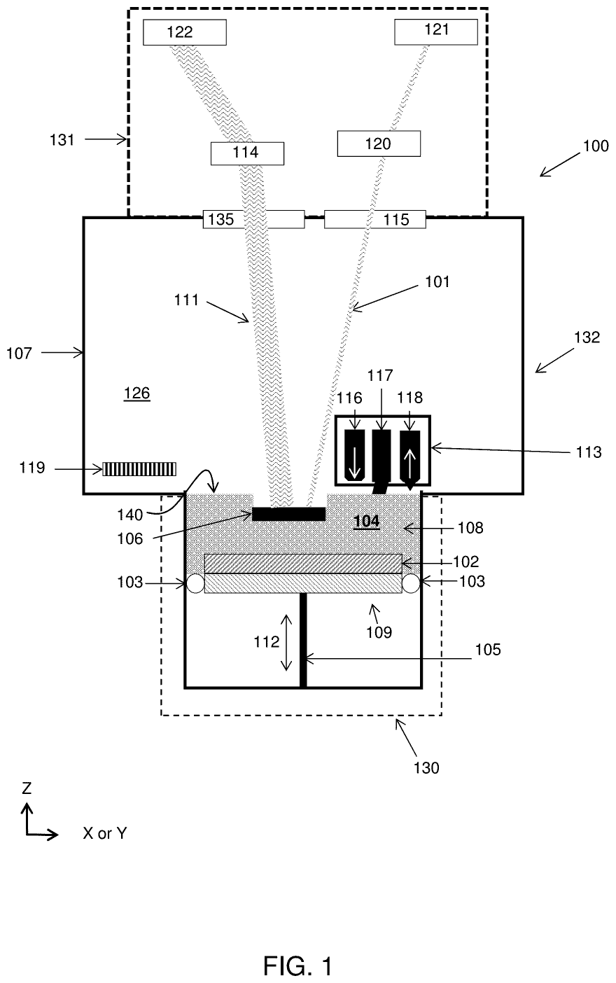

In some embodiments, transforming comprises heating at least a portion of a target surface (e.g., exposed surface of a material bed), and/or a previously formed area of hardened material using at least one energy source. The energy source may generate an energy beam. The energy source may be a radiative energy source. The energy source may be a dispersive energy source (e.g., a fiber laser). The energy source may generate a substantially uniform (e.g., homogenous) energy stream (e.g., energy beam). The energy beam may comprise a cross section (e.g., or a footprint) having a (e.g., substantially) homogenous fluence. The energy beam may have a spot size (e.g., footprint or cross-section) on a target surface. The energy generated for transforming a portion of material (e.g., pre-transformed or transformed) by the energy source will be referred herein as the “energy beam.” The energy beam may heat a portion of a 3D object (e.g., an exposed surface of the 3D object). The energy beam may heat a portion of the target surface (e.g., an exposed surface of the material bed, and/or a deeper portion of the material bed that is not exposed). The target surface may comprise a pre-transformed material, a partially transformed material and/or a transformed material. The target surface may comprise a portion of the build platform, for example, the base (e.g., FIG. 1, 102). The target surface may comprise a (surface) portion of a 3D object. The heating by the energy beam may be substantially uniform across its footprint on the target surface. In some embodiments, the energy beam takes the form of an energy stream emitted toward the target surface in a step and repeat sequence (e.g., tiling sequence). The energy beam may advance continuously, in a pulsing sequence, or in a step-and repeat sequence. The energy source may comprise an array of energy sources, e.g., a light emitting diode (LED) array.

In some embodiments, the methods, systems, apparatuses, and/or software disclosed herein comprises controlling at least one characteristic of the layer of hardened material (or a portion thereof) that is part of the 3D object. The methods, systems, apparatuses, and/or software disclosed herein may comprise controlling the degree of 3D object deformation. The control may be an in-situ and/or real-time control. The control may be control during formation of the at least a portion of the 3D object. The control may comprise a closed loop or an open loop control scheme. The portion may be a surface, layer, plurality (e.g., multiplicity) of layers, portion of a layer, and/or portion of a multiplicity of layers. The layer of hardened material of the 3D object may comprise a plurality of melt pools. The layers' characteristics may comprise planarity, curvature, or radius of curvature of the layer (or a portion thereof). The characteristics may comprise the thickness of the layer (or a portion thereof). The characteristics may comprise the smoothness (e.g., planarity) of the layer (or a portion thereof).

In some embodiments, a 3D forming (e.g., printing, or print) cycle refers to printing one or more 3D objects in a 3D printer, e.g., using one printing instruction batch. A 3D printing cycle may include printing one or more 3D objects above a (single) platform and/or in a material bed. A 3D printing cycle may include printing all layers of one or more 3D objects in a 3D printer. On the completion of a 3D printing cycle, the one or more objects may be removed from the 3D printer (e.g., by sealing and/or removing the build module from the printer) in a removal operation (e.g., simultaneously). During a printing cycle, the one or more objects may be printed in the same material bed, above the same platform, with the same printing system, at the same time span, using the same forming (e.g., printing) instructions, or any combination thereof. A print cycle may comprise printing the one or more objects layer-wise (e.g., layer-by-layer). A layer may comprise a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle (e.g., within a material bed). In some embodiments, at least two layers of a print cycle within a material bed have different layer heights. A printing cycle may comprise a collection (e.g., sum) of print operations. A print operation may comprise a print increment (e.g., deposition of a layer and transformation of a portion thereof to form at least part of the 3D object). A printing cycle (also referred to herein as “build cycle”) may comprise one or more printing-laps (e.g., the process of forming a printed layer in a layerwise deposition to form the 3D object). The printing-lap may be referred to herein as “build-lap” or “print-increment”. In some embodiments, a printing cycle comprises one or more printing laps. The 3D printing lap may correspond with (i) depositing a (planar) layer of pre-transformed material (e.g., as part of a material bed) above a platform, and (ii) transforming at least a portion of the pre-transformed material (e.g., by at least one energy beam) to form a layer of a 3D objects above the platform (e.g., in the material bed). The printing cycle may comprise a plurality of laps to layerwise form the 3D object. The 3D printing cycle may correspond with (I) depositing a pre-transformed material toward a platform, and (II) transforming at least a portion of the pre-transformed material (e.g., by at least one energy beam) at or adjacent to the platform to form one or more 3D objects above the platform at the same time-window. An additional sequential layer (or part thereof) can be added to a previous layer of a 3D object by transforming (e.g., fusing and/or melting) a fraction of pre-transformed material that is introduced (e.g., as a pre-transformed material stream) to the prior-formed layer. At times, the platform supports a plurality of material beds and/or a plurality of 3D objects. One or more 3D objects may be formed in a single material bed during a printing cycle (e.g., one or more print jobs). The transformation may connect transformed material of a given layer (e.g., formed during a printing lap) to a previously formed 3D object portion (e.g., of a previous printing lap). The transforming operation may comprise utilizing a transforming agent (e.g., an energy beam or a binder dispenser) to transform the pre-transformed (or re-transform the transformed) material. In some instances, the transforming agent (e.g., energy beam) is utilized to transform at least a portion of the material bed (e.g., utilizing any of the methods described herein).

In some embodiments, at least one (e.g., each) energy source of the 3D forming (e.g., printing) system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr).

In some embodiments, the transforming agent is dispensed through a material dispenser (e.g., binding dispenser). The dispenser may be any dispenser disclosed herein. The dispenser can be controlled (e.g., manually and/or automatically). The automatic control may be using one or more controllers that are operatively coupled to at least one component of the dispenser. The control may be before, during, and/or after the forming (e.g., printing). The dispenser may be translated using an actuator. The translation of the dispenser can utilize a scanner (e.g., an XY stage). In some embodiments, the at least one 3D object is printed using a plurality of dispensers. In some embodiments, at least two dispensers dispense the same type of binder (e.g., comprising a binding agent). In some embodiments, at least two dispensers each dispense a different type of binder. In some embodiments, a binding agent is a polymer or resin. The binding agent can be organic or inorganic. The binding agent can be carbon based or silicon based.

In some embodiments, the energy source and/or energy source is movable such that it can translate across (e.g., laterally) the top surface of the material bed, e.g., during the printing. The energy beam(s) and/or energy source(s) can be moved via at least one (e.g., galvanometer) scanner. The scanner may comprise a galvanometer scanner, a moving (e.g., rotating) polygon, a mechanical-stage (e.g., X-Y-stage), a piezoelectric device, a gimbal, or any combination of thereof. The scanner may comprise a mirror. The scanner may comprise a modulator. The scanner may comprise a polygonal mirror. The scanner can be the same scanner for two or more energy sources and/or beams. At least two (e.g., each) energy sources and/or beams may have a separate scanner. At least two scanners may be operably coupled with a single energy source and/or energy beam. The systems and/or apparatuses disclosed herein may comprise one or more shutters (e.g., safety shutters). The energy source(s) may project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle).

At times, the energy source(s) are modulated. The energy (e.g., beam) emitted by the energy source can be modulated. The modulator can comprise an amplitude modulator, a phase modulator, or polarization modulator. The modulation may alter the intensity of the energy beam. The modulation may alter the current supplied to the energy source (e.g., direct modulation). The modulation may affect (e.g., alter) the energy beam (e.g., external modulation such as external light modulator). The modulator can comprise an aucusto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam.

The scanner can be included in an optical system that is configured to direct energy from the energy source to a predetermined position on the (target) surface (e.g., exposed surface of the material bed). At least one controller can be programmed to control a trajectory of the energy source(s) with the aid of the optical system. The controller can regulate a supply of energy from the energy source to the pre-transformed material (e.g., at the target surface) to form a transformed material. The optical system may be enclosed in an optical enclosure. Examples of an optical enclosure and/or system can be found in Patent Application serial number PCT/US17/64474, titled “OPTICS, DETECTORS, AND THREE-DIMENSIONAL PRINTING” that was filed Dec. 4, 2017, or in Patent Application serial number PCT/US18/12250, titled “OPTICS IN THREE-DIMENSIONAL PRINTING” that was filed Jan. 3, 2018, each of which is incorporated herein by reference in its entirety.

The energy beam (e.g., transforming energy beam) may comprise a Gaussian energy beam. The energy beam may have any cross-sectional shape comprising an ellipse (e.g., circle), or a polygon. The energy beam may have a cross section (e.g., at an intersection of the energy beam on a target surface) with a FLS of at least about 20 μm, 50 μm, 75 μm, 100 μm, 150 μm, 200 μm or 250 μm, 0.3 millimeters (mm), 0.4 mm, 0.5 mm, 0.8 mm, 1 mm, 1.5 mm, 2 mm, 2.5 mm, 3 mm, 3.5 mm, 4 mm, 4.5 mm, or 5 mm. The cross section of the energy beam may be any value of the afore-mentioned values (e.g., from about 50 μm to about 250 μm, from about 50 μm to about 150 μm, from about 150 μm to about 25 μm, from about 0.2 mm to about 5 mm, from about 0.2 mm to about 2.5 mm, or from about 2.5 mm to about 5 mm). The FLS may be measured at full width half maximum intensity of the energy beam. The FLS may be measured at 1/e² intensity of the energy beam. In some embodiments, the energy beam is a focused energy beam at the target surface. In some embodiments, the energy beam is a defocused energy beam at the target surface. The energy profile of the energy beam may be (e.g., substantially) uniform (e.g., in the energy beam's cross-sectional area that impinges on the target surface). The energy profile of the energy beam may be (e.g., substantially) uniform during an exposure time (e.g., also referred to herein as a dwell time). The exposure time (e.g., at the target surface) of the energy beam may be at least about 0.1 milliseconds (ms), 0.5 ms, 1 ms, 10 ms, 50 ms, 100 ms, 200 ms, 500 ms, 1000 ms, 2500 ms, or 5000 ms. The exposure time may be between any of the above-mentioned exposure times (e.g., from about 0.1 ms to about 5000 ms, from about 0.1 ms to about 1000 ms, or from about 1000 ms to about 5000 ms). In some embodiments, the energy beam is configured to be continuous or non-continuous (e.g., pulsing). In some embodiments, at least one energy source can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of a value between the afore-mentioned values (e.g., from about 50 J/cm² to about 5000 J/cm², from about 50 J/cm² to about 2500 J/cm², or from about 2500 J/cm² to about 5000 J/cm²). In some embodiments, the power density (e.g., power per unit area) of the energy beam is at least about 100 Watts per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², 8000 W/mm², 9000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the energy beam may be any value between the aforementioned values (e.g., from about 100 W/mm² to about 100000 W/mm², about 100 W/mm² to about 1000 W/mm², or about 1000 W/mm² to about 10000 W/mm², from about 10000 W/mm² to about 100000 W/mm², from about 10000 W/mm² to about 50000 W/mm², or from about 50000 W/mm² to about 100000 W/mm²). The energy beam may emit energy stream towards the target surface in a step and repeat sequence. The target surface may comprise an exposed surface of an energy beam, a previously formed 3D object portion, or a platform.

At times, an energy source provides power at a peak wavelength. For example, an energy source can provide electromagnetic energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. An energy beam can provide energy at a peak wavelength between any value of the afore-mentioned peak wavelength values (e.g., from about 100 nm to about 2000 nm, from about 100 nm to about 1000 nm, or from about 1000 nm to about 2000 nm). The energy source (e.g., laser) may have a power of at least about 0.5 Watt (W), 1 W, 5 W, 10 W, 50 W, 100 W, 250 W, 500 W, 1000 W, 2000 W, 3000 W, or 4000 W. The energy source may have a power between any value of the afore-mentioned laser power values (e.g., from about 0.5 W to about 4000 W, from about 0.5 W to about 1000 W, or from about 1000 W to about 4000 W).

At times, an energy beam is translated across a surface (e.g., target surface) at a given rate (e.g., a scanning speed), e.g., in a trajectory. The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be any value between the aforementioned values (e.g., from about 50 mm/sec to about 50000 mm/sec, from about 50 mm/sec to about 3000 mm/sec, or from about 3000 mm/sec to about 50000 mm/sec). The energy beam may be continuous or non-continuous (e.g., pulsing). The energy profile of the energy beam may be (e.g., substantially) uniform during the exposure time (e.g., also referred to herein as dwell time). The exposure time (e.g., at the target surface) of the energy beam may be at least about 0.1 milliseconds (ms), 0.5 ms, 1 ms, 10 ms, 50 ms, 100 ms, 500 ms, 1000 ms, 2500 ms, or 5000 ms. The exposure time may be any value between the above-mentioned exposure times (e.g., from about 0.1 ms to about 5000 ms, from about 0.1 ms to about 1000 ms, or from about 1000 ms to about 5000 ms). The exposure time (e.g., irradiation time) may be the dwell time. The dwell time may be at least 1 minute, or 1 hour.

In some embodiments, the at least one 3D object is formed (e.g., printed) using a plurality of energy beams and/or energy sources. At times, at least two transforming agents (e.g., energy sources (e.g., producing at least two energy beams)) may have at least one characteristic value in common with each other. At times, the at least two energy sources may have at least one characteristic value that is different from each other. Characteristics of the transforming agent may comprise transformation density (or transformation strength), trajectory, FLS of footprint on the target surface, hatch spacing, scan speed, or scanning scheme. The transformation density may refer to the volume or weight of material transformed in a given time by the transforming agent. The FLS of footprint on the target surface may refer to the FLS of the energy beam on the target surface, of a binder stream dispensed on the target surface. Characteristics of the energy beam may comprise wavelength, power density, amplitude, trajectory, FLS of footprint on the target surface, intensity, energy, energy density, fluence, Andrew Number, hatch spacing, scan speed, scanning scheme, or charge. The scanning scheme may comprise continuous, pulsed or tiled scanning scheme. The charge can be electrical and/or magnetic charge. Andrew number is proportional to the power of the irradiating energy over the multiplication product of its velocity (e.g., scan speed) by a hatch spacing. The Andrew number is at times referred to as the area filling power of the irradiating energy. In some embodiments, at least two of the energy source(s) and/or beam(s) can be translated at different rates (e.g., velocities).

A guidance system and/or an energy source may be controlled manually and/or automatically by at least one controller. For example, at least two guidance systems may be directed by the same controller. For example, at least one guidance system may be directed by its own (e.g., unique) controller. A plurality of controllers may be operatively coupled to each other, to the guidance system(s) (e.g., scanner(s)), and/or to the energy source(s). At least two of a plurality of energy beams may be directed towards the same position at the target surface, or to different positions at the target surface. The one or more guidance systems may be positioned at an angle (e.g., tilted) with respect to the target surface. One or more sensors may be disposed adjacent to the target surface. At least one of the one or more sensors may be disposed in an indirect view of the target surface. At least one of the one or more sensors may be disposed in a direct view of the target surface (e.g., a camera viewing the target surface). The one or more sensors may be configured to have a field of view of at least a portion of the target surface (e.g., an exposed surface of the material bed).

FIG. 1 shows an example of a 3D forming (e.g., 3D printing) system 100 (also referred to herein as “3D printer”) and apparatuses, including a (e.g., first) energy source 121 that emits a (e.g., first) energy beam 101 and a (e.g., second) energy source 122 that emits a (e.g., second overlapping) energy beam 111. In the example of FIG. 1 the energy from energy source 121 travels through an (e.g., first) optical system 120 (e.g., comprising a scanner) and an optical window 115 to be incident upon a target surface 140 within an enclosure 126 (e.g., comprising an atmosphere). The enclosure can comprise one or more walls that enclose the atmosphere. The target surface may comprise at least one layer of pre-transformed material (e.g., FIG. 1, 108) that is disposed adjacent to a platform (e.g., FIG. 1, 109). Adjacent can be above. In some embodiments, an elevator shaft (e.g., FIG. 1, 105) is configured to move the platform (e.g., vertically; FIG. 1, 112). The enclosure (e.g., 132) may including sub-enclosures comprising an optical chamber (e.g., 131), a processing chamber (e.g., 107), and a build module (e.g., 130). The platform may be separated from one or more walls (e.g., side walls) of the build module by a seal (e.g., FIG. 1, 103). The guidance system of the energy beam may comprise an optical system. FIG. 1 shows the energy from the energy source 122 travels through an optical system 114 (e.g., comprising a scanner) and an optical window 135 to impinge (e.g., be incident) upon the target surface 140. The energy from the (e.g., plurality of) energy source(s) may be directed through the same optical system and/or the same optical window. At times, energy from the same energy source is directed to form a plurality of energy beams by one or more optical systems. The target surface may comprise a (e.g., portion of) hardened material (e.g., FIG. 1, 106) formed via transformation of material within a material bed (e.g., FIG. 1, 104). In the example of FIG. 1, a layer forming device 113 includes a (e.g., powder) dispenser 116, a leveler 117, and material removal mechanism 118. During printing, the 3D object (e.g., and the material bed) may be supported by a (e.g., movable) platform, which platform may comprise a base (e.g., FIG. 1, 102). The base may be detachable (e.g., after the printing). A hardened material may be anchored to the base (e.g., via supports and/or directly), or non-anchored to the base (e.g., floating anchorlessly in the material bed, e.g., suspended in the material bed). An optional thermal control unit can be configured to maintain a (e.g., local) attribute of the forming process. An optional thermal control unit (e.g., FIG. 1, 119) can be configured to maintain a (e.g., local) temperature (e.g., at the material bed and/or atmosphere). In some cases, the thermal control unit comprises a (e.g., passive or active) heating member. In some cases, the thermal control unit comprises a (e.g., passive or active) cooling member. The thermal control unit may comprise or be operatively coupled to a thermostat. The thermal control unit can be provided inside of a region where the 3D object is formed or adjacent to (e.g., above) a region (e.g., within the processing chamber atmosphere) where the 3D object is formed. The thermal control unit can be provided outside of a region (e.g., within the processing chamber atmosphere) where the 3D object is formed (e.g., at a predetermined distance).

In some embodiments, an optical system through which an energy beam travels can be disposed within the enclosure, outside of the enclosure, or within at least one wall of the enclosure. For example, an optical window of an optical system may be disposed within at least one wall of the enclosure (e.g., as in FIGS. 1, 135 and 115). In some embodiments, at least a portion of the optical system is disposed within its own (optical) enclosure (e.g., FIG. 1, 131). The optical enclosure may optionally be (e.g., operatively and/or physically) coupled with the processing chamber. Examples of an optical mechanism and any of its components (e.g., including an optical enclosure and/or optical window) can be found in patent application number PCT/US17/60035, titled “GAS FLOW IN THREE-DIMENSIONAL PRINTING” that was filed on Nov. 3, 2017, or in Patent Application serial number PCT/US18/12250, each of which is incorporated herein by reference in its entirety.

In some embodiments, the target surface is detected by a detection system. The detection system may comprise at least one sensor. The detection system may comprise a light source operable to illuminate a portion of the 3D forming (e.g., printing) system enclosure (e.g., the target surface). The light source may be configured to illuminate onto a target surface. The illumination may be such that objects in the field of view of the detector are illuminated with (e.g., substantial) uniformity. For example, sufficient uniformity may be uniformity such that at most a threshold level (e.g., 25 levels) of variation in grayscale intensity exists (for objects), across the build plane. The illumination may comprise illuminating a map of varied light intensity (e.g., a picture made of varied light intensities). Examples of illumination apparatuses include a lamp (e.g., a flash lamp), a LED, a halogen light, an incandescent light, a laser, or a fluorescent light. The detection system may comprise a camera system, CCD, CMOS, detector array, a photodiode, or line-scan CCD (or CMOS). Examples of a control system, detection system and/or illumination can be found in Patent Application serial number U.S. Ser. No. 15/435,090, titled “ACCURATE THREE-DIMENSIONAL PRINTING” that was filed Feb. 16, 2017, which is incorporated herein by reference in its entirety.

The 3D printer may include an enclosure (e.g., FIG. 1, 132). The enclosure can include sub-enclosures. For example, the enclosure can include a processing chamber (e.g., FIG. 1, 107) and a build module (e.g., FIG. 1, 130). The sub-enclosures may be configured to be coupled and decoupled from one another. In some embodiments, the build module and the processing chamber are separate and/or inseparable. In some embodiments, the optical chamber and the processing chamber are separate and/or inseparable. The build module and processing chamber may (e.g., controllably) engage and disengage. The separate build module, optical chamber, and processing chamber may each comprise a separate atmosphere. Any of these atmospheres may be different than the ambient atmosphere outside of the build module, optical chamber, and/or processing chamber. For example, any of these atmospheres may be inert (e.g., comprise argon, or nitrogen). Any of these atmospheres may comprise a species that is reactive with the transformed and/or pre-transformed material during the printing, in an amount below a (e.g., reactive) threshold. The species may comprise water or oxygen. The build module, optical chamber, and/or processing chamber may engage to form a gas tight seal (e.g., hermetic seal). The separate build module, optical chamber, and/or processing chamber may (e.g., controllably) merge. For example, the atmospheres of the build module and processing chamber may merge. In the example of FIG. 1, the 3D printing system comprises a processing chamber which comprises the energy beam and the target surface (e.g., comprising the atmosphere in the interior volume of the processing chamber, e.g., 126). At times, at least one build module may be disposed in the enclosure that comprises the processing chamber (having an interior volume 126 comprising an atmosphere). At times, at least one build module may engage with the processing chamber (e.g., FIG. 1) (e.g., 107). At times, a plurality of build modules may be coupled to the enclosure. The build module and/or optical chamber may reversibly engage with (e.g., couple to) the processing chamber. The engagement of the build module and/or optical chamber may be before or after the 3D printing. The engagement of the build module and/or optical chamber with the processing chamber may be controlled (e.g., by a controller, such as a microcontroller). Examples of a controller and any of its components can be found in: patent application serial number PCT/US17/18191, titled “ACCURATE THREE-DIMENSIONAL PRINTING” that was filed on Feb. 16, 2017; patent application serial number U.S. Ser. No. 15/435,065, titled “ACCURATE THREE-DIMENSIONAL PRINTING” that was filed on Feb. 16, 2017; and/or patent application serial number EP17156707, titled “ACCURATE THREE-DIMENSIONAL PRINTING” that was filed on Feb. 17, 2017; each of which is incorporated herein by reference in its entirety. The controller may direct the engagement and/or dis-engagement of the build module and/or of the optical chamber. The control may comprise automatic and/or manual control. The engagement of the build module with the processing chamber may be reversible. In some embodiments, the engagement of the build module with the processing chamber may be non-reversible (e.g., stable, or static). The FLS (e.g., width, depth, and/or height) of the processing chamber can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m, or 5 m. The FLS of the processing chamber can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber can be between any of the afore-mentioned values (e.g., 50 mm to about 5 m, from about 250 mm to about 500 mm, or from about 500 mm to about 5 m). The build module, optical chamber, and/or processing chamber may comprise any (e.g., be formed of a) material comprising an organic (e.g., polymer or resin) or inorganic material (e.g., a salt, mineral, acid, base, or silicon-based compound). The build module and/or processing chamber may comprise any material disclosed herein (e.g., elemental metal, metal alloy, an allotrope of elemental carbon, ceramic, or glass).

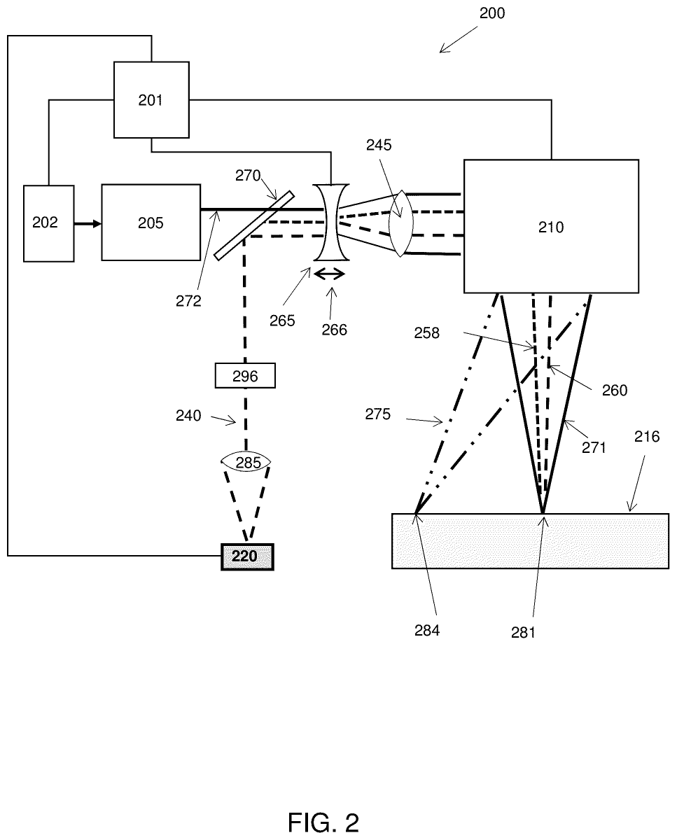

In some embodiments, the 3D printer comprises a detection system. The detection system may detect one or more characteristics and/or features of a transforming agent (e.g., detecting an energy beam footprint at the target surface). In some embodiments, the detection system detects one or more characteristics and/or features caused by the transforming agent (e.g., on the target surface). For example, a detection system may detect (i) a position at which the transforming agent (e.g., energy beam or binding agent) contacts a surface (e.g., the target surface), (ii) a shape of the footprint of the transforming agent at the (e.g., target) surface, (iii) an XY offset of a (e.g., first) transforming agent footprint position at the (e.g., target) surface with a (e.g., second) transforming agent footprint position at the (e.g., target) surface, and/or (iv) an XY offset of an transforming agent footprint with respect to an intended position of the footprint at the (e.g., target) surface. In some embodiments, the detection system detects one or more characteristics and/or features of an electromagnetic radiation. In some embodiments, the detection system detects one or more characteristics and/or features of a thermal radiation. FIG. 2 shows an example of a (e.g., optical) detection system (e.g., FIG. 2, 200) as part of a 3D printer. The detection system may be operatively coupled to at least one component of the processing chamber. The at least one component of the processing chamber may comprise the energy beam, the controller, the target surface, or the platform. The detection system may be operatively coupled to the build module. The detection system may be a part of or separate from the optical system. The detection system may be operatively coupled to an energy source (e.g., FIG. 2, 202). The energy source may be any energy source disclosed herein. The energy source may irradiate with a transforming energy (e.g., beam). The transforming energy may heat (e.g., and transform) a material at the target surface, and subsequently emit an electromagnetic radiation of a different wavelength (e.g., a thermal radiation, e.g., a black body radiation) and/or be reflected (e.g., away from the material) (e.g., FIGS. 2, 258 and/or 260). The different wavelength may be a larger wavelength as compared to the wavelength of the irradiating energy by the energy source. For example, a laser may emit laser energy towards the target surface at a position, which irradiation will cause the irradiated position to heat (e.g., and melt). The laser irradiation may be reflected from the target surface (e.g., exposed surface of a material bed). The heating of the position at the target surface may cause emittance of heat radiation. The heat radiation may have a larger wavelength as compared to the laser irradiation wavelength. At times, the irradiating energy may illuminate the enclosure environment. At times, the target surface may be illuminated by the energy beam (e.g., direct or reflected) or the produced thermal radiation. At times, the enclosure environment may include a separate illumination source (e.g., a light-emitting diode (LED)). The back reflected irradiating energy, and/or the electromagnetic radiation of a different wavelength may be referred to herein as “the returned energy beams.” The returned energy beams may be detected via one or more detectors. The detection may be performed in real-time (e.g., during at least a portion of the 3D printing). For example, the real-time detection may be during the transformation of the pre-transformed material (e.g., using the energy beam). The irradiating energy may be focused on a position at the target surface. The returned energy beams may be focused on their respective detectors. In some embodiments, the irradiating energy is focused on a position at the target surface as at least a portion of the returned energy beams are focused on at least one of their respective detectors. The returned energy beam can provide energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm 3000 nm, or 3500 nm. The returned energy beam can provide energy at a peak wavelength between any of the afore-mentioned peak wavelength values (e.g., from about 100 nm to about 3500 nm, from about 1000 nm to about 1500 nm, from about 1700 nm to about 2600 nm, or from about 1000 nm to about 1100 nm). In some embodiments, the detection system may comprise aberration-correcting optics (e.g., spherical aberration correcting optics, chromatic aberration correcting optics, achromatic optics, apochromatic optics, superachromatic optics, f-theta achromatic optics, or any combinations thereof). In some embodiments, the aberration-correcting optics is devoid of an f-theta lens. In some embodiments, the aberration corrective optics is devoid of f-theta achromatic optics. The detector of the returned energy beam may detect the energy at the above mentioned peak wavelengths. The peak wavelength may be a wavelength at full width at half maximal of the energy profile of the returned energy beam.

In some embodiments, a detector is arranged to follow the processing location of the directed energy beam to the target material. For example, the detector (e.g., a field of view thereof) may move along with a point at which the energy beam is incident upon the target material. The processing location may comprise (i) a footprint of the energy beam on a target surface, (ii) a transformed portion that comprises the target surface, or (iii) a heated portion that comprises the target surface. In an embodiment, an optical system includes a detector (e.g., FIG. 2, 220) operable to detect one or more characteristics of the target surface (e.g., comprising a material). For example, the detector may be operable to detect one or more characteristics of the target surface (or a portion thereof). The detector can be operated continuously or controlled to operate at a selected time (e.g., selected time intervals). The detector may operate before, during, and/or after processing of the target material (at the target surface). The detector can be formed with at least one radiation-sensitive detector. The detector can be adapted to detect a selected wavelength (e.g., wavelength span) of radiation. The radiation may be an electromagnetic radiation. The wavelength of the electromagnetic radiation may comprise a wavelength in the ultraviolet band, visible band, or infrared (IR) band. According to some embodiments, different radiation detectors detect different wavelengths, respectively. For example, a near-IR wavelength for a first radiation detector, and an IR wavelength for a second radiation detector.

FIG. 2 shows an example of a (e.g., optical) detection system 200 that may be operatively coupled to a platform. The platform may be a part of a (e.g., 3D) printing system. In the example of FIG. 2 an energy source 202 provides an energy beam to a collimator 205, and the collimated energy beam 272 is incident on a beam splitter 270. In the example of FIG. 2, the energy beam passes through optical elements 265 (e.g., a diverging lens, capable of translating 266) and 245 (e.g., a converging lens) to a scanner 210 (e.g., any scanner described herein). In some embodiments, one or more optical elements (e.g., lenses, FIG. 2, 285) may be placed preceding the one or more detectors, and along the path of the returning energy beam. Optionally, there may be one or more filter elements (e.g., 296) placed before each of the optical element. The optical element may maintain the focus of the detector energy beam on each detector (e.g., simultaneously with maintaining the focus of the transforming energy beam on the target surface). An arrangement of the one or more lenses may comprise a variable optical axis focusing arrangement (e.g., variable focus mechanism). While not depicted in the example of FIG. 2, it should be appreciated that more than one or more optical elements can be present between the optical element (e.g., 265) and the scanner (e.g., 210) (e.g., a second converging lens). The scanner (e.g., 210) can be operable to direct an energy beam onto a material, for example, via optical paths (e.g., 271 and 275) toward target positions (e.g., 281 and 284, respectively) of a target surface (e.g., 216). At least one controller may be operatively coupled with at least one of (a) a transforming agent generator (e.g., 202, e.g., energy source or dispenser), (b) an optical element (e.g., 266), (c) a guidance element (e.g., 210, e.g., a guidance system) and/or (d) a detector (e.g., 220). Irradiation of the target surface can generate characteristic radiation (e.g., electromagnetic radiation) at or near the targeted position of the target material. Near the targeted position may be at most 2, 3, 4, 5, 6, 7, or 10 FLS of the energy beam (e.g., cross sectional diameter of the energy beam, or diameters of the footprint of the energy beam on the target surface).

The variable focus mechanism may comprise one or more optical elements. At least one of the one or more optical elements may be stationary. At least one of the one or more optical elements may be movable (e.g., translatable, rotable, or any combination thereof). The energy beam path may be controlled manually and/or by a controller; before, after, and/or during the printing. The controller may control positions of the optical elements, e.g., to adjust the focus of the energy beam on the target surface and/or on a detector. The controller may consider (e.g., take into account) an energy beam selection path for adjusting the focus of the energy beam on the target surface. The optical element may be a negative optical element (e.g., a concave lens or a diverging lens). The optical element may be a positive optical element (e.g., a convex lens or a converging lens). The optical element may be planar. The optical element may comprise a (e.g., objective) lens, a mirror, a reflective objective, a prism, a beam splitter, an optical window, a filter, a polarizer, a grating, a retarder, a fiber (e.g., expander), a beam shaper, or a collimator (e.g., as in a Galilean and/or Newtonian telescope).

In some embodiments, an optical element comprises a material having a low (e.g., thermal) conductivity. For example, materials having a low conductivity may include those having a conductivity at 300K of no greater than about 2 Watts per meters times Celsius degrees ° C. (W/m° C.). For example, materials having a high (e.g., thermal) conductivity may include those having a conductivity at 300K that is greater than about 2 W/m° C. The optical element material may include SCHOTT N-BK 7®, SCHOTT N-SF2, UV fused silica (e.g., UV fused silica), Pyrex®, Zerodur®, fused silica, fused quartz, sodium carbonate (Na₂CO₃), lime (CaO), magnesium oxide (MgO), aluminum oxide (Al₂O₃), boron trioxide (B₂O₃), soda (Na₂O₃), barium oxide (BaO), lead oxide (PbO), potassium oxide (K₂O), zinc oxide (ZnO), and/or germanium oxide (GeO₂), calcium fluoride (CaF₂), magnesium fluoride (MgF₂), crystal quartz, sapphire, zinc selenide (ZnSe), zinc sulfide (ZnS), potassium fluoride (KF), barium fluoride (BaF₂), gallium arsenide (GaAs), germanium, lithium fluoride (LiF), magnesium fluoride (MgF₂), potassium bromide (KBr), potassium chloride (KCl), crystalline silicon, beryllium and/or silicon carbide (SiC).

In a forming process (e.g., 3D printing), a requested 3D object can be formed (e.g., printed) according to forming (e.g., printing) instructions. The forming instructions may at least in part consider a model of a requested 3D object. The model may comprise a digital model, a computer model, a geometric model, a corrected geometric model, a test model, a marked model, or a marked geometric model. The geometric model may comprise a CAD model. The geometric model may be a virtual model (e.g., a computer-generated model of the 3D object). The geometric model may be a virtual representation of the geometry and/or the topology of the 3D object (e.g., in the form of 3D imagery). In some cases, a geometric model corresponds to an image (e.g., scan) of an object (e.g., a test object). The scan can be a 3D or a 2D scan. The model of a marked 3D object may be incorporated in a (e.g., printing) instruction to generate a physically (e.g., structurally) marked 3D object (also referred herein as the “test 3D object”, “test object” or “test part”) that incorporates one or more physical markers. The one or more markers may be referred to herein as “physical markers,” “structural markers” or “test markers” (e.g., depending on the type of object). The structural marker may be a geometric marker. A model of the object can have one or more markers (also referred to herein as “model markers,” “image markers,” “virtual markers” or “digital markers,” depending on the type of model) corresponding to the one or more physical markers. A model of a 3D object, test object, and the markers may be any of the ones disclosed in patent application serial number PCT/US17/54043, titled “THREE-DIMENSIONAL OBJECTS AND THEIR FORMATION,” that was filed on Sep. 28, 2017, which is incorporated herein in its entirety.

At times, a formed (e.g., printed) portion of the 3D object may (e.g., substantially) deviate from the model of the 3D object during and/or after the forming (e.g., 3D printing), e.g., during and/or after the formation of the hardened material. Substantially deviate may be in relation to the intended purpose of the 3D object. For example, manufacturing requirements may dictate that a particular dimension of the 3D object is within a specified threshold (e.g., tolerance). Such deviation may comprise a deformation.

In some embodiments, the 3D object is generated with respect to a (e.g., virtual) model of a requested 3D object. The 3D object model may comprise a simulated model. The model may be a computer-generated model. The 3D object model may comprise a (e.g., 3D object) surface. In some embodiments, the generated 3D object may be generated with the accuracy of at least about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm with respect to a model of the requested 3D object. With respect to a model of the requested 3D object, the generated 3D object may be generated with the accuracy of any accuracy value between the afore-mentioned values (e.g., from about 5 μm to about 100 μm, from about 15 μm to about 35 μm, from about 100 μm to about 1500 μm, from about 5 μm to about 1500 μm, or from about 400 μm to about 600 μm). The 3D object (e.g., solidified material) that is generated for the customer can have an average deviation value from the intended dimensions of at most about 0.5 microns (μm), 1 μm, 3 μm, 10 μm, 30 μm, 100 μm, 300 μm or less. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dᵥ+L/K_{dv}, wherein Dᵥ is a deviation value, L is the length of the 3D object in a specific direction, and Kay is a constant. Dᵥ can have a value of at most about 300 μm, 200 μm, 100 μm, 50 μm, 40 μm, 30 μm, 20 μm, 10 μm, 5 μm, 1 μm, or 0.5 μm. Dᵥ can have any value between the afore-mentioned values (e.g., from about 0.5 μm to about 300 μm, from about 10 μm to about 50 μm, from about 15 μm to about 85 μm, from about 5 μm to about 45 μm, or from about 15 μm to about 35 μm). Kay can have a value of at most about 3000, 2500, 2000, 1500, 1000, or 500. K_{dv} can have any value between the afore-mentioned values (e.g., from about 3000 to about 500, from about 1000 to about 2500, from about 500 to about 2000, from about 1000 to about 3000, or from about 1000 to about 2500).

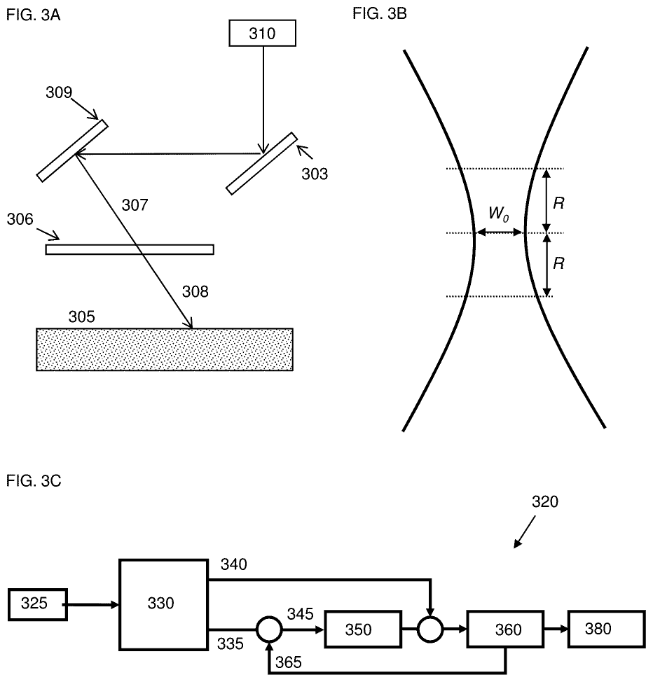

In some embodiments, the printer includes an optical system. The optical system may be used to control the one or more transforming agents (e.g., energy beams). The energy beams may comprise a single mode beam (e.g., Gaussian beam) or a multi-mode beam. The optical system may be coupled with or separate from the enclosure. The optical system may be enclosed in an optical enclosure (e.g., FIG. 1, 131). FIG. 3A shows an example of an optical system in which an energy beam is projected from the energy source 310, and is deflected by two mirrors 303 and 309, and travels through an optical element 306 prior to reaching target 305 (e.g., an exposed surface of a material bed comprising a pre-transformed material and/or hardened or partially hardened material such as from a previous transformation operation). The optical system may comprise more than one optical element. In some cases, the optical element comprises an optical window (e.g., for transmitting the energy beam into the enclosure). In some embodiments, the optical element comprises a focus altering device, e.g., for altering (e.g., focusing or defocusing) an incoming energy beam (e.g., FIG. 3A, 307) to an outgoing energy beam (e.g., FIG. 3A, 308). The focus altering device may comprise a lens. In some embodiments, aspects of the optical system are controlled by one or more controllers of the printer. For example, one or more controllers may control one or more mirrors (e.g., of galvanometer scanners) that directs movement of the one or more energy beams in real time. Examples of various aspects of optical systems and their components can be found in U.S. patent application Ser. No. 15/435,128, filed on Feb. 16, 2017, titled “ACCURATE THREE-DIMENSIONAL PRINTING;” international patent application number PCT/US17/18191, filed on Feb. 16, 2017, titled “ACCURATE THREE-DIMENSIONAL PRINTING;” European patent application number EP17156707.6, filed on Feb. 17, 2017, titled “ACCURATE THREE-DIMENSIONAL PRINTING;” international patent application number PCT/US17/64474, filed Dec. 4, 2017, titled “OPTICS, DETECTORS, AND THREE-DIMENSIONAL PRINTING;” and international patent application number PCT/US18/12250, filed Jan. 3, 2018, titled “OPTICS IN THREE-DIMENSIONAL PRINTING,” each of which is entirely incorporated herein by reference.

In some cases, the optical system modifies a focus of the one or more energy beams at the target surface. In some embodiments, the energy beam is (e.g., substantially) focused at the target surface. In some embodiments, the energy beam is defocused at the target surface. An energy beam that is focused at the target surface may have a (e.g., substantially) minimum spot size at the target surface. An energy beam that is defocused at the target surface may have a spot size at the target surface that is (e.g., substantially) greater than the minimum spot size, for example, by a pre-determined amount. For example, a Gaussian energy beam that is defocused at the target surface can have spot size that is outside of a Rayleigh distance from the energy beams focus (also referred to herein as the beam waist). FIG. 3B shows an example profile of a Gaussian beam as a function of distance. The target surface of a focused energy beam may be within a Rayleigh distance (e.g., FIG. 3B, R) from the beam waist (e.g., FIG. 3B, W₀). A distance over which the focused laser spot has a constant diameter and constant irradiance (e.g., at a given power of the energy source) may be referred herein as “depth of focus.”

In some cases, one or more controllers control the operation of one or more components of a manufacturing device. For example, one or more controllers may control one or more aspects (e.g., movement and/or speed) of a layer forming apparatus. One or more controllers may control one or more aspects of a transforming agent provider (e.g., energy beam power, scan speed and/or scan path). One or more controllers may control one or more aspects of an energy beam optical system (e.g., energy beam scan path and/or energy beam focus). One or more controllers may control one or more operations of a gas flow system (e.g., gas flow speed and/or direction). In some embodiments, one or more controllers control aspects of multiple components or systems. For example, a first controller can control aspects of the energy source(s), a second controller can control aspects of a layer forming apparatus(es), and a third controller can control aspects of a gas flow system. In some embodiments, one or more controller controls aspect of one component or system. For example, multiple controllers may control aspects of an optical system. For instance, a first controller can control the path of the one or more energy beams, a second controller may control scan speed of the one or more energy beams, and a third controller may control a focus of the one or more energy beams. As another example, multiple controllers may control aspects of an energy source. For instance, a first controller can control the power of one or more energy beams, a second controller may control pulsing (e.g., pulse versus continuous, or pulse rate) of the one or more energy beams, and a third controller may control a power profile over time (e.g., ramp up and down) one or more energy beams. At times, the first controller, second controller, and the third controller are the same controller. At times, at least two of the first controller, second controller, and the third controller are different controllers. Any combination of one or more controllers may control aspects of one or more components or systems of a printer. The one or more controllers may control the operations before, during, and/or after the printing, or a portion of the printing (irradiation operation).

In some instances, the controller(s) can include (e.g., electrical) circuitry that is configured to generate output (e.g., voltage signals) for directing one or more aspects of the apparatuses (or any parts thereof) described herein. FIG. 3C shows a schematic example of a (e.g., automatic) controller (e.g., a control system, or a controller) 320 that is programmed or otherwise configured to facilitate formation of one or more 3D objects. The controller may comprise an electrical circuitry. The controller may comprise a connection to an electrical power. The controller (e.g., FIG. 3C, 320) can comprise a subordinate-controller 350 for controlling formation of at least one 3D object (e.g., FIG. 3C, 380).

The controller may comprise one or more loop schemes (e.g., open loop, feed-forward loop and/or feedback loop). In the example of FIG. 3C, the controller optionally includes a feedforward control 340 and/or feedback control loop 365. The subordinate-controller may be an internal-controller. The controller (e.g., or subordinate controller) may comprise a PID loop. The subordinate-controller can be a second-controller as part of the first controller. The subordinate-controller can be a linear controller. The controller may be configured to control one or more components of the forming tool. The controller may be configured to control a transforming agent generator (e.g., an energy source, a dispenser of the binding agent and/or reactive agent), a guidance mechanism (e.g., scanner and/or actuator), at least one component of a layer dispenser, a dispenser (e.g., of a pre-transformed material and/or a transforming agent), at least one component of a gas flow system, at least one component of a chamber in which the 3D object is formed (e.g., a door, an elevator, a valve, a pump, and/or a sensor). The controller (e.g., FIG. 3C, 320) may be configured to control (e.g., in real time, during at least a portion of the 3D printing) a controllable property comprising: (i) an energy beam power (e.g., delivered to the material bed), (ii) an attribute (e.g., temperature) at a position in the material bed (e.g., on the forming 3D object), (iii) energy beam speed, (iv) energy beam power density, (v) energy beam dwell time, (vi) energy beam irradiation spot (e.g., on the exposed surface of the material bed), (vii) energy beam focus (e.g., focus or defocus), or (viii) energy beam cross-section (e.g., beam waist). The controller (e.g., FIG. 3C, 320) may be configured to control (e.g., in real time, during at least a portion of the 3D printing) a controllable (e.g., binding and/or reactive agent) property comprising: (i) strength (e.g., reaction rate), (ii) volume (e.g., delivered to the material bed), (iii) density (e.g., on a location of the material bed), or (iv) dwell time (e.g., on the material bed). The controllable property may be a control variable. The control may be to maintain a target parameter (e.g., temperature) of one or more 3D objects being formed. The target parameter may be a setpoint of an attribute. The target parameter may vary in time (e.g., in real time) and/or in location. The location may comprise a location at the exposed surface of the material bed. The location may comprise a location at the top surface of the (e.g., forming) 3D object. The target parameter may correlate to the controllable property. The (e.g., input) target parameter may vary in time and/or location in the material bed (e.g., on the forming 3D object). The subordinate-controller may receive a pre-determined attribute setpoint. For example, the subordinate-controller may receive a pre-determined power per unit area (of the energy beam), temperature, and/or metrological (e.g., height) target value. The target parameter may comprise forming instructions (e.g., 325). Forming instructions may be (e.g., optionally) modified by a sub-controller 330 to generate a control variable plan (e.g., that is executed by the controller 320). The subordinate-controller may receive a target parameter (e.g., FIG. 3C, 335) (e.g. temperature) to maintain at least one characteristic of the forming 3D object (e.g., dimension in a direction, and/or temperature). The controller can receive multiple (e.g., three) types of target inputs: (i) characteristic of the transforming agent (e.g., energy beam power), (ii) attribute (e.g., temperature), and (iii) geometry. Any of the target input may be user defined. The geometry may comprise geometrical object pre-print correction. The geometric information may derive from the 3D object (or a correctively deviated (e.g., altered) model thereof). The geometry may comprise geometric information of a previously printed portion of the 3D object (e.g., comprising a local thickness below a given layer, local build angle, proximity to an edge on a given layer, or proximity to layer boundaries). The geometry may be an input to the controller (e.g., via an open loop control scheme). Some of the target values may be used to form 3D forming instructions for generating the 3D object (e.g., FIG. 3C, 380). The forming instructions may be dynamically adjusted in real time. The controller may monitor (e.g., continuously) one or more signals from one or more sensors for providing feedback (e.g., FIG. 3C, 360). For example, the controller may monitor the energy beam power, attribute (e.g., temperature, wavelength, reflectivity, or specularity) of a position in the material bed, and/or metrology (e.g., height) of a position on the target surface (e.g., exposed surface of a material bed). The position on the target surface may be of the forming 3D object. The monitor may be continuous or discontinuous. The monitor may be in real-time during the 3D printing. The monitor may be using the one or more sensors. The forming instructions may be dynamically adjusted in real time (e.g., using the signals from the one or more sensors). A variation between the target parameter and the sensed parameter (e.g., 365) may be used to estimate an error in the value of that parameter (e.g., FIG. 3C, 345). The variation (e.g., error) may be used by the subordinate-controller (e.g., FIG. 3C, 350) to adjust the forming instructions. The controller may control (e.g., continuously) one or more parameters (e.g., in real time). The controller may use historical data (e.g., for the parameters). The historical data may be of previously printed 3D objects, or of previously printed layers of the 3D object. Configured may comprise built, constructed, designed, patterned, or arranged. The hardware of the controller may comprise a predictor model. The predictor model may be linear or non-linear. For example, the predictor model may be non-linear. The predictor model may comprise linear or non-linear modes. The predictor model may comprise free parameters which may be estimated using a characterization process. The characterization process may be before, during and/or after the 3D printing. The predictor model may be wired to the controller. The predictor model can be configured into the controller (e.g., before and/or during the 3D printing). Examples of a controller, subordinate controller, and/or predictor model (also referred to as “control model”) can be found in patent application serial number PCT/US16/59781; patent application serial number PCT/US17/18191; patent application serial number U.S. Ser. No. 15/435,065; patent application serial number EP17156707; and/or patent application serial number PCT/US17/54043; each of which is incorporated herein by reference in its entirety.

In a forming process (e.g., 3D printing), a requested 3D object can be formed (e.g., printed) according to forming (e.g., printing) instructions. The forming instructions may at least in part consider a (e.g., geometric) model of a requested 3D object. The geometric model may be a virtual model (e.g., a computer-generated model of the 3D object). For example, the geometric model may comprise a CAD model. The geometric model may be a virtual representation of the geometry and/or the topology of the 3D object (e.g., in the form of 3D imagery). The geometric model may correspond to an image (e.g., scan) of an object (e.g., a real object such as a test object). The image may be a scan image.

At times, 3D forming (e.g., printing) comprises one or more forming (e.g., printing) instructions (e.g., embodied in a computer-readable medium). The forming instructions, when executed, may cause a (e.g., suitable) manufacturing (e.g., 3D printing) device to perform a series of operations. The series of operations may cause (e.g., additive) formation of the 3D object. For example, the forming instructions may divide the formation of a physical 3D object into a series of physical layers (e.g., layers made of transformed material). In some embodiments, a model of a 3D object is arranged (e.g., divided) into a number of constituent portions (e.g., virtual slices). A slice of a 3D model may correspond to a (e.g., planar) section of the 3D model. In some embodiments, a series of physical layers correspond to a series of virtual slices of a geometric model. The (e.g., planar) slice may be defined by a top surface, a bottom surface, and a thickness (e.g., where top and bottom are with respect to a global vector). A thickness of a slice may correspond with a layer height (e.g., thickness) of the formed 3D object. The 3D model may be organized into a plurality of (e.g., neighboring) slices. For example, a plurality of slices may be arranged such that a top surface of a first slice is adjacent to (e.g., juxtaposed with) a bottom surface of a neighboring slice that is above the first slice (e.g., above with respect to a global vector). The first slice may be directly adjacent to the second slice. For example, the first slice may contact the second slice. In some embodiments, a (e.g., corresponding) virtual slice exists for each layer of the physically formed 3D object that is formed additively in a layer-wise manner.

In some embodiments, each slice of a geometric model comprises an associated (e.g., set of) printing instruction of a printing lap. In some embodiments, printing operations comprise (i) depositing a first (e.g., planar) layer of pre-transformed material as part a material bed, and (ii) directing an energy beam towards a first portion of the first layer of pre-transformed material to form a first transformed material. In some embodiments, the printing operations comprise (i) depositing a first (e.g., planar) layer of pre-transformed material as part a material bed, and (ii) directing a transforming agent (e.g., an energy beam or a binding agent) towards a first portion of the first layer of pre-transformed material to form a first transformed material. The transformed material may be a portion of the 3D object. The transformed material may be hardened into a hardened (e.g., solid) material as part of the 3D object. The transformed material may comprise pre-transformed material that are connected (e.g., using a binding agent, through chemical bonding such as utilizing covalent bonds, and/or by sintering). The transformed material may be embedded in a matrix (e.g., formed by a binding agent such as polymer, resin, and/or other glue). Optionally, this process may be repeated layer by layer deposition, or layerwise deposition. Another layer may be formed, for example, by adding a second (e.g., planar) layer of pre-transformed material, directing a transforming agent (e.g., an energy beam, a chemically reactive species, or a binding agent) toward a second portion of the second layer of pre-transformed material to form a second transformed material according to forming instructions of a second slice in the (e.g., geometric) computer model of the 3D object. A dispenser may deposit the binder and/or the reactive species, e.g., through an opening in the dispenser. An energy source may generate the energy beam. A dispenser may deposit the pre-transformed material, e.g., to form the material bed. In some embodiments, the 3D object is formed in a material bed. The material bed (e.g., powder bed) may comprise flowable material (e.g., powder) during the forming process. During formation of the one or more 3D objects, the material bed may exclude a pressure gradient. In some examples, the 3D object (or a portion thereof) may be formed in the material bed with diminished number of auxiliary supports and/or spaced apart auxiliary supports (e.g., spaced by at least about 2, 3, 5, 10, 40, or 60 millimeters). In some examples, the 3D object (or a portion thereof) may be formed in the material bed without being anchored (e.g., to the platform). For example, the 3D object may be formed without auxiliary supports.

In some examples the 3D object may be formed above a platform, without usage of a material bed. The 3D printing cycle may correspond with (I) depositing a pre-transformed material toward the platform, and (II) transforming at least a portion of the pre-transformed material (e.g., by at least one energy beam) at or adjacent to the platform (e.g., during deposition of the pre-transformed material towards the platform) to form one or more 3D objects disposed above the platform. An additional sequential layer (or part thereof) can be added to the previous layer of a 3D object by transforming (e.g., fusing and/or melting) a fraction of pre-transformed material that is introduced (e.g., as a pre-transformed material stream) to the prior-formed layer. The depositing in (i) and the transforming in (ii) may comprise a print increment. A dispenser may deposit the pre-transformed material, e.g., through an opening of the dispenser.

In some embodiments, forming instructions for forming (e.g., a given layer of) the 3D object(s) may comprise the utilization (e.g., selection) of one or more 3D forming (e.g., printing) procedures. A forming procedure may comprise a forming feature (e.g., an auxiliary support) or a forming process (e.g., of a plurality of forming processes). The particular forming procedure(s) (e.g., of a plurality of forming procedures) that is used to generate a given portion of the (e.g., layer of) the 3D object may consider the geometry of the 3D object. For example, the forming procedure that is used may consider: (i) a position of the given portion (e.g., with respect to a geometry of the 3D object(t); (ii) an angle of the given portion (e.g., of a normal vector at a surface of the 3D object, with respect to a global vector); (iii) an intended use of the given portion (e.g., according to an intended use of the requested 3D object); (iv) a requested (e.g., surface) characteristic of the given portion (e.g., a surface roughness or a dimensional accuracy); and/or (v) a requested material property of the given portion. The particular forming procedure(s) that is/are used to generate a given portion of the 3D object may be selected manually and/or automatically (e.g., using a controller). The selection may be before and/or during the printing of the 3D object. For example, the selection may be altered during the printing of the 3D object. The alteration may be manual (e.g., by a user) and/or automatic (e.g., using a selection tree, simulation, and/or other procedure). The alteration may consider data from one or more sensors.

In some embodiments, a forming instructions engine (e.g., module and/or program) comprises code for generation of forming instructions for at least one (e.g., each) virtual slice of a virtual geometric model. In some embodiments, the forming instructions engine considers (e.g., manual and/or automatic) selection of at least one forming process (e.g. of a plurality of forming processes) for a (e.g., each) virtual slice or slice portion. The virtual slice of a model of the 3D object may correspond to a formed layer of the 3D object. The slice portion may comprise a slice edge, or slice interior. The plurality of forming processes may comprise hatching, tiling, forming globular melt pools, forming high aspect ratio melt pools, re-transforming, annealing, or pre-heating. Examples of forming processes can be found in Patent Application serial number PCT/US18/20406, titled “THREE-DIMENSIONAL PRINTING OF THREE-DIMENSIONAL OBJECTS” that was filed Mar. 1, 2018, and in Patent Application Ser. No. U.S. 62/654,190, titled “THREE-DIMENSIONAL PRINTING OF THREE-DIMENSIONAL OBJECTS” that was filed Apr. 6, 2018, each of which is incorporated herein by reference in its entirety.

In some embodiments, an (e.g., additive) process for formation of a 3D object comprises a plurality of process variables. For example, a process variable may comprise: (i) an attribute (e.g., a temperature) at one or more positions at a target surface (e.g., of a build region), (ii) a target surface height (e.g., exposed surface of a material bed) at a position, (iii) a (e.g., average or mean) target surface planarity, (iv) a gas flow (e.g., within a build region), (v) a pressure (e.g., within a build volume), (vi) a power of an energy source that generates a transforming agent (e.g., an energy beam), (vii) an intensity of a transforming agent (e.g., power density of an energy beam), (viii) a position of a transforming agent (e.g., on the target surface), (ix) an area of effect of a transforming agent on the target surface (e.g., energy beam footprint), (x) a focus (e.g., and/or de-focus) of a transforming agent, or (xi) a transforming agent flux (e.g., energy beam fluence). The attribute (e.g., temperature) at the one or more positions may be sensed by a sensor, e.g., any sensor disclosed herein.

In some embodiments, the forming tool (e.g., 3D printer) comprises one or more detectors/sensors. In some embodiments, a controller uses data obtained from one or more detectors/sensors. The detector may comprise a sensor. The detectors (e.g., sensors) can be configured to measure one or more properties of the 3D object and/or the pre-transformed material (e.g., powder). The detectors can collect one or more signals from the 3D object and/or the target surface (e.g., by using the returning energy beams). In some cases, the detectors can collect signals from one or more optical sensors (e.g., as disclosed herein). The detectors can collect signals from one or more vision sensors (e.g. camera), thermal sensors, acoustic sensors, vibration sensors, spectroscopic sensor, radar sensors, and/or motion sensors. The optical sensor may include an analogue device (e.g., CCD). The optical sensor may include a p-doped metal-oxide-semiconductor (MOS) capacitor, charge-coupled device (CCD), active-pixel sensor (APS), micro/nano-electro-mechanical-system (MEMS/NEMS) based sensor, or any combination thereof. The APS may be a complementary MOS (CMOS) sensor. The MEMS/NEMS sensor may include a MEMS/NEMS inertial sensor. The MEMS/NEMS sensor may be based on silicon, polymer, metal, ceramics, or any combination thereof. The detector (e.g., optical detector) may be coupled to an optical fiber. Examples of a detector can be found in patent application number PCT/US15/65297, titled “FEEDBACK CONTROL SYSTEMS FOR THREE-DIMENSIONAL PRINTING” that was filed on Dec. 11, 2015, which is incorporated herein by reference in its entirety.

In some embodiments, the detector includes a sensor, e.g., a temperature sensor. The sensor may be configured to detect the attribute of the forming process. The sensor may be an optical sensor. For example, the sensor (e.g., thermal sensor) may sense an IR radiation (e.g., photons). The sensor may sense an attribute (e.g., a temperature) of at least one melt pool. The sensor may be a metrology sensor. The metrology sensor may comprise a sensor that measures the FLS (e.g., depth) of at least one melt pool. The transforming energy beam and the detector energy beam (e.g., thermal sensor beam and/or metrology sensor energy beam) may be focused on substantially the same position. The transforming energy beam and the detector energy beam (e.g., thermal sensor beam and/or metrology sensor energy beam) may be confocal.

The detector may include an imaging sensor. The imaging sensor can image a surface of the target surface comprising untransformed material (e.g., pre-transformed material) and at least a portion of the 3D object. The imaging sensor may be coupled to an optical fiber. The imaging sensor can image (e.g. using the returning energy beam) a portion of the target surface comprising transforming material (e.g., one or more melt pools and/or its vicinity). The optical filter or CCD can allow transmission of background lighting at a predetermined wavelength or within a range of wavelengths.

The detector may include a reflectivity sensor. The reflectivity sensor may include an imaging component. The reflectivity sensor can image the material surface at variable heights and/or angles relative to the surface (e.g., the material surface). In some cases, reflectivity measurements can be processed to distinguish between the exposed surface of the material bed and a surface of the 3D object. For example, the untransformed material (e.g., pre-transformed material) in the target surface can be a diffuse reflector and the 3D object (or a melt pool, a melt pool keyhole) can be a specular reflector. Images from the detectors can be processed to determine topography, roughness, and/or reflectivity of the surface comprising the untransformed material (e.g., pre-transformed material) and the 3D object. The detector may be used to perform thermal analysis of a meltpool and/or its vicinity (e.g., detecting keyhole, balling and/or spatter formation). The surface can be sensed (e.g., measured) with dark-field and/or bright field illumination and a map and/or image of the illumination can be generated from signals detected during the dark-field and/or bright field illumination. The maps from the dark-field and/or bright field illumination can be compared to characterize the target surface (e.g., of the material bed and/or of the 3D object). For example, surface roughness can be determined from a comparison of dark-field and/or bright field detection measurements. In some cases, analyzing the signals can include polarization analysis of reflected or scattered light signals.

The at least one sensor can be operatively coupled to a control system (e.g., computer control system). The sensor may comprise a light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include a temperature sensor, weight sensor, material (e.g., powder) level sensor, metrology sensor, gas sensor, or humidity sensor. The metrology sensor may comprise a measurement sensor (e.g., height, length, width, angle, and/or volume). The metrology sensor may comprise a magnetic, acceleration, orientation, or optical sensor. The sensor may transmit and/or receive a sound (e.g., echo), magnetic, electronic, or electromagnetic signal. The electromagnetic signal may comprise a visible, infrared, ultraviolet, ultrasound, radio wave, or microwave signal. The metrology sensor may measure at least a portion of the layer of material. The layer of material may be a pre-transformed material (e.g., powder), transformed material, or hardened material. The metrology sensor may measure at least a portion of the 3D object. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, Calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. In another example, one or more sensors (e.g., optical sensors or optical level sensors) can be provided adjacent to the material bed such as above, below, or to the side of the material bed. In some examples, the one or more sensors can sense the powder level. The material (e.g., powder) level sensor can be in communication with a material dispensing mechanism (e.g., powder dispenser). Alternatively, or additionally a sensor can be configured to monitor the weight of the material bed by monitoring a weight of a structure that contains the material bed. One or more position sensors (e.g., height sensors) can measure the height of a target surface (e.g., an exposed surface of a material bed), e.g., relative to the substrate. The position sensors can be optical sensors. The position sensors can determine a distance between one or more energy beams (e.g., a laser or an electron beam.) and a surface of the material (e.g., powder). The one or more sensors may be connected to a control system (e.g., to a processor, to a computer).

In some embodiments, at least one process variable is controllable (e.g., by at least one controller). The at least one controller may provide integrated and/or adaptive control of at least one control variable. As used herein, a control variable is a process variable that may be (e.g., at least indirectly) controlled by a manufacturing device. A control variable may comprise a control axis. In some embodiments, the at least one controller comprises a control axis for a (e.g., each) control variable. In some embodiments, the at least one controller comprises at least one spare control axis (e.g., at least one additional control axis in excess to the number of control variables). In some embodiments, the at least one controller may comprise at least about 6, 8, 10, 12, 15, or 20 control axes. The at least one controller may comprise any value between the afore-mentioned number of control axes (e.g., from about 6 to about 20 control axes, from about 6 to about 10 control axes, or from about 10 to about 20 control axes).

The at least one controller may be coupled with a manufacturing device configured for forming a 3D object. The at least one controller may receive forming instructions (e.g., from a forming instructions engine) for generating at least a portion of a 3D object. In some embodiments, a control variable may comprise: (I) a transforming agent flux (e.g., energy beam fluence), (II) attribute (e.g., temperature) at a position on a target surface (e.g., on the forming 3D object), (III) transforming agent motion (e.g., energy beam position, velocity and/or acceleration), (IV) a transforming agent intensity (e.g., energy beam power density), (V) energy beam dwell time, (VI) energy beam footprint (e.g., on the exposed surface of the material bed), (VII) energy beam focus, (VIII) energy beam cross-section, or (IX) a transforming agent source output power (e.g., energy source power). In some embodiments, transforming agent motion (e.g., along a path) is guided by a (e.g., at least one) guidance system. The target surface may be an exposed surface of a material bed.

The controller may be operatively coupled to a component of a forming system. Operative coupling may comprise physical coupling (e.g., direct physical coupling, or signal-based coupling). The physical coupling may comprise one or more wires (e.g., electrical wires). Signal-based coupling may comprise wireless coupling. The signal may comprise an electrical, magnetic, optical, or audio signal. In some instances, the software may be separated (e.g., disconnected) from the controller. In some instances, the (e.g., forming instructions engine) software may be an integral part of the controller. The software may be communicatively coupled with the controller (e.g., via TCP/IP). The software may generate a sequence of events (e.g., forming instructions). The software may be embedded in a non-transitory media, e.g., a non-transitory computer readable media (e.g., hardware). The forming instructions may be a logical sequence of events. The software may generate the forming instructions according to a plan. The plan may comprise a procedure, a design, a scheme, a planning sequence, or an algorithm. The software may consider process build parameter(s) (e.g., prescribed, real-time and/or historical). The software may consider an (e.g., thermal) analysis of a material bed and/or of the 3D object (e.g., hardened material of the forming or previously formed 3D object portion) during and/or after the printing. The (e.g., thermal) analysis may consider the physical properties of the material of (i) the starting material for the 3D object, (ii) the material bed and/or (iii) the hard material of the 3D object (or portion thereof). The thermal analysis may consider heat diffusion through the (e.g., forming) 3D object and/or its surrounding (e.g., material bed, auxiliary support, and/or platform). The analysis may comprise thermal or mechanical properties. The analysis may comprise physical behavior and/or physical characteristics of various material phases of the pre-transformed and/or transformed material (e.g., solid, liquid, gas, and/or plasma). The analysis may comprise an interplay between at least two of the material phases. The physical behavior may manifest during and/or after the forming. The physical characteristics may comprise heat capacity, heat conductance, heat response (e.g., expansion), stress response (e.g., contraction), surface tension, flow, or wetting. The thermal analysis may include dissipation of heat through the pre-transformed and/or transformed material (e.g., as part of the at least a portion of the printed 3D object).

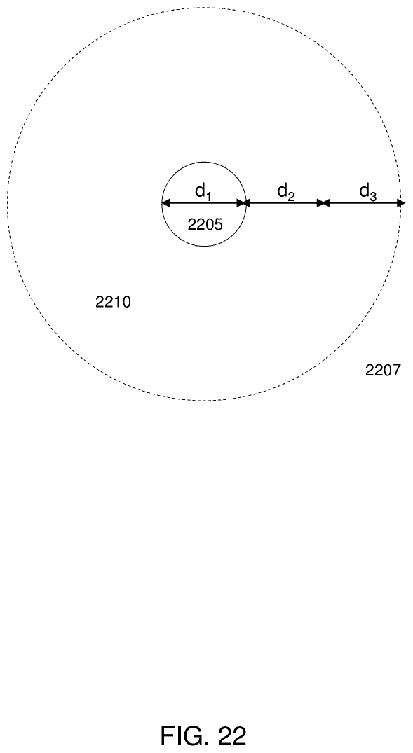

In some embodiments, at least one controller performs planning (e.g., using a planning engine) considering one or more forming instructions (e.g., received from the forming instructions engine) for at least a portion of a 3D object. For a (e.g., each) given portion of a 3D object, the forming instructions may comprise commands for at least one control variable. For example, the forming instructions may comprise commands for (a) a transforming agent source (e.g., energy beam source) power, (b) an attribute (e.g., temperature) setpoint, (c) a transforming agent flux (e.g., energy beam fluence), (d) a transforming agent motion, or (d) a transforming agent focus. A plan (e.g., for a given control variable) may comprise a sequence of setpoints (e.g., for the given control variable). For example, a plan may comprise a trajectory (e.g., a sequence of setpoints) for a transforming agent to traverse relative to (e.g., along) a target surface. Motion planning may comprise generation of at least one path for the transforming agent to traverse for forming at least a portion of a 3D object. For example, an attribute setpoint plan may correspond to a sequence of attributes of a material such as a transformed, transforming, and/or pre-transformed material, e.g., measured during formation of a given portion of a 3D object. For example, a temperature setpoint plan may correspond to a sequence of material temperatures (e.g., measured during formation of a given portion of a 3D object). The attribute (e.g., temperature) setpoint may correspond to an attribute of the material at the target surface, e.g., during, before, and/or after transformation. The attribute setpoint may correspond to at a position of transformation (e.g., during, before, and/or after transformation). The attribute may be sensed by a sensor. The attribute setpoint may correspond to a sensed attribute by the sensor. For example, the sensor may sense a characteristic at the target surface. The characteristic may correspond to the attribute. The sensed characteristic may comprise a radiation irradiated and/or emitted from a sensed position, e.g., a wavelength and/or intensity of the radiation, e.g., a variation of the sensed radiation (e.g., at the position and/or along a path of the transforming agent) over time. The sensed characteristic may be from a portion (e.g., having a FLS such as a diameter, or a radius) of (i) a footprint of the transforming agent on a target surface, and/or (ii) a transformation area (e.g., melt pool), at the target surface and/or a vicinity thereof. The vicinity may be of at most about 8, 6, 5, 4, 3, or 2 FLS from the perimeter or from a center of the (1) footprint on the target surface and/or (II) a center of the transformation area at the target surface. The FLS may be a radius or a diameter. In case of a non-circularity of the footprint and/or of the transformation area, the sensed characteristic may be from a diameter- or radius-equivalent. FIG. 22 shows an example of a transformation area (e.g., melt pool) 2205 on a target surface 2207 shown as a top view, having a diameter d₁. The target surface may comprise an exposed surface of a material bed. The melt pool 2205 in the example shown in FIG. 22, is surrounded by an area that is centered at the melt pool, and extends (for example) two melt pool diameters (designated as d₂ and d₃), out from the edge of the melt pool 2205, wherein d₁, d₂ and d₃ are (e.g., substantially) equal. A (e.g., temperature) sensor may sense an attribute (e.g., temperature) of the melt pool (e.g., FIG. 22, 2205), and/or an attribute (e.g., temperature) of the melt pool vicinity (e.g., FIG. 22, 2210). In some embodiments, a first sensor may sense a first attribute of a first region (e.g., 2205), and a second sensor may sense a second attribute of a second region (e.g., 2210). The attribute (e.g., temperature) sensed by (e.g., at least two) sensors may be used to evaluate (e.g., calculate) an attribute (e.g., temperature) gradient from to melt pool to the vicinity of the melt pool (e.g., temperature gradient between 2205 and 2210, inclusive).

In some embodiments, at least one controller organizes (e.g., divides) at least two commands from a plurality of commands (e.g., for control of the at least one control variable) by assigning the at least two commands to at least two plans (e.g., respectively) pertaining to a process variable. A plan pertaining to a process variable may comprise a sequence of setpoints (e.g., for a given control variable). The sequence of setpoints may correspond to a series (e.g., sequence) of processing commands (e.g., forming instructions). The sequence of setpoints may consider (e.g., be based on) a simulation, a calculation, an estimation, historical data, past experience, or any combination thereof. In some embodiments, a plurality of plans pertaining to process variables comprises (i) an energy source power plan, (ii) an attribute (e.g., temperature) plan, (iii) a motion plan (e.g., of transforming agent positions on a target surface), or (iv) a focus plan (e.g., of transforming agent focal setpoints). A control variable setpoint may comprise a control variable profile. A control variable setpoint may be (A) a (e.g., time-varied) function, (B) a non-time varied function, and/or (C) a value. A time-varied function may comprise a continuous or discrete function. A (time-varied or non-time varied) function may comprise a linear, polynomial, trigonometric, conic section, or logarithmic function. The function may comprise a natural exponent. The order of the polynomial may be at least 1, 2, 3, 4, 5, 6, 7, or 8 order polynomial.

In some embodiments, at least one controller is configured to generate and execute the plan(s) in real time. Real time may include, (i) during the formation of a layer of transformed material, (ii) during the formation of a layer of hardened material, (iii) during formation of a portion of a 3D object, (iv) during formation of a melt pool, (v) during formation of a singular number of melt pools, (vi) during formation of an entire 3D object, (vii) prior to consolidation, (e.g. complete) cooling, and/or solidification, of a transforming material, or (viii) any combination thereof. The singular number may be 1, 2, 3, 4, 5, 6, 7, 8, or 9. In some embodiments, at least one controller is configured to perform a conversion of a generated plan of the process parameter(s) into a (e.g., set of) low level command(s). Real time may comprise a response time (e.g., execution time) that is within about 1 microsecond, 5 microseconds, 20 microseconds, 50 microseconds, 100 microseconds, 200 microseconds, 500 microseconds, or 1000 microseconds, wherein “within” is inclusive. Real time may be any value between the afore-mentioned values (e.g., from about 1 microsecond to about 1000 microseconds, from about 5 microseconds to about 1000 microseconds, from about 5 microseconds to about 200 microseconds, or from about 200 microseconds to about 1000 microseconds). For example, at least one (e.g., all) generated plan (e.g., function) of the process parameter(s) may be converted into commands in an assembly language format. Low level commands may execute computation of the specified setpoints (e.g., of a given trajectory) in real time.

In some embodiments, a plan of control variable(s) is generated considering a hardware operational capability (e.g., limit). For example, a motion plan may be generated considering a hardware (e.g., safety) operational limit of a guidance system (e.g., of a manufacturing device) that is configured to effectuate the motion command(s). The guidance system may comprise an actuator that is coupled to the transforming agent and facilitates its movement along a trajectory. The actuator may comprise a motor. The actuator may be operatively coupled to a guidance element. A guidance element may comprise a dispenser. The actuator may be operatively coupled to at least one optical element. A guidance element may comprise at least one optical element (e.g., a scanner, e.g., a galvanometer scanner). The optical element(s) may facilitate translation of an energy beam. In some embodiments, a hardware operational limit may correspond to a physical (e.g., kinematic) limit (e.g., of a material component). For example, a hardware limit (e.g., of the actuator) may comprise a maximum acceleration or jerk, beyond which at least one component of the hardware may become damaged (e.g., to operate outside of its specified performance). In some embodiments, a power plan may be generated considering a hardware operational limit of the actuator and/or an energy source (e.g., that is configured for generating a transforming agent). For example, a power plan may be generated considering a response time with which the energy source may vary a power level (e.g., power output) of a transforming agent (e.g., energy beam fluence). For example, a power plan may be generated considering a maximum acceleration and/or jerk of an actuator (e.g., motor) configured to dispense a transforming agent at a selected intensity.

In some embodiments, forming instructions comprise motion commands for (e.g., a guidance system) direction of a transforming agent in a given coordinate system (e.g., a Cartesian coordinate system). For example, a motion command may comprise (i) a (e.g., x axis and/or y axis) path on a target surface, or (ii) a transforming agent (e.g., z axis) focus (e.g., or de-focus). A motion command may comprise a requested velocity and/or acceleration for (e.g., a given portion of) the path. In some embodiments, the at least one controller may modify (e.g., translate) forming instructions from a first representation to a second representation. For example, the at least one controller may translate motion commands from a first coordinate system to (e.g., at least) a second coordinate system. In some embodiments, a position of a transforming agent on a target surface is represented by a first coordinate system (e.g., Cartesian). In some embodiments, control of a position of a dispenser of the transforming agent, or of the transforming agent (e.g., energy beam directed to a position on a target surface) as provided by at least one guidance system component is along a second coordinate system (e.g., spherical and/or polar coordinate system). In some embodiments, motion commands may be translated between Cartesian coordinates and spherical coordinates, and/or polar coordinates. In some embodiments, a conversion (e.g., translation) from a first coordinate system to a second coordinate system comprises a calibration. For example, a (e.g., plurality of) position(s) of a guidance element may be calibrated over a (e.g., corresponding plurality of) target surface position(s) (e.g., of a transforming agent, e.g., as guided by the guidance element).

In some embodiments, the at least one controller causes at least one control variable plan to change arbitrarily (e.g., in planning for and/or during formation of a portion of a 3D object). In some embodiments, an arbitrary change may include at least one discontinuity (e.g., may not be a continuous function, or may not be a function that is continuously differentiable), may comprise a continuous function, and/or may comprise a function that is continuously differentiable. An arbitrary change may comprise an abrupt change, e.g., a step-function change. One or more process parameters (e.g., power), may adjust abruptly. One or more process parameters (e.g., trajectory) may not adjust abruptly. The ability to adjust a process parameter abruptly may depend on the mechanism that effectuate adjustment of the process parameter (e.g., electrical circuitry, signal, actuator, and/or optical component). The signal may comprise optical, audio, electrical, or magnetic signal. In some embodiments, a power plan and/or an attribute (e.g., temperature) plan may change: (i) over time, and/or (ii) considering (e.g., as a function of) a position of a transforming agent on a target surface. For example, an (e.g., energy source) power plan and/or (ii) an attribute plan, may be changed arbitrarily, e.g., while a transforming agent trajectory and/or motion plan may be (e.g., constrained to be) changed continuously. For example, for formation of at least two portions of a 3D object, a power plan and/or attribute (e.g., temperature) plan, may comprise an arbitrary change for a second portion of the 3D object with respect to the first portion. The second portion may be discontinuous with the first portion (e.g., at a given formation layer). The second portion may be formed with a transforming agent having a different intensity. For example, the second portion may be formed with a relatively large transforming agent intensity, e.g., relative to a transforming agent intensity for forming the first portion). In some embodiments, a transforming agent trajectory and/or motion plan is devoid of a discontinuity. The discontinuity may be between the first portion and the second portion.

In some embodiments, at least one controller coordinates control between at least two apparatuses of a manufacturing device (e.g., that is suitable for forming a 3D object). For example, coordinated control may be between (i) at least two transforming agent dispensers and/or sources (e.g., energy sources), and/or (ii) at least two actuators. The actuator may be operatively coupled to the dispenser and/or to at least one optical element (e.g., of guidance system that guides the energy beam along a path). The optical elements may be configured for directing at least two transforming agents (e.g., along a target surface), e.g., respectively. In some embodiments, coordinated control may be between (a) a transforming agent source, (b) an actuator, and/or (c) a transforming agent (e.g., an energy beam).

In some embodiments, at least one controller organizes control of at least one control variable into two or more sets of control variables (e.g., sets of control axes). As described herein, a set of control axes may be termed a “task”. A task may comprise commands for a subset (e.g., up to an entirety) of a plurality of control variables. A plurality of (e.g., sequential) processing operations may form a task queue. In some embodiments, the at least one controller may be coupled with at least two energy systems (e.g., for generating a respective transforming agent) and/or guidance systems (e.g., for guiding a respective transforming agent). In some embodiments, the at least one controller may comprise at least two task queues. In some embodiments, the at least one controller comprises at least one task queue for at least one (e.g., for each) transforming agent actuator (e.g., of a guidance system) and/or transforming agent energy source. The actuator may comprise one or more motors, e.g., a servo-motor. The servomotors may comprise actuated linear lead screw drive motors. The motors may comprise belt drive motors. The motors may comprise rotary encoders. The motors may comprise a moving coil direct current (DC) (e.g., rotary) motor. The motors may comprise a voice coil motor. The apparatuses and/or systems may comprise switches. The switches may be optical, capacitive, inductive and/or mechanical. The switches may comprise homing or limit switches. The motors may comprise linear actuators. The motors may comprise belt driven actuators. The motors may comprise lead screw driven actuators. The motors may comprise a material such as copper, stainless steel, iron, rare-earth magnet (e.g., an element in the lanthanide series of the periodic chart). The motors may comprise any material disclosed herein. The actuators may comprise linear actuators. The systems and/or apparatuses disclosed herein may comprise one or more pistons. The systems and/or apparatuses disclosed herein may comprise one or more encoders (e.g., for positional feedback).

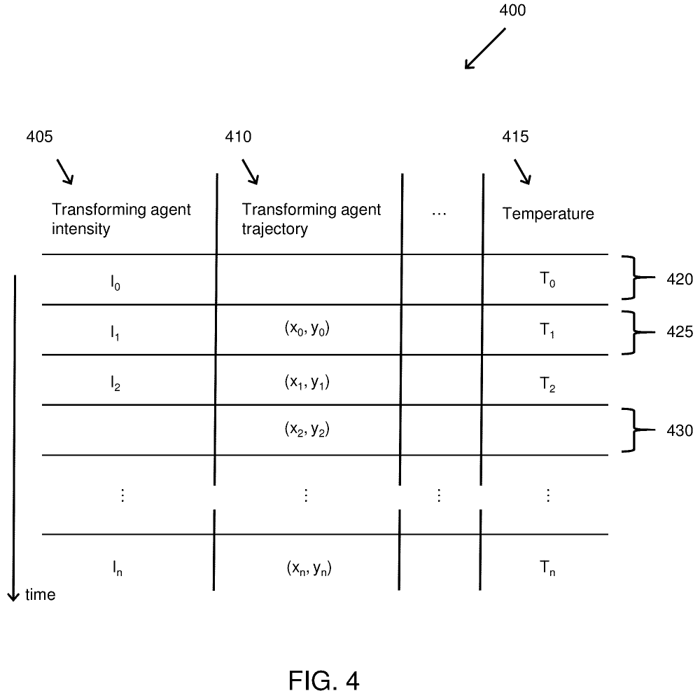

FIG. 4 depicts an example of a task (e.g., queue) 400. In some embodiments, a task comprises commands for a subset (e.g., up to an entirety) of an (e.g., available) plurality of control variables. In the example of FIG. 4, a sequence of processing operations corresponding to transforming agent control variables for intensity (e.g., 405) and trajectory (e.g., 410) are depicted, along with an attribute (e.g., temperature) control variable (e.g., 415). In some embodiments, a (e.g., processing operation of a) task comprises coordinated (e.g., synchronous) control of at least two (e.g., all) control variables organized into the task. The control variable may be, for example, the three control variables of temperature, transforming agent trajectory position, and transforming agent intensity, in row 425. processing operation of a) task comprises coordinated control that excludes at least one control variable (e.g., transforming agent trajectory position is excluded in row 420) organized into the task. In some embodiments, a (e.g., processing operation of a) task comprises control of (e.g., only) one control variable (e.g., transforming agent trajectory position only is included in row 430) organized into the task.

At times, at least two tasks may be executed in parallel. Control (e.g., of control variables) between at least two (e.g., each) tasks may be contemporaneous. Contemporaneous control may comprise coordinated or non-coordinated control (e.g., of at least two control variables). Contemporaneous control may comprise control of at least two control variables in parallel, at a given time (e.g., for a given duration), where the at least two control variables are controlled independently of each other. For example, contemporaneous control may comprise a first task comprising (e.g., a set of) first motion, power, and/or attribute (e.g., temperature) plans for a first transforming agent on build area (e.g., in first path), and a second task comprising (e.g., a set of) second motion, power, and/or attribute (e.g., temperature) plans for a second transforming agent on build area (e.g., in second, independent, path). For example, a motion of the first transforming agent may begin and/or end at different times than a motion of the second transforming agent. In some embodiments, at least one controller performs motion planning for control variables of at least two tasks independently. For example, in contemporaneous control at least one controller may perform motion planning for control variables (e.g., control axes) of a first task without considering (e.g., any) control axis limits of control variables (e.g., control axes) of a second task. In some embodiments, in contemporaneous control at least one controller may perform motion planning for control variables (e.g., control axes) using (e.g., respective) maximum control limit values (e.g., axis acceleration values).

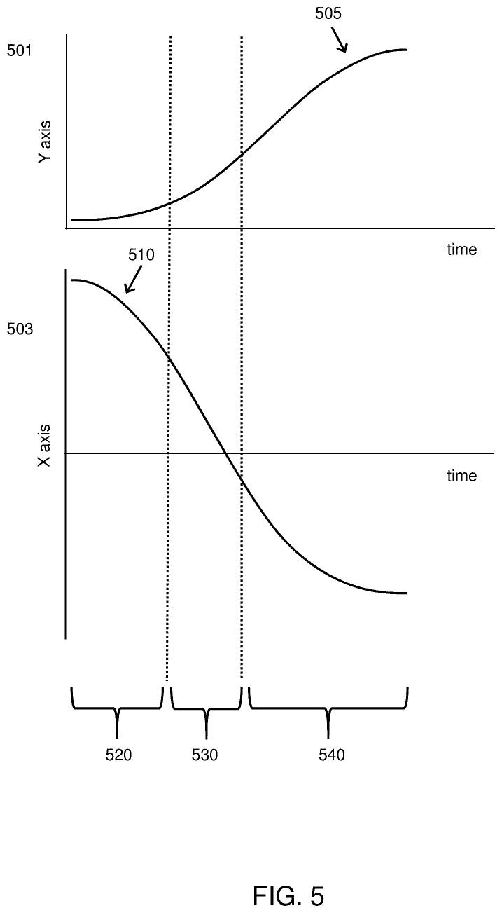

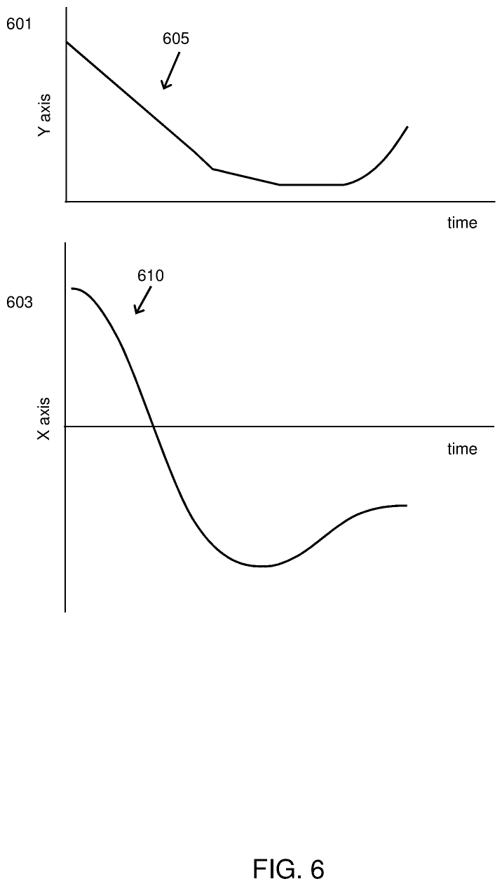

At times, control of at least two control variables may be coordinated. Coordinated control may comprise synchronous control. Coordinated control may be performed between at least two control variables within a (e.g., same) task. In some embodiments, coordinated control may be performed for all control variables within a task. Coordinated control may comprise control of at least one control variable considering a state of at least one other control variable. For example, coordinated control may comprise coordinated motion planning for at least two guidance systems that are configured to guide at least two (e.g., respective) transforming agents. Coordinated motion may include modifying (e.g., splitting) at least two coordinated motion plans into segments. A segment may comprise wherein a same type of motion is commanded (e.g., for a given segment) for all coordinated axes. A type of motion may comprise (i) an acceleration, (ii) a (e.g., constant) velocity, (iii) a duration (e.g., an initiation time and an end time for motion), or (iv) any combination thereof. For example, coordinated control may comprise synchronous motion commands for at least two axes (e.g., x-axis and y-axis) of a guidance system. In the example of FIG. 5, coordinated control between two transforming agent motion axes (e.g., y-axis 501 and x-axis 503) is depicted. FIG. 5 depicts an example of synchronized motion between the transforming agent motion axes, such that for any given period of time (e.g., 520, 530, and 540) a motion type along a given trajectory (e.g., 505 and 510) for each motion axis is the same. In the example of FIG. 5, during the period 520 the y-axis is undergoing (e.g., positive) acceleration, while the x-axis is undergoing (e.g., negative) acceleration. In the example of FIG. 5, during the period 530 the y-axis is undergoing constant (e.g., positive) velocity motion (e.g., no acceleration), and the x-axis is undergoing constant (e.g., negative) velocity motion (e.g., no acceleration). In the example of FIG. 5, during the period 540 the y-axis is undergoing (e.g., negative) acceleration, while the x-axis is undergoing (e.g., positive) acceleration. In the example of FIG. 6, non-coordinated control between two transforming agent motion axes (e.g., y-axis 601 and x-axis 603) is depicted. FIG. 6 depicts an example of contemporaneous (e.g. un-synchronized) motion between the transforming agent motion axes, such that a motion type along a given trajectory (e.g., 605 and 610) for each motion axis may vary at any given (e.g., period) of time. The guidance system may comprise an actuator. The guidance system may be operatively coupled to a dispenser or to an optical element, e.g., that guides an energy beam along a path. The at least two axes under coordinated control may undergo motion changes of the same type, and/or for the same duration (e.g., initiation and end time). For example, at least two control axes (e.g., an x-axis and a z-axis) may be commanded to have velocity changes (e.g., accelerations) for a same duration (e.g., within an error). A duration error may be to a specified duration within about 10 nanoseconds, 50 nanoseconds, 100 nanoseconds, 200 nanoseconds, 500 nanoseconds, or 1000 nanoseconds, wherein the term “within” is inclusive. A duration error may be any value between the afore-mentioned values (e.g., from about 10 nanoseconds to about 1000 nanoseconds, from about 10 nanoseconds to about 200 nanoseconds, or from about 200 nanoseconds to about 1000 nanoseconds). For example, at least two control axes may be commanded to initiate motion at a same (e.g., first) time, and to end motion at a same (e.g., second) time.

In some embodiments, coordinated control comprises at least two (e.g., all) control axes having positions that are independent of each other. For example, coordinated control may comprise motion commands for at least one (e.g., first) actuator for guiding a transforming agent along a trajectory, and for at least one (e.g., second) actuator configured to adjust a focus of a transforming agent. The first actuator may be coupled to a dispenser and/or to an optical element (e.g., of a scanner). The second actuator may be coupled to a shutter (e.g., iris and/or aperture), or a (e.g., translatable) optical element (e.g., lens). In some embodiments, at least one controller is configured to perform motion planning considering at least one dominant control axis limit. In some embodiments, at least one controller is configured to perform motion planning without considering (e.g., while ignoring) at least one dependent axis limit. A dominant (e.g., master) control axis may comprise a control axis having a lower acceleration limit, a longer (e.g., slower) response time, or that is estimated to have a (e.g., relatively) greater effect during formation of a given portion of a 3D object. A dependent (e.g., slave) control axis may comprise a control axis having a larger acceleration limit, a shorter (e.g., faster, relative to a dominant axis) response time, or that is estimated to have a lesser effect (e.g., with respect to the dominant axis) during formation of the given portion of the 3D object. In some embodiments, coordinated control may comprise reducing a (e.g., commanded) rate of motion (e.g., acceleration and/or velocity) of at least one dependent axis to match a rate of motion of a (e.g., at least one) dominant axis.

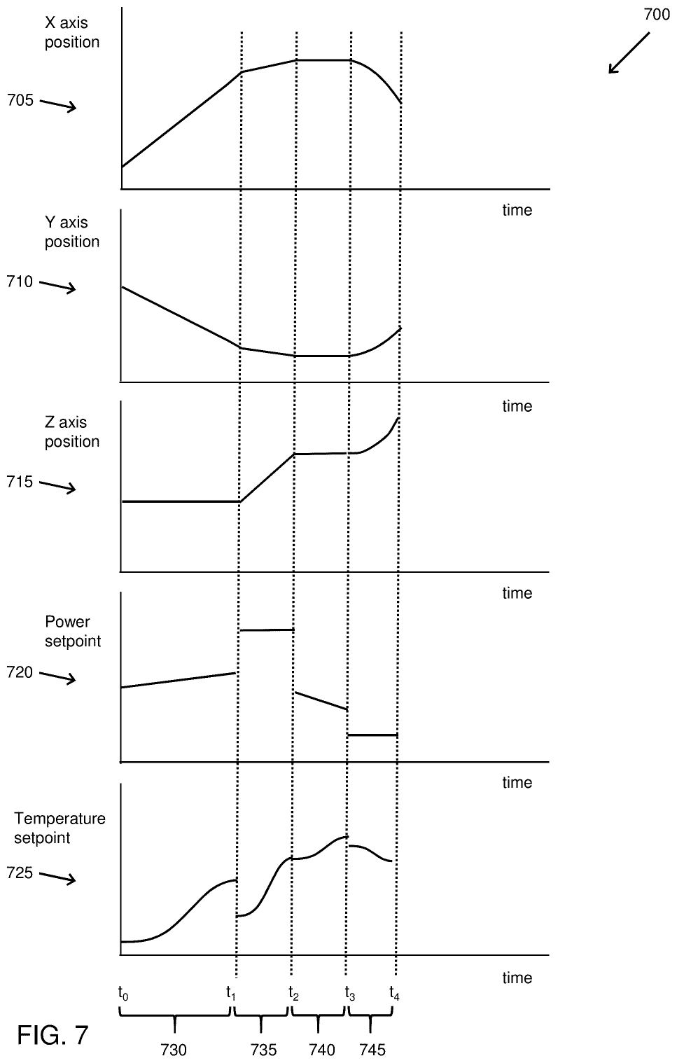

In some embodiments, a plan comprising integrated control of at least two control variables comprises chained commands. Chained commands may comprise a set of integrated control variable (e.g., second) commands that has a (e.g., time) dependency, on a (e.g., same) set of integrated control variable (e.g., first) commands. For example, chained commands for a set of integrated control variables may be provided for forming a given portion of a 3D object. The chained commands may correspond to a series of transformation procedures (e.g., hatches, tiles, depositions, and/or curing) for transforming a pre-transformed material to a transformed material. FIG. 7 depicts an example 700 of chained commands for a set of integrated control variables. In the example of FIG. 7, the set of integrated control variables includes control of: (i) a transforming agent trajectory along a target surface (e.g., x-axis 705, y-axis 710); (ii) a transforming agent (e.g., energy beam) focus (e.g., 715); (iii) a power of an energy source for generating the transforming agent (e.g., power 720 of the energy source generating an energy beam); and (iv) an attribute (e.g., temperature) setpoint (e.g., 725). The attribute may be at the transforming area (e.g., melt pool). In some embodiments, a setpoint value of a control variable may be fixed, or varied, e.g., within a given time period (e.g., control variable plan duration). In the example of the first time period 730 of FIG. 7, the transforming agent focus (e.g., 715) has a fixed value, while the values of the remaining control variables (e.g., 705, 710, 720, and 725) are varied. In some embodiments, a chained command may comprise at least one (e.g., set of) command(s) that (e.g., directly) follows another command. In the example of FIG. 7, the set of commands are chained over four (4) (e.g., sequential) time periods (e.g., 730, 735, 740, and 745). A control variable plan may comprise at least two commands that have different, or the same, duration. In the example of FIG. 7, the time period 730 is longer than the remaining time periods (e.g., 735, 740 and 745, which have the same duration).

In some embodiments, a control variable setpoint value of a later-performed command considers (e.g., depends on) the control variable setpoint value of an (e.g., immediately adjacent) earlier-performed command. For example, a control variable having a plan described by a (e.g., continuous) time-varied function may have an initial setpoint of the later-performed command that depends on (e.g., is the same as) an ending setpoint of the later-performed command. In some embodiments, control variables that correspond to a motion of a transforming agent may be described by a continuous function. In the example of FIG. 7, the transforming agent trajectory motion (e.g., 705 and 710) and focus (e.g., 715) are described by (e.g., respective) continuous functions. In the example of FIG. 7, the control variable plans described by continuous functions (e.g., 705, 710, and 715) are provided such that an ending setpoint value for a first time period (e.g., 735) is the same as a beginning (e.g., initial) setpoint value for a second (e.g. following) time period (e.g., 740).

In some embodiments, a control variable setpoint value of a later-performed command does not consider (e.g., depend on) the control variable setpoint value of an (e.g., immediately adjacent) earlier-performed command. For example, a control variable having a plan comprising at least one discontinuity in a setpoint value. A control variable plan comprising at least one discontinuity may promote a varied (e.g., reduced) response time for enacting a change for the given control variable. For example, the control variable plan comprising at least one discontinuity may promote a reduced response time with respect to a control variable plan that is devoid of any discontinuity. In some embodiments, a transforming agent trajectory and/or motion control variable does not comprise a discontinuity (e.g., any change in transforming agent position must be continuous). In some embodiments, a control variable of a transforming agent characteristic may comprise at least one discontinuity. The transforming agent characteristic may comprise (i) a transforming agent flux (e.g., energy beam fluence), (ii) a transforming agent intensity (e.g., energy beam power density), (iii) transforming agent persistence (e.g., dwell) time, (iv) transforming agent area of effect (e.g., energy beam footprint) (e.g., on an exposed surface of a material bed), or (v) an attribute such as a temperature (at a target surface location). In some embodiments, a discontinuity in a control variable plan comprising a discontinuity may be controlled in an independent manner from at least one control variable plan that is continuous (e.g., devoid of a discontinuity). For example, a (e.g., non-zero) value of a control variable for a transforming agent characteristic may be specified for selected portions of a target surface. The selected portions of the target surface may correspond to (e.g., a cross section) of a forming 3D object (e.g., in a given layer). The selected portions may comprise corresponding (e.g., continuous) control variable plans for a transforming agent motion. The continuous control variable plans may comprise non-zero (e.g., and/or varying) values for portions of the target surface that do not correspond to a forming 3D object. In the example of FIG. 7, the power setpoint 720 and the attribute (e.g., temperature) setpoint 725 include (e.g., respective) discontinuities (e.g., from 730 to 735, and from 740 to 745).

In some embodiments, a transition between a first (e.g., set of) command(s) and a second (e.g., set of) command(s) comprises a command join. For example, a command join may be positioned (e.g., inserted) between two (e.g., sequential) chained commands. A command join may comprise a trajectory methodology. In some embodiments, the command join may specify a motion (e.g., trajectory) of a transforming agent (e.g., between a first motion segment and a second motion segment). In some embodiments, a command join may specify a relationship (e.g., coordination) between at least two control variables for a duration of the join. For example, a command join may coordinate a transforming agent power setpoint with a trajectory of the transforming agent. For example, a command join may coordinate an attribute (e.g., temperature) setpoint with a transforming agent area of effect (e.g., energy beam footprint). A command join may comprise a (e.g., join type). A join type may comprise (i) a full stop (e.g., point-to-point), (ii) a fusion (e.g., blended), or (iii) a skywriting, join. A full stop command join may be positioned between a first and a second (e.g., set of) command(s). In some embodiments, for a full stop command join (e.g., any) motion of a transforming agent (e.g., across a target surface) is ceased between execution of the first command(s) and the second command(s). A full stop command join may comprise an initiation of transforming agent motion from a standstill (e.g., from a stopped position, with zero velocity), during the second command(s). In some embodiments, at least one control variable remains active during the full stop command join (e.g., between the first motion segment and the second motion segment). For example, a transforming agent power setpoint may be maintained and/or modified during a full stop command join. In some embodiments, at least one control variable is inactive (e.g., has a zero setpoint value and/or is unchanged) during the full stop command join. For example, a motion (e.g., of an x-axis, y-axis, and/or z-axis) of a transforming agent may comprise a zero (e.g. unchanging) setpoint value during a full stop command join.

In some embodiments, a command join may maintain a requested value of at least one control variable (e.g., as provided by a forming instructions engine) for at least a portion of the command join duration. For example, a full stop command join may facilitate maintaining (e.g., maintain) a requested trajectory of a transforming agent (e.g., as generated by the forming instructions engine). In some embodiments, a requested setpoint of at least one control variable may be modified (e.g., while maintaining the requested value of the at least one control variable). For example, for a given trajectory, forming instructions for a given portion of a 3D object may request a velocity and/or acceleration for a transforming agent that is beyond a hardware capability (e.g., maximum acceleration) of a component of a manufacturing device. In some embodiments, a requested velocity and/or acceleration for the transforming agent that is beyond a hardware capability (e.g., maximum acceleration) of a component causes the at least one controller to (i) modify at least a portion of a control variable plan (e.g., to be within the hardware capability), (ii) generate an alert, and/or (iii) generate an error condition (e.g., and halt formation of the 3D object). In some embodiments, while maintaining a requested trajectory of a transforming agent, a full stop command join may modify (i) a requested velocity and/or acceleration of the transforming agent, (ii) a requested transforming agent power, and/or (iii) a requested attribute such as a temperature (e.g., of a material). The modification may be in response to a request that is beyond hardware capabilities.

In some embodiments, a fusion command join comprises a variation from a requested value in (i) a transforming agent characteristic, (ii) a power setpoint of a transforming agent provider, and/or (iii) an attribute (e.g., temperature) setpoint, along a portion of at least one command sequence. The transforming agent provider may comprise a dispenser or an energy source. The dispenser may provide (e.g., by dispensing) a binding agent. The energy source may provide (e.g., by generating) an energy beam. A power setpoint of the dispenser comprises power setpoint of an actuator that is operatively coupled to the dispenser. In some embodiments, a fusion command join comprises a combination (e.g., blending) of first and second values of at least one control variable, for (e.g., corresponding) first and second commands (e.g., motion segments). For example, a fusion command join may comprise a blending of (e.g., first and second) actuator power and/or (e.g., material) attribute setpoints. The attribute setpoint may be related to a sensed attribute (e.g., temperature). The sensed attribute may be at a transformation position. The transformation position may be the position at which the transforming agent (e.g., the energy beam) transforms a pre-transformed material to a transformed material. A power of the transforming agent provider may be a power of an energy source (e.g., laser). The attribute may be at a transformation area (e.g., melt pool). For example, a fusion command join may comprise a blending of (e.g., a first and a second) velocity setpoints for a motion of the transforming agent along (e.g., an x-axis and/or a y-axis of) a target surface. The target surface may be a platform above the 3D object is formed, or an exposed surface of a material bed in which the 3D object is being formed. A blending of setpoint values may comprise: an averaging (e.g., mean), weighted averaging, linear interpolation, polynomial interpolation, spline interpolation, or normalization of the first and second setpoint values. The first and second setpoint values may correspond to an ending setpoint value (e.g., of a first command sequence) and an initial (e.g., beginning) setpoint value (e.g., of a second command sequence).

In some embodiments, a component of a manufacturing device that is suitable for forming a requested 3D object comprises a hardware limitation that promotes a deviation of at least one control variable plan from a requested set of commands (e.g., from a forming instructions engine). For example, a forming instructions engine may request a motion of a transforming agent relative to (e.g., along) a target surface that is beyond at least one hardware limitation (e.g., of a dispenser and/or guidance system) configured to provide the transforming agent to a requested position relative to the target surface. The guidance system may comprise a scanner (e.g., galvanometer scanner or an XY scanner). The guidance system may comprise one or more actuators (e.g., motors). For example, a transforming agent trajectory (e.g., sequence of x-axis and/or y-axis positions) as dispensed and/or guided may deviate from a requested trajectory. For example, a transforming agent motion (e.g., velocity and/or acceleration along a trajectory) may deviate from a requested motion. In some embodiments, at least one controller provides compensation for (e.g., any) deviation in at least one control variable plan from a requested value (e.g., according to the forming instructions). For example, the at least one controller may maintain a requested energy density and/or energy fluence of a transforming agent for forming a portion of a 3D object, while modifying a requested transforming agent motion. In some embodiments, the at least one controller determines a vectoring velocity of a transforming agent, and analyzing the vectoring velocity in conjunction with a requested (e.g., nominal) vectoring velocity (e.g., vₙ). In some embodiments, a compensation to at least one control variable may be made considering an analysis that considers the vectoring velocity (e.g., vₐ) and the nominal vectoring velocity (e.g., vₙ). The analysis may comprise comparing, correlating, matching, equating, or balancing. The compensation to at least one control variable may be referred to herein as a “velocity deviation”. For example, a transforming agent power setpoint (e.g., Pₐ) may be modified from a (e.g., nominal) power setpoint (e.g., Pₙ), considering a velocity deviation (v_{d}) that comprises a ratio of vₐ and vₙ (e.g., v_{d}=vₐ/vₙ). The ratio may comprise a modified (e.g., squared) value of vₐ or vₙ. An example of the ratio may be v_{d}=(vₐ)²/(vₙ)². In some embodiments, the transforming agent power setpoint is given by Pₐ=v_{d}*Pₙ. The transforming agent power setpoint may comprise a coefficient that modifies the velocity deviation, e.g., Pₐ=(g*v_{d})*Pₙ. The coefficient may comprise a relationship (e.g., equation or inequality). For example, the coefficient may comprise a polynomial of order 1, 2, 3, 4, 5, 6, 7, 8, or 9.

At times, the at least one controller is configured to control (e.g., direct) one or more apparatuses and/or operations. Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The controller may comprise an electronic circuitry, and electrical inlet, or an electrical outlet. The configuration may comprise facilitating (e.g., and directing) an action or a force. The force may be magnetic, electric, pneumatic, hydraulic, and/or mechanic. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) that comprises a visual, auditory, olfactory, or a tactile signal. The controller may comprise a board (e.g., motherboard), an electrical circuitry, a programmable logic device, a signal generator, a signal receiver, or a (e.g., embedded) software. The motherboard may comprise a material such as silicon, fiberglass, epoxy, silicone, or plastic. The controller may comprise a plurality of conductive connectors (e.g., leads). The leads may comprise a material such as tin-lead, nickel, gold, copper, platinum. The controller may comprise one or more communication ports. The communication port(s) may comprise a plug and/or a socket (e.g., electrical, AC power, DC power). The communication port(s) may comprise an adapter (e.g., AC and/or DC power adapter). The communication port(s) may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins. In some embodiments, the controller is configured to communicate with one or more networks. The controller may comprise at least one tangible transmission medium. Tangible transmission media may comprise coaxial cables, wire (e.g., copper wire), and/or fiber optics, including the wires that comprise a bus within the controller. The network(s) may comprise a wide-area network (WAN) or a local area network (LAN). In some cases, the controller includes one or more network interfaces that is configured to facilitate communication with the network(s). The network interface(s) may include wired and/or wireless connections. In some embodiments, the network interface(s) comprises a modulator demodulator (modem). The modem may be a wireless modem. The modem may be a broadband modem. The modem may be a “dial up” modem. The modem may be a high-speed modem. The WAN can comprise the Internet, a cellular telecommunications network, and/or a private WAN. The LAN can comprise an intranet. In some embodiments, the LAN is operationally coupled with the WAN via a connection, which may include a firewall security device. The WAN may be operationally coupled the LAN by a high capacity connection. In some cases, the controller can communicate with one or more remote computers via the LAN and/or the WAN. In some instances, the controller may communicate with a remote computer(s) of a user (e.g., operator). The user may access the computer(s) via the LAN and/or the WAN. In some cases, the controller stores and/or accesses data to and/or from data storage unit(s) that are located on one or more remote computers in communication via the LAN and/or the WAN. The remote computer(s) may be a client computer. The remote computer(s) may be a server computer (e.g., web server or server farm). The remote computer(s) can include desktop computers, personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants.

In some embodiments, the at least one controller generates a compensation during a fusion command join between a first command (e.g., sequence) and a second command (e.g., sequence). In some embodiments, a fusion command join maintains a requested value of at least one control variable, while modifying (e.g., compensating) at least one other control variable value (e.g., as provided by a forming instructions engine). In some embodiments, a transforming agent intensity setpoint and/or (e.g., material) attribute (e.g., temperature) setpoint is specified according to a (e.g., requested) position of a transforming agent on a target surface. The transforming agent intensity may comprise a power density of the energy beam, or an amount (e.g., flux) of a binding agent that flows per given time (e.g., that may consider a flow rate and a cross section of the flow stream). In some embodiments, during motion of the transforming agent relative to the target surface, a fusion command join automatically (e.g., in a pre-determined manner) modifies a transforming agent power setpoint considering any change from a requested transforming agent motion (e.g., velocity and/or acceleration). The change from the requested transforming agent motion may be from a first motion segment to a next (e.g., immediately following, subsequent, consecutive, successive, and/or connecting) motion segment. In some embodiments, a transforming agent intensity setpoint may be modified such that the fluence (e.g., of energy beam or of the binder) onto the target surface is controlled (e.g., held constant). In some embodiments, a modification to a transforming agent intensity setpoint comprises a modification to a pulse rate at which the transforming agent generator (e.g., source) generates the transforming agent. For example, a modification to an energy beam intensity (e.g., power density) setpoint comprises a modification to a pulse rate at which an energy source generates the energy beam. In some embodiments, a modification to an intensity setpoint of a transforming agent comprises a modification to an output power setpoint of the transforming agent generator. For example, for a modification to an energy beam leading to a lower power density, a power setpoint of an energy source that generates the energy beam may be lowered. For example, for a modification to an energy beam leading to a higher power density, a power setpoint of the energy source may be increased. In some embodiments, a modification to a transforming agent intensity setpoint is devoid of a modification to a pulse rate at which the transforming agent source (e.g., generator) generates the transforming agent. For example, a modification to an output power setpoint of the transforming agent generator may be devoid of a modification to a pulse rate at which the transforming agent is generated (e.g., energy beam). In some embodiments, a fusion command join controls (e.g., maintains) a requested value of a transforming agent intensity, while modifying (e.g., compensating) a position and/or motion of the transforming agent, in a given command (e.g., in order to maintain an attribute setpoint). For example, in order to facilitate maintaining a requested transforming agent intensity following a modification to a trajectory and/or motion plan of a transforming agent that leads to a lower transforming agent velocity (e.g., relative to a requested velocity along a target surface), a power output plan of a transforming agent generator may comprise a lowered setpoint. For example, in order to facilitate a modification to a trajectory and/or motion plan of a transforming agent that lead to a higher transforming agent velocity (e.g., relative to a requested velocity along a target surface), a power plan of a transforming agent generator may comprise an increased setpoint.

In some embodiments, a fusion command join is positioned between a first segment and a second segment of a transforming agent trajectory (e.g., path). The transforming agent trajectory may comprise at least one segment of the joined segments. In some embodiments, at least one segment of the joined segments comprises an inactive transforming agent processing operation (e.g., wherein the transforming agent is not transforming). In some embodiments, a fusion command join comprises de-activating a transforming agent within a duration (e.g., portion of) the join between (i) the first trajectory segment and (ii) second trajectory segment. In some embodiments, at least one segment of the joined segments comprises a stationary processing operation. In some embodiments, in the statutory processing operation, the transforming agent is transforming and is substantially devoid of motion. In some embodiments, a fusion command join comprises changing a transforming agent motion state from a moving state to a stationary state within a duration (e.g., portion of) the join between the first and second trajectory segments. In some embodiments, a fusion command join comprises changing a transforming agent motion state from a stationary state to a moving state within a duration (e.g., portion of) the join between the first and second trajectory segments.

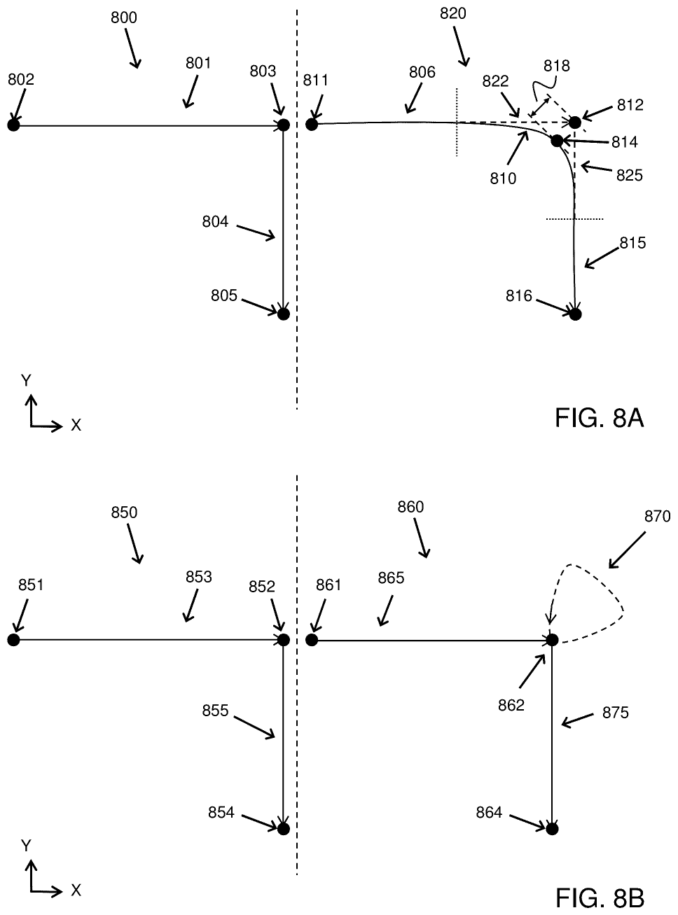

In the example of FIG. 8A, a full stop command join 800 is depicted for a transition from a first transforming agent motion segment 801 to a second segment 804. In the example of FIG. 8A, the first segment has an initial position (e.g., of the transforming agent trajectory) at point 802 and an ending position at point 803; the second segment has an initial position at point 803 and an ending position at point 805. In the example of FIG. 8A, the transforming agent trajectories (e.g., 801 and 804) follow those of requested trajectories (e.g., according to a forming instructions engine). In some embodiments, at least one transforming agent characteristic varies between a (e.g., first) segment and a following (e.g., second) segment. For example, a transforming agent motion (e.g., velocity and/or acceleration) and/or power setpoint may vary between a first segment and a second segment. In some embodiments, a full stop command join may maintain a requested transforming agent trajectory, while comprising a deviation in at least one control variable setpoint value from a requested value. The control variable setpoint value may include: a requested transforming agent motion setpoint, transforming agent intensity setpoint, power setpoint of a transforming agent generator, and/or attribute setpoint (e.g., at the transforming area). The attribute may comprise a temperature. A fusion command join may comprise a modification to a first control variable (e.g., a requested transforming agent trajectory), while maintaining a requested second control variable setpoint (e.g., transforming agent motion, power setpoint, and/or attribute setpoint). In the example of FIG. 8A, a fusion command join 820 is depicted for a transition from a third transforming agent motion segment 806 to a fourth segment 815. In the example of FIG. 8A, the third segment has an initial position (e.g., of the transforming agent trajectory) at point 811 and a requested ending position at point 812; the fourth segment has an initial requested position at point 812 and an ending position at point 816. In the example of FIG. 8A, the transforming agent trajectory segment 810 deviates from a first portion 822 and a second portion 825 of the requested trajectory (e.g., according to a forming instructions engine). In the example of FIG. 8A, a deviation 818 is depicted from the requested trajectory position 812 to the modified trajectory position 814.

In some embodiments, the at least one controller may use a time during which one portion of a forming process takes place, to adjust for an upcoming (e.g., adjoining) portion of the forming process (e.g., perform a lookahead operation). For example, the at least one controller may use an inactive period (e.g., when a transforming agent is not actively transforming) to adjust one or more control variables to a requested value (for the upcoming processing operation). For example, the at least one controller may use the skywriting path portion to adjust one or more control variables to a requested value (for the upcoming processing operation). The adjustment may include an adjustment to: (i) at least one transforming agent characteristic, (ii) a transforming agent source output power (e.g., setpoint), and/or (iii) an attribute such as a temperature (e.g., setpoint thereof).

In some embodiments, a skywriting command join comprises a modification to a command sequence (e.g., to maintain and/or achieve at least one requested control variable setpoint). The modification may comprise an insertion of a transforming agent trajectory (e.g., segment) between a first trajectory segment and a second trajectory segment. In some embodiments, a skywriting command join comprises a fusion (e.g., blending) of control variable values from a (e.g., first) segment and a (e.g., second) segment). In some embodiments, a skywriting command join does not comprise a fusion (e.g., blending) of control variable values from a (e.g., first) segment and a (e.g., second) segment). During skywriting, the transforming agent does not transform the pre-transformed material to a transformed material. For example, during skywriting the energy beam does not irradiate, e.g., in a sufficient intensity to perform a transformation of the pre-transformed material (or not irradiate any energy beam). For example, during skywriting the dispenser does not dispense, e.g., in a sufficient intensity to perform a transformation of the pre-transformed material (or not dispense any binder). An inserted transforming agent trajectory of a skywriting command join may comprise a curve (e.g., a loop). The skywriting command join loop may connect a first transforming agent trajectory segment and a second transforming agent trajectory segment, in which segments transformation of the pre-transformed material occurs. The inserted transforming agent trajectory of the skywriting command join may comprise an initial position that corresponds with an ending position of the first transforming agent trajectory segment, and an ending position that corresponds with an initial position of the second transforming agent trajectory segment. The insertion may be with respect to a set of forming instructions (e.g., as generated from a forming instructions engine). In some embodiments, the transforming agent is inactive during the inserted (e.g., skywriting) trajectory motion. Inactive may be with respect to a transformation of the pre-transformed material to a transformed material. For example, a transforming agent intensity is reduced (e.g., or is equal to zero) during the inserted trajectory motion in skywriting mode. In some embodiments, a modification to at least one transforming agent characteristic (e.g., a transforming agent flux, intensity, area of effect, motion, focus, and/or persistence) setpoint and/or a metrology is generated during a skywriting command join. The modification may be a change in a control variable value from its value at the end of the first trajectory segment to its (e.g., setpoint) value at the beginning of the second trajectory segment. For example, a modification to a transforming agent intensity setpoint may be generated during the skywriting command join. For example, a modification to a transforming agent generator characteristic (e.g., power) may be generated during the skywriting command join. For example, a skywriting command join may be specified such that a requested (e.g., initial value of a) transforming agent trajectory, motion, intensity setpoint, and/or attribute (e.g., temperature) setpoint value (e.g., from a forming instructions engine) is achieved (e.g., at an initiation of a following processing step). For example, a skywriting command join may be specified such that a transforming agent trajectory plan and/or motion plan for the (e.g., entire) first and/or second trajectory is achieved in accordance with the forming instructions. A temperature setpoint value may correspond to a temperature of a material (e.g., at a target surface), as measured by a (e.g., temperature) sensor. The material may comprise a pre-transformed, transformed, or transforming material. The sensor may be calibrated (e.g., such that a given sensor signal corresponds to a given material temperature). The sensor may be any sensor or detector described herein (e.g., a temperature sensor). The temperature sensor may sense a radiation (or a radiation range) that is emitted and/or radiated from an area at the target surface that coincides with the transforming agent area of effect (e.g., energy beam footprint), or that is adjacent thereto. The adjacent area may be within a radius (or radius equivalent if the footprint is not circular) equal to at most about 2, 3, 4, 5, or 6 footprint radii (or radii equivalents) measured from the center of the footprint. The radiation may comprise an infrared radiation. The intensity and/or wavelength of a radiation emitted from an area may correlate to the temperature at that area.

In some embodiments, an inserted skywriting command join promotes and/or causes a delay between execution of the first trajectory segment and the second trajectory segment. In some embodiments, a physical state (e.g., transformation) of a portion of a (e.g., forming) 3D object changes during the delay between the first trajectory segment and the second trajectory segment. An attribute of the portion of the 3D object may be altered during the delay. For example, a temperature and/or specularity of the portion of the 3D object may be reduced during the delay. For example, the transformed material may harden. For example, the transformed material may turn from at least partial liquid (e.g., completely liquid) to solid. In some embodiments, the at least one controller estimates (e.g., considering a model and/or a simulation) a change in the physical state of the portion of the 3D object (e.g., reduction in material temperature or change in color) during the delay. In some embodiments, the at least one controller generates a modification (e.g., compensation) to at least one control variable setpoint (e.g., of the second trajectory segment), considering the estimated change in the physical state. For example, a (e.g., compensatory) modification to at least one characteristic of the transforming agent (e.g., a transforming agent flux, intensity, area of effect, motion, focus, and/or persistence) setpoint may be generated to align with the respective characteristic requested for the second trajectory segment.

In the example of FIG. 8B, a full stop command join 850 is depicted for a transition from a first transforming agent motion segment 853 to a second segment 855. In the example of FIG. 8B, the first segment has an initial position (e.g., of the transforming agent trajectory) at point 851 and an ending position at point 852; the second segment has an initial position at point 852 and an ending position at point 854. In the example of FIG. 8B, the transforming agent trajectories (e.g., 853 and 855) follow those of requested trajectories (e.g., according to a forming instructions engine). In some embodiments, following a full stop command join at least one control variable value may deviate from a requested control variable setpoint value. For example, a value of at least one transforming agent characteristic (e.g., transforming agent velocity and/or acceleration) may deviate from a requested value. In some embodiments, a skywriting command join may achieve a requested value of the at least one transforming agent characteristic, while maintaining the requested transforming agent trajectory. In the example of FIG. 8B, a skywriting command join 860 is depicted for a transition from a third transforming agent motion segment 865 to a fourth segment 875. In the example of FIG. 8B, the third segment has an initial position (e.g., of the transforming agent trajectory) at point 861 and a requested ending position at point 862; the fourth segment has an initial requested position at point 862 and an ending position at point 864. In the example of FIG. 8B, the skywriting command join 860 comprises a (e.g., inserted) segment 870 (e.g., inserted between segments 865 and 875). In some embodiments, an inserted motion segment enables the first segment and the second segment trajectories to adhere to the requested transforming agent trajectory and motion (e.g., according to a forming instructions engine). One or more process parameters (e.g., one or more characteristics of the transforming agent) may be altered during a time at which the transforming agent does not perform transformation. For example, when the transforming agent travels without transforming. For example, when the transforming agent travels along a skywriting path segment. During the skywriting command join the transforming agent may transform as it travels along a first segment (e.g., 865), continue traveling along a skywriting segment in which it does not transform (e.g., 870), and then continue traveling along a second segment (e.g., 875) in which it performs transformation. The transformation may be of the pre-transformed material to a transformed material.

In some embodiments, during (e.g., within a duration of) a processing operation a value of at least one control variable is varied while that of at least one other control variable is maintained to be (e.g., substantially) constant. Substantially may be within a measurable and/or acceptable error. Substantially may be within a range that does not materially affect the requested outcome. For example, during formation of a portion of a 3D object, a transforming agent may be maintained to be (e.g., substantially) stationary while another transforming agent characteristic is varied. For example, a varied value may comprise (i) a transforming agent flux, intensity, persistence, or area of effect; or (ii) an attribute (e.g., temperature) setpoint. For example, an energy beam power setpoint and/or (e.g., material) attribute setpoint, may increase over the duration of the processing operation, while the energy beam is maintained at a given location (e.g., at a target surface). For example, an energy beam focus and/or footprint may be varied over the duration of the processing operation, while the energy beam is maintained at a given location (e.g., of a target surface). In some embodiments, a processing operation comprises a delay. A delay may comprise a guidance (e.g., actuator and/or scanner) of a transforming agent that maintains a (e.g., substantially) stationary position during the processing operation. The stationary position of the transforming agent during the processing operation may occur while the transforming agent is maintained in an active, or during an inactive state (e.g., energy beam is off, e.g., dispenser is not dispensing).

In some embodiments, formation of at least a portion of a 3D object proceeds considering feedback, e.g., regarding at least one process variable of the formation. For example, feedback (e.g., provided to at least one controller) may comprise (i) a transforming agent position (e.g., on a target surface), (ii) an attribute (e.g., of surface of a material), or (iii) a transforming agent source output power. In some embodiments, control of forming the 3D objects considers (e.g., relies on) at least one measurement of at least one process variable. The measurement may be using a sensor and/or detector, e.g., as described herein. The (e.g., at least one) process variable may be susceptible to (e.g., influenced by) the transforming agent intensity (e.g., power density of energy emitted by the energy beam, e.g., an amount of a binding agent that flows per given time and area). In some embodiments, the at least one process variable may be (e.g., indirectly) controlled considering the at least one measurement (e.g., as a control variable). For example, an (e.g., material) attribute (e.g., setpoint) may be varied considering the transforming agent intensity (e.g., plan). In some embodiments, at least one control variable may be controlled (e.g., regulated, monitored, modulated, varied, altered, restrained, managed, checked, and/or guided) in real-time during formation of at least the portion of the 3D object (e.g., formation of a melt pool). The material may be a pre-transformed, a transforming, or a transformed material.

In some embodiments, control of at least one control axis comprises feedback (e.g., closed loop) control. In some embodiments, at least one controller comprises a control axis for a (e.g., each) given control variable. In some embodiments, at least one controller comprises a control axis for a plurality of control variables. In some embodiments, at least one controller comprises a plurality of control axes for a control variable (of for a type of control variable). For example, at least two (e.g., different) control axes may be provided for at least two control variables (e.g., that are different). Different may comprise different types of control variables. For example, different types of control variables may correspond to different components. For example, a (e.g., distinct) control axis may be provided for a given (e.g., each) control variable. For example, the control axis may be related to a position of the transformation agent, e.g., relative to the target surface. For example, control of a transforming agent position (e.g., on a target surface) may comprise feedback regarding a (e.g., measured) x-axis and/or y-axis location of the transforming agent (e.g., relative to a target surface). The feedback may utilize signal(s) sensed by at least one sensor. The signals may correspond to an actuator and/or scanner that translate the transforming agent relative to the target surface. The at least one sensor may comprise an encoder, a current meter, or a voltage meter. An encoder may be operable to detect a position of at least one element (e.g., within a range of motion, e.g., for an actuator comprising the at least one element). For example, an encoder may detect a position of at least one element on a track, a rail, a stage, and/or about an axis of rotation. A current and/or voltage meter may be operable to detect a rate (e.g., velocity and/or acceleration) at which an actuator is commanded (e.g., driven) to move at least one element. For example, a current and/or voltage sensor may be operable to detect a motion (e.g., velocity and/or acceleration) of a (e.g., linear and/or rotary) motor that is operable to guide a guidance element (e.g., guiding a transforming agent). In some embodiments, the at least one sensor is comprised by at least one element that is operable to modify a trajectory, motion, and/or focus of the transforming agent. For example, the at least one sensor may be comprised by a guidance system that is operable to guide the transforming agent along a trajectory. For example, control of a transforming agent focus may comprise feedback regarding a (e.g., measured, e.g., z-axis) location of a focusing element that is operable to change the focus of the transforming agent. The at least one sensor may comprise an optical sensor.

In some embodiments, at least one controller provides control of at least one control axis using open loop, and/or closed loop control. The closed loop control may comprise feedback and feed-forward control. At times, closed loop control may comprise at least one filter applied to a feedback signal. The filter may comprise a low-pass filter, a high-pass filter, an infinite impulse response (IIR) filter, a notch filter, or a bandpass filter. A filter may promote a change (e.g., a delay) in a control response time. For example, a filter (e.g., applied to a feedback signal) may delay a response time in which a modification made to a setpoint value (e.g., of a control variable) is put into effect by an actuator (e.g., operable to control the control variable). The delay may be with respect to a control response time in which the control is devoid of any filtering. A delay in a control response time may promote a deviation (e.g., error) in a value (e.g., a measured value) of at least one control variable, from a requested value. The measured value may comprise a value of a signal that is generated by a sensor. For example, a measured value of an attribute such as a temperature, metrological, voltage, current, or power sensor. For example, a deviation may be introduced in an output power (of a transforming agent generator) from a requested power, and/or in a position and/or motion (of a transforming agent footprint relative to a target surface) from (1) a requested position and/or (2) a requested motion. A control variable deviation may promote a defect of at least a portion of a 3D object. The defect may be in a material characteristic, porosity, surface quality, and/or geometry, of the formed 3D object relative to the requested 3D object.

In some embodiments, a control variable that is (e.g., at least partially) controlled without the use of feedback has an improved response time. In some embodiments, at least one controller that provides integrated control of a plurality of control variables, controls at least one control variable without using a feedback control scheme (e.g., rather using an open loop and/or a feedforward control scheme). In some embodiments, at least one control axis may be controlled using at least two of (i) open loop, (ii) feedforward, and (iii) closed loop control. For example, at least one control axis may be controlled using a combination of closed loop and feedforward control schemes. For example, control of a transforming agent position (e.g., on a target surface) may comprise (I) a feedforward control scheme utilized to control a velocity and/or acceleration of the transforming agent (e.g., motion), and (II) feedback control of the transforming agent position. For example, control of an attribute (e.g., corresponding to a position at the target surface) may comprise (I) a feedforward control scheme utilized to control a source output power of a transforming agent generator, and (II) a feedback control scheme utilized to control the attribute (e.g., corresponding to a position at the target surface). The attribute may be any attribute disclosed herein. Control of the attribute (e.g., temperature) may be effectuated by controlling an attribute setpoint. In some embodiments, feedforward control promotes an improved response time for a modification to a control variable setpoint (e.g., improved with respect to control with feedback and/or filtering). In some embodiments, feedback control comprises developing a control signal while considering a feedback signal (e.g., from a control plant and/or environmental source). The feedback signal may be used to determine (e.g., evaluate) an error from a setpoint value for a control variable. For example, a controller may develop an attribute setpoint signal (e.g., according to a predictor model) while considering a feedback signal from a sensor configured to sense the attribute, e.g., a temperature sensor. In some embodiments, feedforward control may comprise a controller that delivers a control signal (e.g., directly) to a controlled component (e.g., an actuator, or a generator). For example, a controller may deliver a power setpoint signal directly to a transforming agent provider (e.g., energy source and/or dispenser).

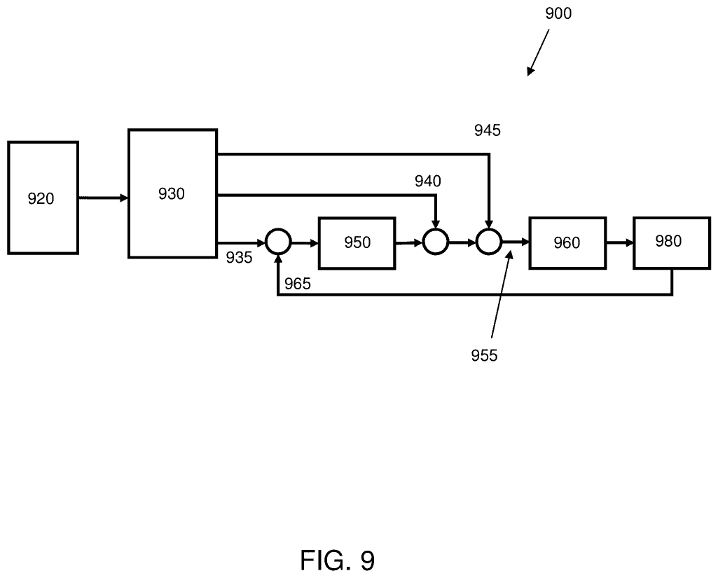

FIG. 9 depicts an example of a control scheme 900 that comprises feedforward and feedback control schemes (e.g., sub-schemes). In the example of FIG. 9, the control scheme 900 is utilized for controlling a position and/or motion (e.g., velocity and/or acceleration) of a guidance element and/or focusing element of a transforming agent (e.g., energy beam). For example, the example control scheme 900 may control a position and/or motion of a (e.g., translatable and/or rotatable) optical element (e.g., mirror, lens, prism, and/or diffraction grating). In some embodiments, a control scheme (e.g., 900) that comprises feedforward and feedback control is used for a transforming agent position and/or motion (e.g., velocity and/or acceleration, e.g., relative to a target surface). In some embodiments, a control scheme that comprises feedforward and feedback control is used for a focusing element to focus a transforming agent (e.g., on a target surface). The focusing element may comprise an optical element. The optical element may effectuate an optical zoom. In the example of FIG. 9, a trajectory, motion, and/or focus plan 920 of a transforming agent is generated (e.g., considering received instructions from a forming instructions engine). In some embodiments, forming instructions regarding a position and/or motion of a transforming agent are received in a first representation, and are modified (e.g., translated) to a second representation. In the example of FIG. 9, the control scheme includes a conversion element 930 for translating target surface coordinate values to coordinate values of at least one manipulative element 960 used for guiding and/or focusing the transforming agent. The manipulative element can be utilized to manipulate a focus of the transforming agent and/or a position of the transforming agent, relative to a target surface. For example, translating Cartesian coordinates of a target surface to spherical (e.g., or polar) coordinates of a rotational guidance element (e.g., of a galvanometer scanner). The possible position(s) of the at least one guidance element may be calibrated to (e.g., corresponding) position(s) of the target surface. In the example of FIG. 9, a position setpoint 935 (e.g., of the transforming agent, as provided by the at least one guidance element position) is provided to a closed loop control element 950; the closed loop control element outputs a (e.g., potentially modified) position setpoint that is combined with (e.g., feedforward) velocity and acceleration motion setpoints (e.g., 940 and 945, respectively). The control scheme may comprise integrating, deriving, and proportionating. In some embodiments, a (e.g., closed loop) control element comprises a proportion-integral-derivate (PID) controller.

In some embodiments, the controller comprises one or more components. The controller may comprise a processor. The controller may comprise a specialized hardware (e.g., electronic circuit). The controller may be a proportional-integral-derivative controller (PID controller). The control may comprise dynamic control (e.g., in real time during the 3D printing process). For example, the control of the (e.g., transforming) energy beam may be a dynamic control (e.g., during the forming process). The PID controller may comprise a PID tuning software. The PID control may comprise constant and/or dynamic PID control parameters. The PID parameters may relate a variable to the required power needed to maintain and/or achieve a setpoint of the variable at any given time. The calculation may comprise calculating a process value. The process value may be the value of the variable to be controlled at a given moment in time. For example, the process controller may control an attribute (e.g., a temperature) by altering the power of the energy beam, wherein the attribute is the variable, and the power of the energy beam is the process value. The attribute may vary during the forming of the 3D object. The parameters may be obtained and/or calculated using a historical (e.g., past) forming process. The parameters may be obtained in real time, during a forming process. During a forming process, may comprise during the formation of a 3D object, during the formation of a layer of hardened material, or during the formation of a portion of a layer of hardened material, or during formation of a portion of the 3D object. The output of the calculation may be the power of the energy source and/or power density of the energy beam. The calculation output may be a position of a footprint of the transforming agent on the target surface.

In some embodiments, the controller comprises a PID controller. The PID controller (e.g., control algorithm) may comprise a proportional-integral controller (i.e., PI controller), deadband, setpoint step alteration, feed forward control, bumpless operation, PID gain scheduling, fuzzy logic, or computational verb logic. The setpoint may be a target value (e.g., target attribute value such as target temperature value, or target power of the energy source). In some embodiments, the controller may comprise a plurality of setpoints (e.g., that are of different types).

The combined position, velocity and acceleration setpoints 955 are provided to the guidance and/or focusing element (e.g., 960) for actuation of the transforming agent (e.g., corresponding to the particular control axis plan). The actuation may comprise providing a voltage and/or current to an actuator (e.g., according to a voltage and/or current setpoint). In the example of FIG. 9, the transforming agent position setpoint is analyzed utilizing a measured (e.g., actual) position 965 of the transforming agent from a sensor 980 (e.g., an encoder) (e.g., to generate a position error value). In some embodiments, an encoder reading provides an (e.g., actual) position of the transforming agent on the target surface indirectly, e.g., by considering the measured position of the (e.g., calibrated) at least one guidance element (e.g., an encoder measures at least one guidance element position). A transforming agent position and/or motion control scheme may use a position error value to modify a transforming agent position setpoint value. In some embodiments, feedback (e.g., control) is provided to an actuator regarding a measured (e.g., actual) voltage and/or current output value, and analyzed with respect to a setpoint value. The actuator feedback may be provided by a voltage meter and/or a current meter.

In some embodiments, control of a (e.g., material) attribute and/or a transforming agent source output power comprises (e.g., a combination of) feedforward and feedback control. The attribute may correspond to a position at the target surface. The attribute may be sensed by a sensor, e.g., in real time. The control may consider an output value of the sensor (e.g., corresponding to an attribute such as a temperature). In some embodiments, at least one controller is configured to control an (e.g. material) attribute using feedback and/or feedforward control. In some embodiments, at least one controller is configured to control an output power of a transforming agent generator using open loop control. The attribute, controller(s), and control schemes may be any of those disclosed in: patent application serial number PCT/US17/18191, titled “ACCURATE THREE-DIMENSIONAL PRINTING” that was filed on Feb. 16, 2017; patent application serial number U.S. Ser. No. 15/435,065, titled “ACCURATE THREE-DIMENSIONAL PRINTING” that was filed on Feb. 16, 2017; and/or patent application serial number EP17156707, titled “ACCURATE THREE-DIMENSIONAL PRINTING” that was filed on Feb. 17, 2017; each of which is incorporated herein by reference in its entirety.

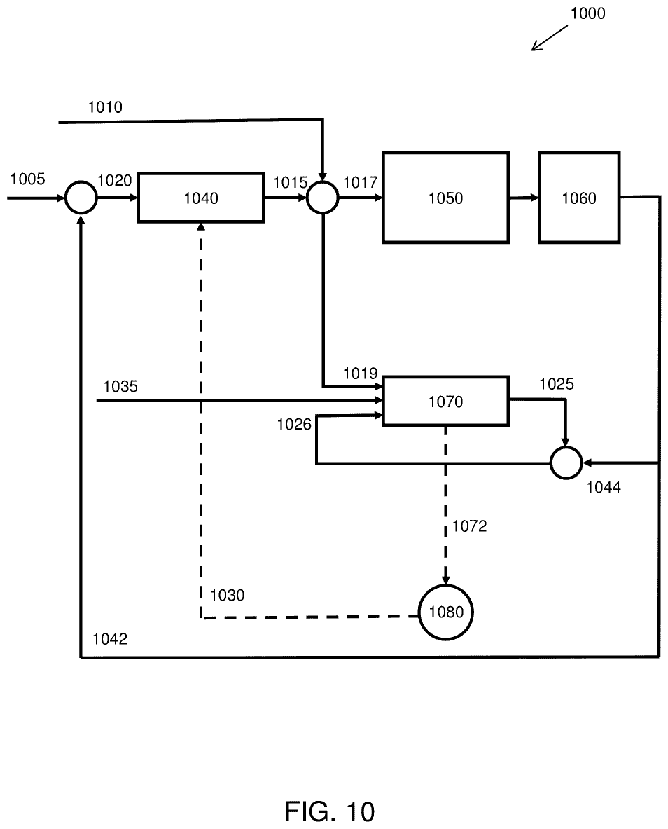

FIG. 10 shows a schematic example of a (e.g., feedforward and/or feedback) control system 1000 (e.g., embodied in at least one controller) that is programmed or otherwise configured to facilitate the formation of one or more 3D objects. The control system (e.g., 1000) may be configured to control (e.g., in an integrated manner, e.g. in real time) at least one control variable (e.g., to a target value) during formation of the one or more 3D objects. In some embodiments, the target value comprises (i) a (e.g., target) attribute (e.g., temperature), (ii) a target output power of a transforming agent generator, or (iii) a target characteristic of a transforming agent. The attribute may be of a portion of the forming 3D object(s). In some embodiments, a target attribute (e.g., temperature) is controlled for maintaining a setpoint. The attribute may correspond to at least one characteristic of at least one transforming area (e.g., melt pool). Characteristics of the transforming area may comprise a FLS of the transforming agent on the target surface. Characteristics of the transforming area may comprise a temperature, specularity, reflectivity, radiation wavelength, FLS, fluidity, viscosity, shape (e.g., of a melt pool cross section), volume, or overall shape, of a transforming material. The control system 1000 includes a (e.g., PID, e.g., sub-) controller 1040, a forming 3D object 1050, one or more sensors 1060 (e.g. attribute sensor, or a sensor sensing a characteristic that can be related to the attribute, one or more computer models for the (e.g., physical) processes of 3D printing 1070 (e.g., a predictor model, comprising a physical model or a predictor model). For example, a characteristic that can be related to the attribute temperature may comprise a wavelength of emitted and/or radiated radiation. The one or more forming 3D objects can be formed (e.g., substantially) simultaneously, or sequentially. The one or more 3D objects can be formed above a (e.g. single) platform and/or in a (e.g., single) material bed. The at least one controller may receive (e.g., from a forming instructions engine) a control variable setpoint (e.g., 1005) to achieve at least one requested characteristic of the forming 3D object. Examples of characteristics of a forming 3D objects include its attribute which may comprise a temperature and/or metrological attribute(s) (e.g., information) of a transforming area (e.g., melt pool), or a vicinity of the transforming area, e.g., as disclosed herein. The metrological attribute(s) (e.g., information) of the transforming area may comprise a FLS of the transforming portion (e.g., melt pool). Examples of characteristics of forming 3D objects comprise geometry attribute(s) (e.g. surface height) or material characteristics (e.g., porosity, surface roughness, hardness, and/or a fluid (e.g., liquidus) state) of the forming 3D object. The control variable setpoint may be time- and/or location-varied (e.g., considering a position on a target surface).

The control system (e.g., 1000) may be configured to control (e.g. in real time) a target (e.g., material) attribute, e.g., of one or more positions of a target surface (e.g., an exposed surface of a material bed). The one or more positions may comprise a position within a transforming area (e.g., melt pool), adjacent to the transforming area, or far from the transforming area. Adjacent to the transforming area may be within a distance (e.g., radius) of at least about 2, 3, 4, or 5 average transforming area radii from the center of the footprint. Adjacent to may be any distance between the afore mentioned distances (e.g., from about 2 to about 5 average transforming area radii).

In some embodiments, the control system includes a (e.g., attribute, e.g., temperature) feedback control loop, such as 1030 or 1042. The control system may use at least one signal detected (e.g., 1060) from at least one position at the transforming area and/or from a position adjacent to the transforming area. The at least one signal may be used to determine an (e.g., material) attribute at the one or more positions. The at least one signal may be used in forming the 3D object. The feedback may comprise an analysis that considers a setpoint (e.g., value) and a measured (e.g., actual) value. In the example of FIG. 10, the sub-controller 1040 generates a transforming agent source output power setpoint 1015 considering a (e.g., modified) attribute setpoint 1020; the modified attribute setpoint is provided to the sub-controller following an analysis that considers a (e.g., material) attribute setpoint 1005 and a measured (e.g., actual) material attribute value 1042. In some embodiments, the control system may use feedback from a computer model estimate of a target variable (e.g., 1072). In some embodiments, a control system feedback control loop (e.g., 1030), e.g., from a predictor model, is used (e.g., as an input) in an attribute (e.g., of a material, e.g., at a target surface) control scheme. The feedback control loop may be for the purpose of altering (e.g., adjusting) one or more target parameters to achieve convergence (e.g., of a desired or requested 3D model with the printed 3D object). In some embodiments, the predictor model may predict (i) an estimated attribute value/profile of a transforming area (e.g., melt pool), (ii) a local deformation within the forming 3D object, (iii) a global deformation and/or (iv) temperature fields. The predictor model may (e.g. further) predict corrective transforming agent (e.g., source) adjustments (e.g. in relation to a temperature target threshold). The adjustment(s) (e.g., that consider the predictions) may be based on the (i) measured and/or monitored attribute (e.g., temperature) information at a first location on the forming 3D object (e.g. a forming melt pool), (ii) at a second location (e.g. in the vicinity of the forming melt pool) and/or (iii) geometric information (e.g. height) of the forming 3D object. The target variable may be a control an attribute (e.g., a temperature of a material). The material may comprise a transformed, transforming, or pre-transformed material. The target variable may be of a physical attribute that may or may not be (e.g., directly) detectable. For example, the target attribute (e.g., variable) may be of a temperature that may or may not be (e.g., directly) measurable. For example, the target variable may be of a physical location that may or may not be (e.g., directly) measurable. For example, a physical location may be inside the (e.g., forming) 3D object at a depth that may not be directly measured by the one or more sensors. An estimated value of the target variable may be (e.g., further) compared to a critical value of the target variable. At times, the target value exceeds the critical value. In some embodiments, a target value that exceeds a critical value that causes and the predictive model to provide feedback to the at least one controller to attenuate (e.g., turn off, or reduce the intensity of) the transforming agent (e.g., for a specific amount of time).

In some embodiments, the at least one controller (e.g., further) receives at least one (e.g., pre-determined) control variable setpoint (e.g. an output power setpoint value of a transforming agent generator). The control variable setpoint may be provided using a feedforward control (e.g., 1010). Open loop and/or closed loop control schemes may comprise providing a setpoint value of a control variable (e.g., directly) to an actuator (e.g., providing an output power setpoint value directly to the transforming agent generator). Feedforward and/or open loop control may supplement (e.g., override) one or more (e.g., any) corrections and/or predictions (e.g., by the predictor model). The override may be effectuated by forcing a predefined transforming intensity (energy beam power density, or binding agent flux) to supply to the portion (e.g., of the material bed and/or of the 3D object). In some embodiments, control comprises (i) controlling a cooling rate (e.g., of the material bed, the 3D object, or a portion thereof), (ii) control the microstructure of a transformed material portion, or (iii) control the microstructure of at least a portion of the 3D object. Controlling the microstructure may comprise controlling the phase, morphology, FLS, volume, or overall shape, of the transformed (e.g., and subsequently solidified) material portion. The material portion may be a melt pool, or an area comprising a single digit number of melt pools.

In some embodiments, an output power level for a transforming agent generator is provided (e.g., directly) to the transforming agent generator that is configured to generate a transforming agent. For example, an output power level for an energy source is provided (e.g., directly) to the energy source that is configured to generate an energy beam. For example, an output power level for a dispenser may be provided (e.g., directly) to the dispenser that is configured to generate a binding agent (e.g., flux). In some embodiments, the (e.g., pre-determined) control variable (e.g., at least indirectly) controls the value of another control attribute variable (e.g., the temperature (e.g., range) of a transforming area of the forming 3D object). For example, a transforming agent intensity (e.g., at a target surface) may influence a material attribute such as temperature (e.g., at the target surface). A transforming agent intensity may be influenced (e.g., controlled) by an output power of a transforming agent generator (e.g., source). In some embodiments, the at least one pre-determined control variable setpoint (e.g., 1035) is provided to a predictor model. In some embodiments, a predictor model (e.g., that comprises a prediction model, statistical model, a thermal model, or a thermo-mechanical model) predicts and/or estimates one or more physical parameters (e.g., 1025) of the forming 3D object. The predictor model may comprise a geometric model, or a physical model. The physical model is of a forming process that forms the 3D object. The predictor model may provide feedforward information to the controller. The predictor model may provide open loop control. There may be more than one predictor models (e.g. at least 1, 2, 3, 4, 5, 6, 7, 8, 9 or 10 different predictor models). The at least one controller may (e.g., dynamically) switch between at least two predictor models to predict and/or estimate the one or more physical parameters of the forming 3D object. Dynamic includes changing predictor models (e.g., in real time) considering a user input, or considering a controller decision that may in turn be based on at least one measured control variable value of the forming 3D object. The dynamic switch may be performed in real-time (e.g., during the forming of the 3D object). The at least one controller may be configured (e.g., reconfigured) to include additional one or more predictor models and/or to readjust the existing one or more predictor models. A prediction of the one or more parameters of the forming 3D object may be done offline (e.g. predetermined) and/or in real-time. The at least one predictor model may receive sensed 3D object parameter(s) value(s) from one or more sensors (e.g., 1044). The sensed (e.g., measured) parameter(s) value(s) may comprise an attribute (e.g., temperature) sensed within and/or in the vicinity of one or more transforming areas. Within a vicinity may be within a radius of at least about 1, 2, 3, 4, or 5 average transforming area FLS from (e.g., extending from the edge of) a transforming area. The predictor model may use (e.g., in real-time) the sensed parameter(s) value(s) for a prediction and/or adjustment of at least one control variable (e.g., transforming agent source output power and/or material attribute). The predictor model may use (e.g., in real-time) geometric information associated with the requested and/or forming 3D object (e.g. transforming area geometry). The use may be in real-time, and/or off-line. Real time may comprise during the operation of the transforming agent, e.g., in which it transforms. Off-line may be during the time a 3D object is not transforming and/or during inactive time of the transforming agent. The predictor model may compare a sensed value (e.g., by the one or more sensors) to an estimated value of the at least one control variable. The predictor model may (e.g., further) calculate an error term (e.g., 1026) and readjust the at least one predictor model to achieve convergence (e.g., of a desired or requested 3D model with the printed 3D object).

A predictor model may predict and/or estimate one or more physical parameters (e.g., 1025) of the forming 3D object (e.g., in real time). In some embodiments, the predictor model is a reduced form of the 3D model of the desired 3D object. In some embodiments, the predictor model is a simplified 3D model compared to the complete 3D model of the desired 3D object. The physical parameters may comprise shape. For example, the predictor model may comprise the shape (e.g., geometry) of the 3D object. The predictor model may be used to adjust the forming of the 3D object (e.g., 3D printing). The predictor model may comprise a simulation. The simulation may comprise an imitation of a real-world process (e.g., 3D printing) over time. The simulation may comprise finite element analysis. For example, the predictor model may comprise a thermal and/or mechanical (e.g., elastic and/or plastic) simulation. For example, the predictor model may comprise thermo-mechanical (e.g., thermo-elastic and/or thermos-plastic) simulation. The predictor model may consider a material state (e.g., solid, liquid, gas, or plasma). The predictor model may consider a behavior of the material in a physical state or in a transition between material states. The predictor model may consider solid phase, liquid phase, and/or gas phase. The simulation may comprise the material(s) of the forming 3D object (e.g., material(s) in the material bed). For example, the simulation may comprise the material properties of the desired 3D object. The simulation and/or predictor model may be adjusted (e.g., using a closed loop control scheme) using one or more measured parameters. The simulation and/or predictor model may be adjusted in real-time. The predictor model may output an estimation of the parameter. The simulation and/or predictor model may use an input from the one or more sensors (e.g., power, temperature, and/or metrology sensors). The predictor model can comprise one or more free parameters. The one or more free parameters can be optimized in real time (e.g., using one or more sensor signals). The controller may comprise an internal-state-system that provides an estimate of an internal state of the 3D printer and/or 3D printing. The internal state can be derived from one or more measurements of the control variable and/or input parameters. The internal-state-system may be implemented using a computer. The internal-state-system may comprise a state-observer. The controller may comprise a state-observer. The predictor model can be a state-observer-model. The controller may comprise a reconfigurable firm-ware (e.g., flash memory). The controller may comprise a microprocessor. The controller may comprise a (e.g., programmable and/or reconfigurable) circuit. The estimated parameter may be compared with the measured parameter (e.g., 1044). The comparison may be used to alter (e.g., 1026) the predictor model. The predictor model may dynamically be adjusted in real time. The simulation may be dynamically adjusted in real-time. The prediction of the parameter may be done offline (e.g. predetermined) and/or in real-time (e.g., during the 3D printing). The predictor model may receive the sensed parameter(s) value(s). The predictor model may use the sensed parameter(s) value(s) for a prediction and/or adjustment of at least one target parameter. For example, the predictor model may use geometric information (e.g., 1035) associated with the requested and/or forming 3D object. The predictor model may set up a feedback control loop (e.g., 1030) to adjust one or more target parameters in order to achieve convergence (e.g., with the desired 3D object). The feedback loop(s) control may comprise one or more comparisons with an input parameter (e.g., 1020) and/or threshold value. Real time may be during formation of at least one: 3D object, a layer within the 3D object, dwell time of an energy beam along a path, and dwell time of an energy beam along a hatch line dwell time of an energy beam forming a melt pool. The one or more forming 3D objects can be generated (e.g., substantially) simultaneously, or sequentially. The one or more 3D objects can be formed in a (e.g., single) material bed.

In some embodiments, an expected thermo-plastic (e.g., thermal component of a thermo-mechanical model) is calculated by computing a thermal balance in the material using the following Equation 1:

$$ρ {c}_{ρ} \frac{\partial T}{\partial f} + {∇}_{x} \cdot q = ρ r ;$$

Where t is time, T=T(t, x) is the temperature field, x is a deformation point; c_{ρ}=c_{ρ}(T) is the heat capacity of the material as a function of temperature; ρ=ρ(t,x) is the density; r=r (t, x) is the energy source field per unit mass; q=−∇ₓT; and ∇ₓT is the temperature gradient. The heat capacity can include a latent heat of melting for the material and the material properties can be assumed to be temperature dependent. An expected mechanical deformation (e.g., mechanical component of a thermo-mechanical model) can be calculated by finding the function x=ϕ(t, X) using the following Equation 2, such that:

∇ₓ·P(t,X)=0;

Where P=P(t,X) is a stress tensor. The stress tensor can be the first Piola-Kirchhoff stress tensor. Equivalent forms of the above equation can comprise a different stress tensor. The different stress tensor may be a Cauchy, Nominal, Piola, second Piola-Kirchhoff, or Biot stress tensor. Equation 2 can assume inertial terms are negligible (e.g., quasistatic approximation of the momentum equation). The constitutive model for the material can be calculated and using the following Equation 3:

S=Cεₑₗ;

where S=F⁻¹P is the same or another stress tensor, e.g., the second Piola-Kirchhoff stress tensor; C is the elastic 4-tensor of the material, and εₑₗ is the elastic strain tensor.

In some embodiments, at least one controller comprises selective (e.g., configurable) feedback control. For example, the at least one controller may (e.g., selectively) operate with an open loop and/or feedforward control scheme (e.g., that is devoid of feedback). The at least one controller may comprise one or more logical switches. The logical switch may alter (e.g., turn “on” or “off”) a feedback loop control. In the example of FIG. 10, a logical switch 1080 is configured to toggle a feedback control from the at least one predictor model 1070 to the controller 1040. The alteration may utilize (e.g., consider) an estimated process and/or control variable (e.g., a temperature of a material). The estimated variable may comprise a threshold value. The estimated variable may be analyzed (e.g., compared) to a respective measured variable. For example, an estimated (e.g., material) attribute such as a temperature (e.g., at a target surface) may derive from the predictor model (e.g., which at least part of the predictor model may be in 1070). For example, the control scheme (e.g., FIG. 10) may comprise the predictor model (e.g., included in 1070). The predictor model may comprise one or more estimations of the control variable (e.g., the temperature). The predictor model may comprise analyzing a measured variable with respect to its respective control variable (e.g., the estimated variable value, threshold variable value, and/or a critical variable value).

In some embodiments, a control variable plan comprises a measurement signal (e.g., profile). The signal may be of an attribute of the forming process to form the 3D object. For example, a profile may comprise (i) a temperature, (ii) a FLS of an transforming agent footprint (on the target surface), (iii) metrology (of the target surface), (iv) power of the transforming agent generator generating the transforming agent, (v) intensity of the transforming agent, (vi) radiation from the target surface (e.g., at or adjacent to the footprint) or (vii) light reflection. The light reflection may comprise scattered light reflection or specular light reflection. The irradiation may be heat emission (e.g., IR radiation).

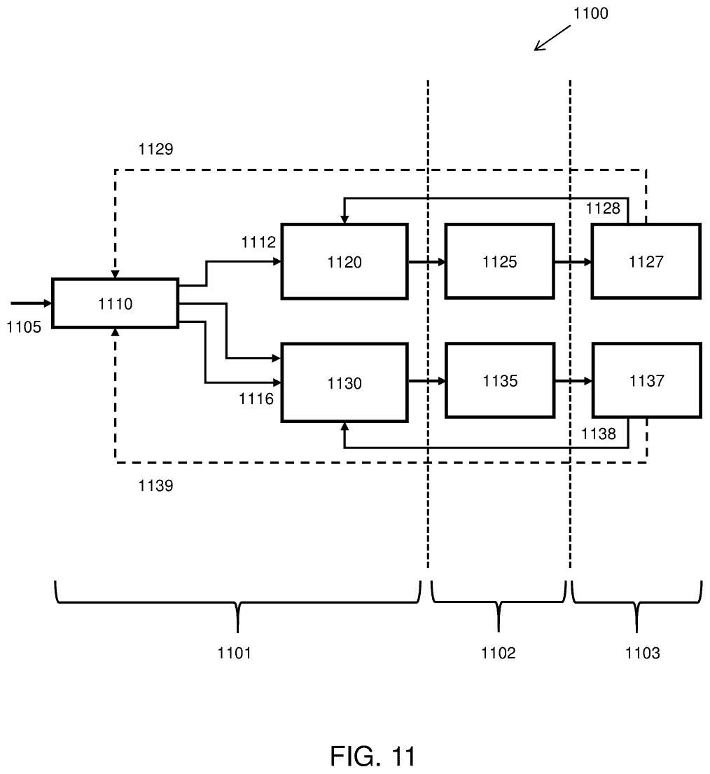

FIG. 11 depicts an example of a control system 1100 for controlling at least one control variable during formation of a 3D object. In the example of FIG. 11, components (e.g., functional blocks of) at least one controller 1101 are coupled with components of at least one manufacturing apparatus 1102 of a manufacturing device, which manufacturing device includes sensors 1103 operable to detect signals within a processing area. The manufacturing device may comprise a transforming agent generator (e.g., source) that is operable to generate a transforming agent for forming at least a portion of a 3D object. Operation of the manufacturing device may comprise control of at least one apparatus that proceeds according to a sequence of processing operations (e.g., according to a control variable plan). In the example of FIG. 11, an instruction (e.g., set) 1105 (e.g., as generated by a forming instructions engine) is provided to a planning engine 1110; the planning engine generates plans for control variables, comprising (i) a transforming agent trajectory and/or motion (e.g., 1112), (ii) a output power (e.g., 1114) of transforming agent generator, and (iii) a (e.g., material) attribute such as a temperature (e.g., 1116). The at least one controller may comprise at least one sub-controller and/or at least one functional block that is operable (e.g., using open loop, and/or closed loop control scheme(s)) to control at least one control variable. In the example of FIG. 11, a trajectory and/or motion control block 1120 of the transforming agent provides control signals to actuate an actuator 1125 (e.g., to operate with a given voltage and/or current profile). A profile may comprise a fixed or a time-varied value. The actuator may be operatively coupled to a guidance element (e.g., of a dispenser and/or a galvanometer scanner). In the example of FIG. 11, a (e.g., material) temperature control block 1130 provides control signals to actuate an actuator 1135 (e.g., to operate with a given voltage, current, pulse width modulation, and/or frequency shift modulation, profile). The actuator may be operatively coupled to a transforming agent source (e.g., an energy source and/or a binding agent source). The (e.g., effects of) operation of at least one actuator of a manufacturing device may be detected and/or monitored by at least one sensor, e.g., before, after, and/or during formation of the 3D object. In the example of FIG. 11, a sensor 1127 detects a position, velocity, and/or acceleration of a guided transforming agent (e.g., along a target surface); and a sensor 1137 detects a temperature of a (e.g., transforming) material. The transforming material may be within and/or adjacent to a transforming area (e.g., melt pool), or a footprint of the transforming agent. In some embodiments, the at least one controller uses feedback to control at least one control variable. In the example of FIG. 11, the sensor 1127 provides a feedback signal 1128 to the transforming agent position and/or motion control block 1120 regarding at least one characteristic of (i) a guidance element (e.g., actuator current) and/or (ii) transforming agent (e.g., position on a target surface). In the example of FIG. 11, the sensor 1137 provides a feedback signal 1138 to the temperature control block 1130 regarding at least one temperature characteristic (e.g., a temperature of a transforming area). In some embodiments, a control system comprises feedback to a (sub-controller), which feedback may be used to modify at least one parameter of a control model (e.g., adaptive closed loop control). In the example of FIG. 11, the sensor 1127 optionally provides feedback 1129 to the planning engine 1110, and sensor 1137 optionally provides feedback 1139 to the planning engine 1110.

In some embodiments, an integrated control scheme enables a lookahead operation to be performed by at least one controller. The integrated control scheme may be combined with one or more control plans. The control plans may or may not be predetermined. The control plans may be of at least two control variables. The control variable may be of a process parameter that is associated with a component. The component may be of a system that is utilized to form the 3D object. The lookahead operation may comprise an adjustment of at least one control variable of the component from one state to a requested setting, e.g., that is different from the one state. The one state (e.g., power, attribute such as a temperature, location, voltage, and/or power density) may be the current state of the component. The one state may be an anticipated state of the component. The requested setting of the component may be for a scheduled period during which the component is requested to be active (e.g., referred to herein as an “active period”). The adjustment to the requested setting of the component may take place during at least a portion of a time (e.g., period) at which the component is inactive (e.g., referred to herein as an “inactive period”). The lookahead operation may be performed in an inactive period that is (i) scheduled before an active period, (ii) scheduled after an active period, and/or (iii) scheduled between at least two active periods (e.g., at least one preceding active period and/or at least one following active period). The adjustment of the component may include an adjustment from a current (or anticipated) setting, to a requested setting. The adjustment may comprise receiving an input from a sensor and/or detector associated with the setting of the component. The adjustment may comprise considering a predictive state of the component (e.g., using the predictive model and/or the physical simulation). The adjustment may comprise considering the manner of operation and/or any limits on the operation of the component. The adjustment may include considering an empirically derived, historically obtained, and/or experimentally measured (e.g., response time) limitation. The limits may include mechanical, optical, and/or electronic limitations. The component may comprise or be operatively coupled to an actuator. The adjustment may comprise considering the manner of operation and/or any limits on the operation of the actuator. The adjustment may consider a response time of the component. The adjustment may consider a time to perform a requested action. The requested action may be from the current (or anticipated) state of the component, to the requested state of the component.

In some embodiments, integrated control in combination (e.g., along) with one or more pre-determined control plans (e.g., of at least two control variables) enables a lookahead operation to be performed by at least one controller. The lookahead operation may comprise an adjustment of at least one control variable during a time when a transforming agent is inactive (e.g., an inactive period). Inactive is with respect to a transformation. During an inactive period, the transforming agent may not be transforming. An inactive period may comprise a period in which the transforming agent does not transform the pre-transformed material to a transformed material. For example, a period in which an energy beam does not irradiate, e.g., in a sufficient intensity, to perform a transformation of the pre-transformed material (or not irradiate any energy beam). For example, during an inactive period an energy beam may irradiate the pre-transformed material with an energy insufficient to transform a material (e.g., a pre-transformed material). For example, during an inactive period an energy beam does not irradiate. For example, a period in which a dispenser does not dispense, e.g., in a sufficient intensity to perform a transformation of the pre-transformed material (e.g., or not dispense any binder). The inactive period may be prior to, or following, an active transforming operation. The period at which the transforming agent transforms may be referred to herein as “an active period”. For example, a lookahead operation may be performed in an inactive period that is (i) scheduled before an active period, (ii) scheduled after an active period, and/or (iii) scheduled between at least two active periods (e.g., at least one preceding active period and/or at least one following active period). The adjustment may comprise an adjustment to (i) at least one transforming agent characteristic, (ii) an output power (e.g., setpoint) of a transforming agent generator, or (iii) a (e.g. material) attribute (e.g., setpoint). The attribute may comprise a temperature, specularity, reflectivity, or radiation wavelength.

In some embodiments, one or more components of an actuator affects a response time with which the actuator enacts a commanded change (e.g., to an output). For example, one or more components of (1) a transforming agent generator (e.g., transforming agent provider, or transforming agent source) and/or (2) a transforming agent focusing element, may affect (e.g., increases) a response time with which the transforming agent provider and/or transforming agent focusing element enacts a commanded change (e.g., to an output). The one or more components may comprise an analog or a digital component. The one or more components may comprise a (e.g., signal) filter. In some embodiments, an actuator (e.g., operatively coupled to a transforming agent generator) comprises at least one analog component or at least one digital component. In some embodiments, an (e.g., at least one) analog component of a transforming agent generator generates a change in (e.g., modulates) an output power level of the transforming agent generator. In some embodiments, a (e.g., at least one) digital component of a transforming agent generator generates an activation signal (e.g., gating, e.g., ON and/or OFF) to operate the transforming agent generator at a given output power level. A response time may be affected differently for analog component and for a digital component. In some embodiments, an analog component may lead to relatively lesser increase in response time (e.g., as compared to a digital component). In some embodiments, an analog component may lead to relatively greater increase in response time (e.g., as compared to a digital component). For example, a (e.g., analog) modulation of an output power of the transforming generator may comprise a relatively large response time, as compared to a response time for activating and/or deactivating the transforming agent source using a (e.g., digital) gating signal.

In some embodiments, an output power plan of a transforming agent generator comprises a power profile of the transforming agent generator. The power profile may comprise at least one inactive period. The power profile may comprise a discontinuity (e.g., within and/or between an active period(s)). The discontinuity may comprise a (e.g., relatively) large change in a setpoint of the transforming agent source power. Relatively large may be with respect to a response time with which the transforming agent source is capable of enacting a commanded change. For example, relatively large requested change may comprise a change in a setpoint that is requested to occur within at most about 1*a given transforming agent response time (TASRT), about 1.5*TASRT, about 2*TASRT, about 5*TASRT, or about 10*TASRT. The relatively large requested change may be value between the afore-mentioned values (e.g., from about 1*TASRT to about 10*TASRT, from about 1*TASRT to about 5*TASRT, or from about 5*TASRT to about 10*TASRT). TASRT is a response time of a transforming agent.

In some embodiments, the at least one controller considers a response time of a transforming agent provider to perform a given change in an output power level for generating (e.g., or modifying) an output power plan for the transforming agent generator. For example, the at least one controller may consider a response time of a transforming agent generator for two active periods having an inactive period therebetween (e.g., a second active period that follows an inactive period, which inactive period follows a first active period). An inactive period of the transforming agent generator may correspond to the inactive period of the transforming agent, e.g., as described herein. An active period of the transforming agent generator may correspond to the active period of the transforming agent, e.g., as described herein. The at least one controller may perform a lookahead operation at the completion of the first (e.g., active) period, and modify at least one control variable (e.g., from a planned value) considering: (i) a requested modification to a setpoint value of the control variable (e.g., from the first active period to the second active period), (ii) a duration of an inactive period (e.g., that is positioned between the first and second active periods) and/or (iii) a response time of an actuator to effect the requested modification. The inactive period of the transforming agent generator may be scheduled (i) prior to an active period of the transforming agent generator, (ii) after an active period of the transforming agent generator, and/or (iii) between a first active period and a second active period (e.g., that succeeds the first active period) of the transforming agent generator. For example, the at least one controller may perform a lookahead operation to an initial setpoint value of at least one control variable at the beginning of the second active period. The lookahead operation may comprise modifying a time at which the requested (e.g., initial) setpoint value is commanded to occur. For example, the initial setpoint value (e.g., of the second active period) may be enacted prior to the beginning of the second active period. For example, the lookahead operation may comprise (e.g., pre-) setting the requested setpoint during an inactive period (e.g., preceding the second active period). Pre-setting the requested setpoint may comprise commanding a requested change to a control variable (i) at the end of a (e.g., first) active period, or (ii) at the beginning of and/or during the inactive period. For example, a power forwarding operation may comprise the at least one controller performing a lookahead operation for a transforming agent source output power setpoint at (e.g., a beginning of) the second active period, and pre-setting the transforming agent source output power setpoint at the end of the first active period or during the inactive period (e.g., that is prior to the second active period).

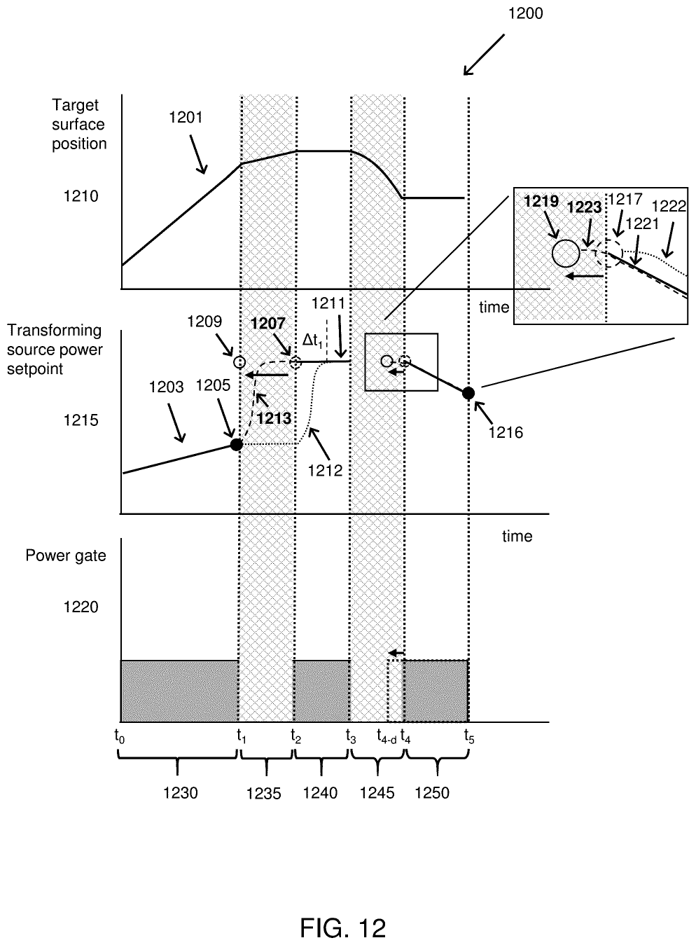

FIG. 12 depicts an example of a lookahead operation during integrated control 1200 of a transforming agent position 1210 (e.g., on a target surface), an output power level 1215 of a transforming agent generator, and a transforming agent generator (e.g., operation) gating signal 1220. An integrated control scheme may comprise one or more active periods and/or one or more inactive periods (e.g., interspersed therebetween). In the example of FIG. 12, a (e.g., first) active period 1230 and a (e.g., second) active period 1240 have a (e.g., first) inactive period 1235 scheduled therebetween. In the example of FIG. 12, during the first active period (e.g., from t₀ to t₁) the transforming agent is moved according to a trajectory 1201, and is operated at (e.g., increasing) source output power level 1203, which has an ending value 1205. In the example of FIG. 12, the second active period (e.g., from t₂ to t₃) includes an output power level 1211 of a transforming agent generator that has an initial (e.g., at time t₂) output power level 1207. A response time (e.g., of the transforming agent source) to modify a power level may cause an actual power output level to deviate from the requested power output level (e.g., 1212, achieving setpoint value within a time period Δt₁). In the example of FIG. 12, a lookahead (e.g., power forwarding) operation is performed during the first inactive period (e.g., from t₁ to t₂) to preset the initial transforming agent source output power level 1209 (e.g., at t₁). A lookahead operation may enable at least one control variable to reach its setpoint value in a following (e.g., active) period, considering a response time to modify the control variable (e.g., 1213).

In some embodiments, an active period comprises a (e.g., time-) varying setpoint value for at least one control variable plan. For example, a transforming agent focus, area of effect (e.g., footprint), and/or intensity setpoint may change during an active period. For example, an output power setpoint of a transforming agent generator may change during an active period (e.g., 1230 and 1250). In some embodiments, a response time of at least one actuator enacting at least one control variable plan promotes a deviation (e.g., a delay) in an actual value from a requested value (e.g., of the control variable), during an active period. For example, a response time of a transforming agent focusing element may cause a delay in a requested change to a focus setpoint of the transforming agent during an active period. For example, a response time of a transforming agent source may cause a delay in a requested change to a transforming agent source output power.

In some embodiments, at least one controller performs a lookahead operation prior to execution of a given active period (e.g., processing operation). The at least one controller may consider a given (e.g., actuator) response time to determine (e.g., estimate) a likelihood that the given component (including an actuator operatively coupled to the component) will execute its (e.g., respective) control variable plan without (e.g., substantial) deviation. Substantial deviation may comprise a deviation that promotes (e.g., causes) at least one defect in a forming 3D object as compared to a requested 3D object. Upon a determination that a deviation from a control variable plan is (e.g., likely) to occur, the at least one controller may modify at least one component of the control variable plan. For example, the at least one controller may modify a timing with which a component (e.g., or its actuator that actuates the given control variable) is enabled. For example, the at least one controller may reschedule (e.g., move forward) an initiation time at which a given component command is executed. In the example of FIG. 12, a transforming agent source output power plan 1221 in an active period 1250 comprises a requested initiation point 1217 (e.g., at t₄), and end point 1216 (e.g., at t₅). In the example of FIG. 12, a response time of the transforming agent source is estimated to cause a deviation in the output power plan (e.g., 1222), leading to a delay in achieving the requested output power (e.g., plan values) of the transforming agent generator. In the example of FIG. 12, an initiation point (e.g., output power activation) 1219 is enacted prior to the planned beginning of the active period (e.g., during inactive period 1245, e.g., at t_{4-d}). The earlier activation (e.g., power advance) compensates for the component (e.g., transforming agent generator) delay in modifying output power (e.g., 1223), in order to achieve the requested power profile (e.g., 1221).

At times, during formation of a 3D object at least a portion of a forming process comprises an uncertainty in a (e.g., required) timing to achieve a selected effect. The uncertainty may comprise an uncertainty in (i) at least a portion of a transformation process, or (ii) a control of at least one component (e.g., of a manufacturing device that is forming the 3D object). For example, there may be an uncertainty in a (e.g., duration of) time (e.g., required) to transform a selected portion of pre-transformed material to a transformed material. The uncertainty in transformation may comprise an uncertainty in a time (e.g., required) to achieve a selected transformation area (e.g., melt pool) characteristic. A transformation (e.g., transforming) area characteristic may comprise (a) an area of extent (e.g., FLS), (b) a shape, (c) a depth, and/or (d) a material (e.g., surface) attribute, e.g., a temperature. For example, there may be an uncertainty in a time required for a component (e.g., that actuates a given control variable) to achieve a selected setpoint value (e.g., corresponding to the given control variable value). For example, there may be an uncertainty in a time required for a guidance element to achieve a requested position and/or motion (e.g., for effecting a selected transforming agent position and/or motion). For example, there may be an uncertainty in a time required for a focusing element to achieve a selected position (e.g., for effected a selected transforming agent focus). The uncertainty may affect a timing (e.g., duration) for execution of a given portion of at least one control variable plan. The given portion of the at least one control variable plan may comprise an active period or an inactive period. For example, the uncertainty may affect a transforming agent dwell time (e.g., at a given target surface location), or an inactive time of a transforming agent generator (e.g., awaiting the transforming agent to reach a selected position, motion, and/or focus).

In some embodiments, an adaptive control scheme enables at least one processing operation to be performed with an adaptive timing operation by at least one controller. The adaptive control scheme may be combined with one or more control plans. The control plans may or may not be predetermined. The control plan may be for a process parameter. The control plan may pertain to the operation of a component that effectuates, and/or manipulates the process parameter. The control plan may pertain to the operation of a component that alters, and/or maintains the process parameter. The control plans (e.g., a control plan set) may be of at least two control variables. The control variable may be of a process parameter that is associated with a component. The component may be of a system that is utilized to form the 3D object. The adaptive control scheme may comprise adaptive (e.g., open loop or closed loop) control. The adaptive control scheme may comprise an adaptive timing operation that comprises an adjustment to an execution of at least one processing operation (e.g., of a sequence of processing operations). An adaptive timing operation may comprise an (i) adaptive timing delay or, (ii) adaptive timing advance. An adaptive timing delay operation may comprise an adjustment to a timing (e.g., duration) with which the at least one processing operation is executed. An adaptive timing advance operation may comprise selective execution of at least one processing operation in a sequence of (e.g., at least two) processing operations. Selective execution may comprise optional execution of the at least one processing operation. Selective execution may comprise optional execution of the at least one processing operation at a given time and/or during a given period. The plan may comprise continuous or intermittent operation during the period. The plan may comprise operation time and intermission time, e.g., of the component. In some embodiments, an adaptive timing delay operation considers at least one threshold value of (e.g., one state of) at least one processing variable, and/or control variable (e.g., of the component). The one state (e.g., power, temperature, location, voltage, and/or power density) may be the current state of the component. The one state may be an anticipated state of the component. The anticipated state may be derived from a simulation, estimation, calculation, historical measurement, and/or lookup table. The adaptive timing operation may comprise (1) continuing execution of a given processing operation until at least one threshold value is achieved (e.g., adaptive timing delay), or (2) proceeding beyond (e.g., without execution of) at least one processing operation once (e.g., and/or while) at least one threshold value is achieved (e.g., adaptive timing advance). The adaptive timing operation may be for a scheduled period during which the component is requested to be active (e.g., referred to herein as an “active period”). The adaptive timing operation may take place during a time at which the component is inactive (e.g., referred to herein as an “inactive period”). The adaptive timing operation may be performed in at least a portion of an inactive period that is (i) scheduled before an active period, (ii) scheduled after an active period, and/or (iii) scheduled between at least two active periods (e.g., at least one preceding active period and/or at least one following active period).

In some embodiments, the at least one controller is configured to operate with an adaptive (e.g., processing) timing execution. For example, the at least one controller may be capable of executing (e.g., within a given task) a given processing operation for a variable duration before proceeding to a following processing operation (e.g., adaptive delay). In some embodiments, the adaptive timing operation may compensate for an uncertainty in at least one processing variable during formation of at least a portion of a 3D object. The adaptive timing operation may consider a (e.g., detection of a) physical process and/or state. For example, the adaptive processing operation may continue executing a given processing operation until a detected physical process and/or state reaches a target (e.g., threshold) condition. A detected physical process and/or state that reaches a target (e.g., threshold) condition may serve as a trigger (e.g., condition) for completing the adaptive processing operation. The adaptive processing operation may consider a threshold value of at least one processing variable (e.g., control variable). The (e.g., threshold) value of the at least one processing variable may be an input that is measured by a (e.g., at least one) sensor. The adaptive processing operation may comprise (i) ceasing execution of the given processing operation, or (ii) proceeding to a following processing operation, once a detected physical process and/or state reaches the target condition. The processing operation may comprise an active period, or an inactive period, of the transforming agent, e.g., as described herein.

In some embodiments, a trigger condition of an adaptive timing operation comprises a detection of a transformation area (e.g., melt pool) characteristic (e.g., by at least one sensor). A trigger condition of a transformation area characteristic may comprise (a) an area of extent (e.g., FLS), (b) a shape, (c) a depth, and/or (d) a material (e.g., surface) attribute such as a temperature, reaching a threshold value. In some embodiments, a trigger condition comprises a detection of a component achieving a selected (e.g., requested) setpoint value (e.g., within a threshold deviation). The component may comprise (i) a guidance element (e.g., for guiding a transforming agent), (ii) a focusing element, or (iii) a transforming agent provider. For example, a trigger condition may comprise the guidance element achieving a requested position and/or motion. For example, a trigger condition may comprise the focusing element achieving a requested position. For example, a trigger condition may comprise the transforming agent provider achieving a requested output power setpoint (e.g., of an energy source), or transforming agent flux setpoint (e.g., of a dispenser).

In some embodiments, a trigger condition of an adaptive timing operation is not reached. For example, a (e.g., at least one) transforming area characteristic may not reach a requested value. For example, a guidance element may not achieve a requested position and/or motion value. In some embodiments, in the absence of a trigger condition being met an adaptive timing operation may become locked at a given processing operation. In some embodiments, an adaptive timing operation comprises a (e.g., configurable) duration. The configurable duration of the adaptive timing operation may comprise a (i) maximum or (ii) minimum, (e.g., delay) value. The minimum value may be a minimum duration of the adaptive timing operation. The maximum value may be a maximum duration of the adaptive timing operation. For example, a maximum duration may prevent a sequence of processing operations from becoming locked at a given processing operation (e.g., in which a trigger condition is not met).

In some embodiments, an adaptive control scheme comprises a dominant control axis of at least two control axes that are organized into a given task. The given task may coordinate control of control variable plans of the at least two control axes. In an adaptive control scheme, a (e.g., the) control axis having a largest response time may dictate timings with which (e.g., at least one) another control axis performs a sequence of processing operations. For example, a dominant (e.g., master) control axis may dictate timings with which a dependent control axis performs a sequence of processing operations. The timings may be determined according to a mechanical and/or electronic limitation of the dominant control axis. A dominant control axis may comprise a control axis having a lower acceleration limit, a longer (e.g., slower) response time, or that is estimated to have a (e.g., relatively) greater effect during formation of a given portion of a 3D object, e.g., as described herein. A dependent (e.g., slave) control axis may comprise a control axis having a larger acceleration limit, a shorter (e.g., faster, relative to a dominant axis) response time, or that is estimated to have a lesser effect (e.g., with respect to the dominant axis) during formation of the given portion of the 3D object, e.g., as described herein. In some embodiments, dictation of a timing with which at least one dependent control axis performs a sequence of operations comprises use of an adaptive timing delay operation. For example, a dominant control axis may comprise control of a focusing element, and dependent control axes may comprise control of a transforming agent guidance element for x-axis motion and y-axis motion (e.g., respectively). For a processing operation having a requested transforming agent focus at a requested target surface position (e.g., and/or motion), the transforming agent adaptive control scheme may comprise adaptive timing delay operations for the guidance element(s) of the transforming agent that consider the focusing element reaching a target position. For example, a dominant control axis may comprise control of a transforming agent guidance element (e.g., for x-axis motion, and a dependent control axis may comprise control of a transforming agent provider activation. For a processing operation having a requested transforming agent intensity at a requested target surface position (e.g., and/or motion), the transforming agent adaptive control scheme may comprise adaptive timing delay operations for the transforming agent provider activation that consider the guidance element(s) of the transforming agent achieving a target position.

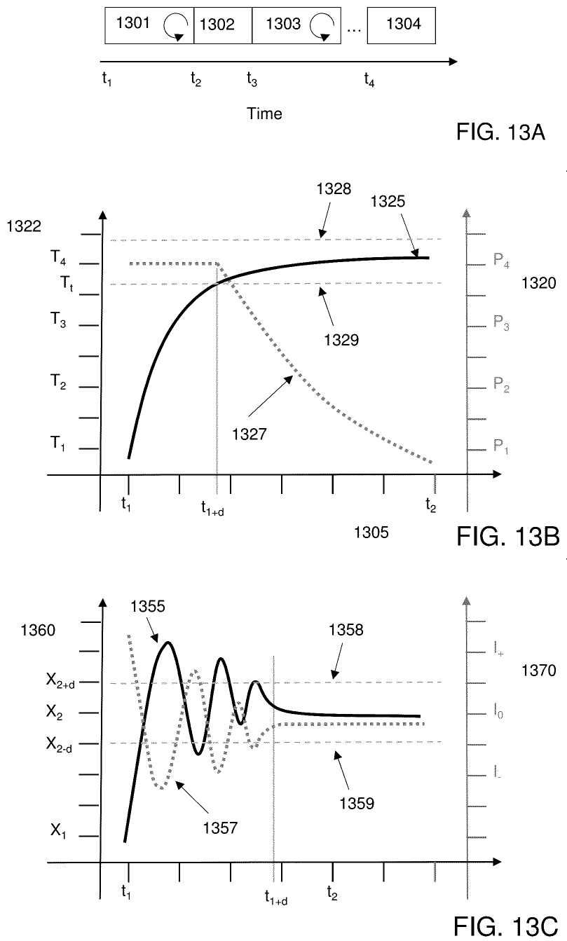

FIG. 13A depicts an example of a sequence of processing operations (e.g., 1301-1304) that comprises adaptive timing operations. In the example of FIG. 13, a (e.g., first) processing operation 1301 comprises an adaptive timing delay. The example processing operation 1301 is initiated at a time t₁, and advances to the example processing operation 1302 at a time t₂ only after a trigger condition for the adaptive timing delay operation is satisfied. The example processing operation 1302 proceeds with a pre-determined duration, ending at a time t₃.

In some embodiments, an adaptive timing advance enables skipping at least one processing operation (e.g., of a plurality of processing operations), without execution of the at least one processing operation. An adaptive advance may comprise a synchronization of at least two processing operations. The at least two processing operations may comprise a first processing operation in a first task, and a second processing operation in a second task. At least one of the at least two processing operations may comprise an adaptive processing operation. For example, a sequence of processing operations comprising an adaptive timing advance operation may be configured to achieve a selected transformation area characteristic. The sequence of processing operations may comprise a sequence of tiling operations. In some embodiments, at least one transformation area characteristic is achieved more quickly than from an estimate (e.g., from a predictor model). In some embodiments, once a requested surface attribute is detected, (e.g., measured, e.g., by at least one sensor) during a given sequence, (e.g., at least one of) a remainder of the sequence of processing operations may be skipped. The attribute may comprise a temperature. In some embodiments, once a requested transformation area shape is detected during a given sequence, (e.g., at least one of) a remainder of the sequence of processing operations may be skipped. In some embodiments, a number of skipped processing operations in an adaptive timing advance operation may be pre-determined. In some embodiments, a processing operation that follows an adaptive timing advance operation (e.g., sequence), comprises an adaptive timing delay.

The example processing operation 1303 comprises an adaptive timing advance operation. In the example of FIG. 13A, processing operation 1303 may skip (e.g., advance beyond, without execution of) at least one intervening processing operation (e.g., not shown) between itself and processing operation 1304. In some embodiments, the intervening processing operations are executed (e.g., with pre-determined timings) when a trigger condition of an adaptive timing advance operation is not met. In some embodiments, when a trigger condition of an adaptive timing advance operation is met, the processing operation 1304 is executed at a time t₄ that (e.g., immediately) follows the processing operation 1303.

FIG. 13B depicts an example of an adaptive timing operation (e.g., tiling) comprising transformation of a portion of a 3D object during a time period 1305. In some embodiments, an adaptive timing operation may be specified for a first control variable (e.g., a transforming agent generator). The adaptive timing operation of the first control variable (e.g., the transforming agent generator) may consider a trigger condition of a second control variable (e.g., a transformation area characteristic). For example, the trigger condition of a transformation area characteristic may comprise (a) an area of extent (e.g., FLS), (b) a shape, (c) a depth, and/or (d) a material (e.g., surface) attribute, reaching a setpoint (e.g., threshold value). An adaptive timing operation may comprise an adaptive timing delay for the first control variable. For example, the adaptive timing delay may comprise the transforming agent generator being held at a (e.g., non-zero) output power until a given trigger condition of a transformation area characteristic is achieved. The trigger condition may comprise a surface attribute (e.g., temperature) increasing up to a setpoint (e.g., target value). For example, the adaptive timing delay may comprise the transforming agent generator being held at zero output power (e.g., inactive) until a given trigger condition of a transformation area characteristic is achieved. The trigger condition may comprise a surface attribute, e.g., decreasing down to a setpoint (e.g., target value).

In the example of FIG. 13B, at a time t₁ a power 1320 of a transforming agent generator (e.g., source) may be activated (e.g., according to a profile 1327) to reach a (e.g., requested) value (e.g., P₄). In some embodiments, a control plan of the transforming agent generator comprises holding a power at a given power setpoint (e.g., value) while considering a value of the second control variable such as an attribute (e.g., material temperature). The second control variable may comprise a process having a state that is affected (e.g., at least indirectly) by the power (e.g., output) of the transforming agent generator. For example, an attribute (e.g., a temperature) of material at a position upon which a transforming agent is incident may be affected by the transforming agent (e.g., flux, and/or energy density). In some embodiments, an adaptive timing operation for a transforming agent generator comprises an adaptive timing delay. For example, a power setpoint of a transforming agent generator may be maintained (for a variable duration from t₁ to t_{1+d}) at a given level (e.g., P₄) until a trigger condition (e.g., a requested material temperature) is detected. In the example of FIG. 13B, the power is maintained at the level P₄ until a material temperature 1322 reaches a target value (e.g., Ti). In some embodiments, the second control variable is requested to be maintained at (e.g., within a range of) a setpoint (e.g., target value T₄ maintained between 1328 and 1329). The setpoint (e.g., threshold value) may be requested to be maintained for at least one processing operation. In some embodiments, achieving (e.g., maintaining) a requested setpoint (e.g., value) of the second control variable comprises an alteration (e.g., modification) to the first variable. In the example of FIG. 13B, the power of the transforming agent generator is reduced according to the profile 1327, in order to maintain the (e.g., material) temperature. In the example of FIG. 13B, the power of the transforming agent generator is reduced until a minimum level is reached at t₂.

In some embodiments, an adaptive timing operation enables a control scheme to react to a given condition of a processing variable (e.g., control variable), prior to a (e.g., significant) change in the given condition. In some embodiments, a control scheme comprises achieving a requested value of a control variable by reaching and/or maintaining the requested setpoint (e.g., value), within a setpoint deviation. For example, for at least one controller that implements the control scheme to react within (e.g., have a response time of) about 1 microsecond (μs), 5 μs, 10 μs, 50 μs, 100 μs, 500 μs, or 1000 μs to the given condition. The at least one controller may have a response time of any value between the aforementioned values (e.g., from about 1 μs to about 1000 μs, from about 1 μs to about 100 μs, or from about 100 μs to about 1000 μs). In some embodiments, a reaction of the controller(s) is to a given (e.g., surface) attribute of a transformation area before the given attribute changes beyond a (e.g., temperature) setpoint deviation. For example, a reaction is to a given (e.g., surface) temperature of a transformation area before the given temperature changes beyond a threshold (e.g., temperature) deviation. A threshold temperature deviation may be a deviation from a given (e.g., target) temperature of about 0.1° C., 0.5° C., 1° C., 5° C., 10° C., 25° C., or 50° C. the deviation from the given target temperature may be any value between the afore-mentioned values (e.g., from about 0.1° C. to about 50° C., from about 0.1° C. to about 5° C., or from about 5° C. to about 50° C.). In some embodiments, a reaction is to a given deviation in a requested position of a guidance element or a focusing element. In some embodiments, a transforming agent position (e.g., on a target surface) may result from a given angular position of a guidance element. The guidance element may be an optical element (e.g., of an optical system). In some embodiments, at least one controller that implements the control scheme reacts to a setpoint (e.g., threshold) deviation in a measured angular position of the guidance element from a requested angular position. The setpoint deviation in angular position may be at least about 10 micro-radians (e.g., μRads), 15 μRads, 20 μRads, 30 μRads 50 μRads, or 100 μRads, from a commanded (e.g., requested) angular position of the guidance element. The setpoint deviation in the measured angular position from a requested angular position may be any value between the afore-mentioned values (e.g., from about 10 μRads to about 100 μRads, from about 30 μRads to about 100 μRads, or from about 10 μRads to about 30 μRads). These angular position accuracies may correspond to position accuracies (e.g., of a transforming agent) at a target surface (e.g., an X-Y position accuracy) from about 2 μm to about 350 μm, from about 150 μm to about 350 μm, or from about 2 μm to about 150 μm.

In some embodiments, a control scheme comprises at least one adaptive timing operation for a requested position of a guidance element (e.g., and/or a focusing element). The adaptive timing operation for the requested position may follow, or precede, a motion operation of the guidance element. For example, the adaptive timing operation may comprise continuing an inactive period of the transforming agent until the transforming agent (e.g., as guided by a guidance system) reaches a requested position (e.g., on a target surface). A trigger condition of the adaptive timing operation may comprise a measured position of the guidance element (within a threshold deviation). The trigger condition at the requested position may correspond to a (e.g., requested) position of a transforming agent on a target surface. A measured position of the guidance element may be determined considering at least one signal generated by at least one sensor. For example, a sensor that comprises an encoder, a voltage meter, or a current meter. In the example of FIG. 13C, an adaptive timing operation (e.g., a transforming agent motion) comprises a (e.g., requested) movement of a guidance element from an initial position at X₁ to a requested position at X₂. The requested position may be a position within a setpoint (e.g., threshold) deviation (e.g., from X_{2-d} to X_{2+d}). The position of the guidance element may be effectuated by at least one actuator (e.g., motor). In the example of FIG. 13C, the position 1355 of the guidance element is modified by a current 1357 with which an actuator is driven. A requested position of the guidance element may correspond to a given current level (e.g., I₀). An increasing current level may move the guidance element in a first direction (e.g., I₊, for a positive direction in a given coordinate system). A decreasing current level may move the guidance element in a second direction (e.g., I₋, for a negative direction in the given coordinate system).

In some embodiments, control of a position and/or motion of a guidance element and/or a focusing element comprises open loop or closed loop control schemes. In some embodiments, closed loop control of a position of a guidance element and/or focusing element promotes an oscillation in a commanded (e.g., measured) position, with respect to a setpoint position. The oscillation may evolve (e.g., decay) in time. For example, the closed loop control may counteract a motion of the controlled (e.g., guidance) element to reduce the oscillation. In some embodiments, an adaptive timing duration may continue (e.g., be extended) until the (e.g., oscillating) position of the guidance element is controlled to be within a threshold range. In the example of FIG. 13C, the position of the guidance element is controlled to be with the threshold range of X₂ (e.g., between 1358 and 1359) at a time t_{1+d}.

At times, an energy beam is directed onto a specified area of at least a portion of the target surface for a specified time period. The material in or on the target surface (e.g., powder material such as in a top surface of a powder bed) can absorb the energy from the energy beam and, and as a result, a localized region of the material can increase in temperature. In some instances, one, two, or more 3D objects are generated in a material bed (e.g., a single material bed; the same material bed). The plurality of 3D objects may be generated in the material bed simultaneously or sequentially. At least two 3D objects may be generated side by side. At least two 3D objects may be generated one on top of the other. At least two 3D objects generated in the material bed may have a gap between them (e.g., gap filled with pre-transformed material). At least two 3D objects generated in the material bed may contact (e.g., not connect to) each other. In some embodiments, the 3D objects may be independently built one above the other. The generation of a multiplicity of 3D objects in the material bed may allow continuous creation of 3D objects.

A pre-transformed material may be a powder material. A pre-transformed material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) may have any value of the afore-mentioned layer thickness values (e.g., from about 0.1 μm to about 1000 μm, from about 1 μm to about 800 μm, from about 20 μm to about 600 μm, from about 30 μm to about 300 μm, or from about 10 μm to about 1000 μm).

At times, the pre-transformed material comprises a powder material. The pre-transformed material may comprise a solid material. The pre-transformed material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprises particles having an average FLS of at least about 5 nanometers (nm), 10 nm, 20 nm, 30 nm, 40 nm, 50 nm, 100 nm, 200 nm, 300 nm, 400 nm, 500 nm, 11 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. In some embodiments, the powder may have an average fundamental length scale of any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The powder in a material bed may be flowable (e.g., retain its flowability) during the printing.

At times, the powder is composed of individual particles. The individual particles can be spherical, oval, prismatic, cubic, or irregularly shaped. The particles can have a FLS. The powder can be composed of a homogenously shaped particle mixture such that all of the particles have substantially the same shape and fundamental length scale magnitude within at most about 1%, 5%, 8%, 10%, 15%, 20%, 25%, 30%, 35%, 40%, 50%, 60%, or 70%, distribution of FLS. In some embodiments, the powder may have a distribution of FLS of any of the values of the average particle FLS listed above (e.g., from at most about 1% to about 70%, about 1% to about 35%, or about 35% to about 70%). In some embodiments, the powder can be a heterogeneous mixture such that the particles have variable shape and/or fundamental length scale magnitude.

At times, at least parts of the layer are transformed to a transformed material that subsequently forms at least a fraction (also used herein “a portion,” or “a part”) of a hardened (e.g., solidified) 3D object. At times a layer of transformed or hardened material may comprise a cross section of a 3D object (e.g., a horizontal cross section). At times a layer of transformed or hardened material may comprise a deviation from a cross section of a 3D object. The deviation may comprise vertical or horizontal deviation.

At times, the pre-transformed material is requested and/or pre-determined for the 3D object. The pre-transformed material can be chosen such that the material is the requested and/or otherwise predetermined material for the 3D object. A layer of the 3D object may comprise a single type of material. For example, a layer of the 3D object may comprise a single metal alloy type. In some examples, a layer within the 3D object may comprise several types of material (e.g., an elemental metal and an alloy, several alloy types, several alloy phases, or any combination thereof). In certain embodiments, each type of material comprises only a single member of that type. For example, a single member of metal alloy (e.g., Aluminum Copper alloy). In some cases, a layer of the 3D object comprises more than one type of material. In some cases, a layer of the 3D object comprises more than one member of a material type.

In some instances, the elemental metal comprises an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

In some instances, the metal alloy comprises an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising a device, medical device (human & veterinary), machinery, cell phone, semiconductor equipment, generators, turbine, stator, motor, rotor, impeller, engine, piston, electronics (e.g., circuits), electronic equipment, agriculture equipment, gear, transmission, communication equipment, computing equipment (e.g., laptop, cell phone, i-pad), air conditioning, generators, furniture, musical equipment, art, jewelry, cooking equipment, or sport gear. The impeller may be a shrouded (e.g., covered) impeller that is produced as one piece (e.g., comprising blades and cover) during one 3D printing procedure. The 3D object may comprise a blade. The impeller may be used for pumps (e.g., turbo pumps). Examples of an impeller and/or blade can be found in U.S. patent application Ser. No. 15/435,128, filed on Feb. 16, 2017; PCT patent application number PCT/US17/18191, filed on Feb. 16, 2017; or European patent application number. EP17156707.6, filed on Feb. 17, 2017, all titled “ACCURATE THREE-DIMENSIONAL PRINTING,” each of which is incorporated herein by reference in its entirety where non-contradictory. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics.

In some instances, the alloy includes a superalloy. The alloy may include a high-performance alloy. The alloy may include an alloy exhibiting at least one of: excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98 T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Maraging steel (M300), Reynolds 531, Silicon steel, Spring steel, Stainless steel, Tool steel, Weathering steel, or Wootz steel. The high-speed steel may comprise Mushet steel. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, 17-4PH steel).

In some instances, the titanium-based alloy comprises alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy comprises Ti-6Al-4V or Ti-6Al-7Nb.

In some instances, the Nickel alloy comprises Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e.g. Talonite), Ultimet, or Vitallium. The chromium alloy may comprise chromium hydroxide, or Nichrome.

In some instances, the aluminum alloy comprises AA-8000, Al—Li (aluminum-lithium), Alnico, Duralumin, Hiduminium, Kryron Magnalium, Nambe, Scandium-aluminum, or Y alloy. The magnesium alloy may comprise Elektron, Magnox, or T-Mg-AI-Zn (Bergman phase) alloy.

In some instances, the copper alloy comprises Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

In some instances, the metal alloys are Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some examples, the material (e.g., pre-transformed material) comprises a material wherein its constituents (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*105 Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1*10⁻⁵ Ω*m to about 1*10⁻⁸ Ω*m). The high thermal conductivity may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³, from about 1 g/cm³ to about 10 g/cm³, or from about 10 g/cm³ to about 25 g/cm³).

At times, a metallic material (e.g., elemental metal or metal alloy) comprises small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (based on weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (based on weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

In some embodiments, a pre-transformed material within the enclosure is in the form of a powder, wires, sheets, or droplets. The material (e.g., pre-transformed, transformed, and/or hardened) may comprise elemental metal, metal alloy, ceramics, an allotrope of elemental carbon, polymer, and/or resin. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may comprise high performance material (HPM). The ceramic material may comprise a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or comprising (e.g., with) metal alloy. The material may comprise a stainless steel. The material may comprise a titanium alloy, aluminum alloy, and/or nickel alloy.

In some embodiments, at least one controller comprises using data obtained from one or more sensors operatively coupled to the controller. The sensor can detect the physical and/or chemical state of material deposited on the target surface (e.g., liquid, or solid (e.g., powder or bulk)). The sensor can detect the crystallinity of material deposited on the target surface. The sensor may spectroscopically detect the material. The sensor can detect an attribute (e.g., the temperature) of the material. For example, the sensor may detect the attribute of the material before, during and/or after its transformation. One or more sensors (at least one sensor) can detect the topology of the exposed surface of the material bed and/or the exposed surface of the 3D object or any part thereof. The sensor can detect the amount of material deposited in the material bed. The sensor can be a proximity sensor. The sensor may detect the temperature and/or pressure of the atmosphere within an enclosure (e.g., chamber). The sensor may detect the temperature of the material (e.g., powder) bed at one or more locations. The controller may be operatively coupled to any apparatus or component thereof, e.g., as disclosed herein.

In some embodiments, the at least one controller receives a target parameter such as an attribute (e.g. temperature) to maintain at least one characteristic of a forming 3D object. Examples of characteristics of forming 3D objects include attribute (e.g., temperature and/or metrological) related information of a melt pool. The metrological information of the melt pool may comprise its FLS. Examples of characteristics of forming 3D objects include metrological information of the forming 3D object. For example, geometry information (e.g. height) of the forming 3D object. Examples of characteristics of forming 3D objects include material characteristic such as hard, soft and/or fluid (e.g., liquidus) state of the forming 3D object. The target parameter may be time-varying, location-varying, or a series of values per location or time. The controller may (e.g., further) receive a pre-determined control variable (e.g. power per unit area) target value from a control loop such as, for example, a feed forward control. In some embodiments, the control variable controls the value of a target parameter of the forming 3D object. For example, a predetermined (e.g., threshold) value of power per unit area of an energy beam may control an attribute (e.g., the temperature) of the melt pool of the forming 3D object.

At times, a computer model (e.g. comprising a prediction model, statistical model, or a thermal model) predicts and/or estimates one or more physical and/or chemical parameters of the forming 3D object. There may be more than one computer models (e.g. at least 1, 2, 3, 4, 5, 6, 7, 8, 9 or 10 different models). The controller may (e.g., dynamically) switch between the computer models to predict and/or estimate the one or more physical and/or chemical parameters of the forming 3D object. Dynamic includes changing computer models (e.g., in real time) based on a user input, and/or a controller decision that may be based on monitored target variables of the forming 3D object. The dynamic switch may be performed in real-time (e.g., during the forming of the 3D object). Real time may be, for example, during the formation of a layer of transformed material, during the formation of a layer of hardened material, during formation of a portion of a 3D object, during formation of a melt pool, during formation of a single digit number of melt pools, or during formation of an entire 3D object. The at least one computer model may receive sensed parameter(s) value(s) from one or more sensors. The sensed parameter(s) value(s) may comprise sensed attribute (e.g., temperature) within and/or near one or more melt pools. Vicinity may be within a radius of at least about 1, 2, 3, 4, or 5 average melt pool FLS from a forming melt pool. The computer model may use (e.g., in real-time) the sensed parameter(s) value(s) for a prediction and/or adjustment of the target parameter. The computer model may use (e.g., in real-time) geometric information associated with the requested and/or forming 3D object (e.g. melt pool geometry). The use may be in real-time, or off-line. Real time may comprise during the operation of the energy beam and/or energy source. Off-line may be during the time a 3D object is not printed and/or during “off” time of the energy beam and/or source. The computer model (e.g., predictor model) may compare a sensed value (e.g., by the one or more sensors) to an estimated value of the target parameter. The computer model may (e.g., further) calculate an error term and readjust the at least one computer model to achieve convergence (e.g., of a desired or requested 3D model with the printed 3D object).

In some embodiments, the computer model (e.g., predictor model) estimates a target variable. The target variable may be of a physical or chemical occurrence (e.g., phenomenon) that may or may not be (e.g., directly) detectable. For example, the target variable such as a target attribute may be of a temperature that may or may not be (e.g., directly) measurable. For example, the target variable may be of a physical location that may or may not be (e.g., directly) measurable. For example, the target variable may be an oxidative state of the material that may or may not be (e.g., directly) measurable. For example, a physical location may be inside the 3D object at a depth, that may be not directly measured by the one or more sensors. An estimated value of the target variable may be (e.g., further) compared to a critical value of the target variable. At times, the target value exceeds a critical value (e.g., threshold value), and the computer model may provide feedback to the controller to attenuate (e.g., turn off, or reduce the intensity of) the energy beam (e.g., for a specific amount of time). The computer model (e.g., comprising the predictor model) may set up a feedback control loop with the controller. The feedback control loop may be for the purpose of adjusting one or more target parameters to achieve convergence (e.g., of a desired or requested 3D model with the printed 3D object). In one embodiment, the predictor model may predict (i) an estimated attribute (e.g., temperature) of the melt pool, (ii) local deformation within the forming 3D object, (iii) global deformation and/or (iv) imaging attribute (e.g., temperature) fields. The predictor model may (e.g. further) predict corrective energy beam adjustments (e.g. in relation to a temperature target threshold). The adjustment predictions may be based on the (i) measured and/or monitored attribute (e.g., temperature) related information at a first location on the forming 3D object (e.g. a forming melt pool), (ii) a second location (e.g. in the vicinity of the forming melt pool), and/or (iii) geometric information (e.g. height) of the forming 3D object. The energy beam adjustment may comprise adjusting at least one control variable (e.g. power per unit area, dwell time, cross-sectional diameter, and/or speed) of the energy beam. In some embodiments, the control system may comprise a closed loop feed forward control scheme. The control scheme may override one or more (e.g., any) corrections and/or predictions by the predictor model. The override may be by requesting a predefined amount of energy (e.g. power per unit area) to supply to the portion (e.g., of the material bed and/or of the 3D object). Real time may be before, during, or following formation of at least a portion of the 3D object. The control may comprise controlling a cooling rate (e.g., of a material bed or a portion thereof), control the microstructure of a transformed material portion, or control the microstructure of at least a portion of the 3D object. Controlling the microstructure may comprise controlling the phase, morphology, FLS, volume, or overall shape of the transformed (e.g., and subsequently solidified) material portion. The material portion may be a melt pool.

In some embodiments, an intensity profile of the transforming agent (e.g., energy beam, or binding agent) may be controlled (e.g., in real time and/or in situ). In some embodiments, a measured (e.g., detectable) transforming agent intensity profile may be controlled (e.g., in real time and/or in situ). In some embodiments, the transforming agent may promote a detectable change in at least one processing variable. The processing variable and/or attribute (e.g., profile) may comprise (i) a (e.g., material) temperature, (ii) a FLS of the transforming agent (e.g., footprint, e.g., on the target surface), (iii) a metrology (e.g., of the target surface), (iv) a transforming agent generator power, (v) a transforming agent intensity, (vi) a (e.g., returning) radiation from the target surface (e.g., at or adjacent to the footprint) or (vii) a light reflection. In some embodiments, a (e.g., measured) physical attribute may be controlled (e.g., in real time and/or in situ). The processing variable and/or attribute may be artificially induced (e.g., using a transforming agent). The processing variable and/or attribute may comprise a profile. The profile of the processing variable and/or attribute may be a measurement signal profile.

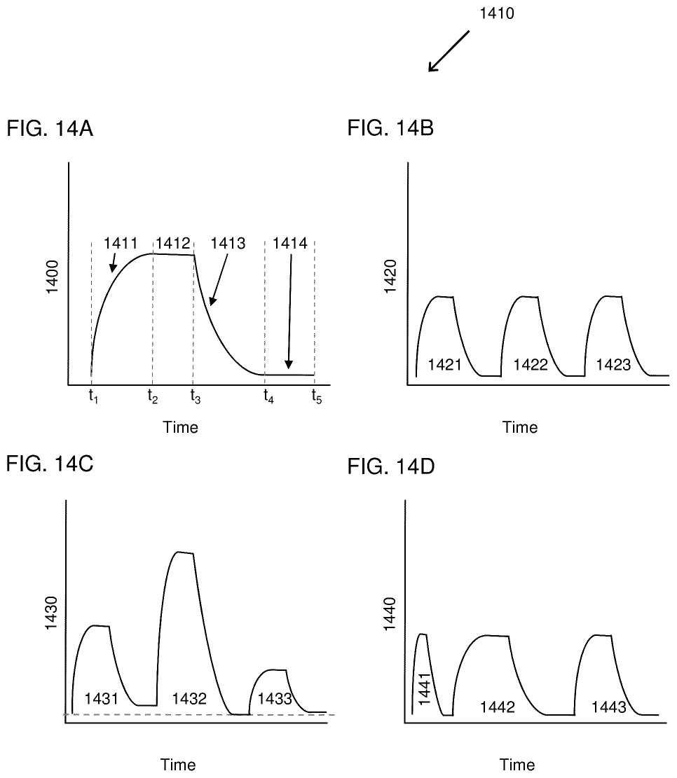

FIG. 14A shows an example of a measured pulse of a processing variable and/or attribute (e.g., the forming attribute of temperature 1400 variation at the footprint of an energy beam on the target surface) profile as a function of time, having a dwell time from t₁ to t₄ and an intermission time from t₄ to t₅. The dwell time in example shown in FIG. 14A is divided into a leading edge 1411, a plateau 1412, and a tailing edge 1413. The intermission in the example shown in FIG. 14A is 1414. The processing variable and/or attribute profile (e.g., temperature profile) over time may be along a trajectory of the transforming agent (e.g., energy beam, or binding agent) on the target surface. The processing variable and/or attribute profile may be derived from sensor measurements. The sensor may be any sensor or detector described herein (e.g., a temperature sensor). The temperature sensor may sense a radiation (or a radiation range) that is emitted from an area at the target surface that coincides with the transforming agent footprint, or adjacent thereto (e.g., within a radius equal to at most about 2, 3, 4, 5, or 6 footprint diameters measured from the center of the footprint). The radiation may be an infrared (IR) radiation. The intensity and/or wavelength of a radiation emitted from an area may correlate to the temperature at that area.

The transforming agent may comprise a pulse. For example, an energy beam may comprise a pulsing energy beam. For example, a dispenser may deliver one or more doses of a binding agent. Pulsing may comprise one or more pulses (e.g., two or more pulses). The pulse may be a pulse in terms of (e.g., in correlation with and/or affecting) the physical attribute (e.g., detectable energy). The pulse in terms of (e.g., pertaining to) the processing variable and/or attribute (termed also herein as “physical attribute pulse”) may comprise one or more pulses of the transforming agent. For example, the pulse may be a result of a single energy beam pulse, or of a plurality of pulses of the energy beam. The pulse may be effectuated by pulse-width modulation (abbreviated as “PWM”) of the energy beam. The pulses may correspond to formation of melt pools, wherein each physical attribute pulse corresponds to formation of a melt pool. FIG. 14B shows an example of a pulsing (measured) processing variable and/or attribute profile over time. In the example shown in FIG. 14B, the attribute is a temperature 1420.

In some embodiments, the processing variable and/or attribute is controlled during the processing variable and/or attribute pulse (e.g., in real time during the 3D forming process) comprises a material temperature, FLS (e.g., of a melt pool), crystal phase, solid morphologies (e.g., metallurgical phase), stress, strain, defect, surface roughness, light scattering (e.g., from a surface), specular reflection (e.g., from a surface), change in polarization of reflected light (e.g., from a surface), surface morphology, or surface topography. The surface can be the target surface. The processing variable and/or attribute may correspond to at least one transformation area (e.g., melt pool). The surface (e.g., target surface) can be the exposed surface of the material bed, 3D object, melt pool, portion of transformed material, or any combination thereof. The defect may comprise cracking or deformation. The deformation may comprise bending, buckling, and/or warping. The processing variable and/or attribute (e.g., detectable energy) may arise at the material bed, melt pool, area just adjacent to the melt pool, target surface (e.g., exposed surface of the material bed), or any combination thereof. For example, the temperature (physical attribute) may comprise temperature of the material bed, melt pool, area (e.g., just) adjacent to the melt pool, exposed surface of the material bed, or any combination thereof. Adjacent may be within a distance that is substantially equal to or equal to at most about 5%, 10%, 20%, 30%, 40% or 50% of the FLS of the melt pool. Adjacent may be within any distance between the afore-mentioned percentages of the melt pool FLS (e.g., from about 5% to about 50%, from about 5% to about 30%, or from about 5% to about 10% of the respective FLS of the melt pool). The FLS physical attribute may comprise a FLS of the melt pool, hatch line, hatch spacing, layer of pre-transformed material (e.g., powder material), or any combination thereof. For example, the FLS of the melt pool may comprise the diameter or depth of the melt pool. In some embodiments, the heating profile and/or the cooling profile (e.g., of the material bed, melt pool, area just adjacent to the melt pool, exposed surface of the material bed, or any combination thereof) may be controlled during the processing variable and/or attribute pulse as a result of the amount of energy radiated into the material bed during different time-portions within the pulse. In some embodiments, the expansion and/or contraction profile (e.g., of the melt pool, of the hatch line, of the hatch spacing, or of the layer of pre-transformed material (e.g., powder material), or any combination thereof) may be controlled during different time-portions within the pulse. The shape of the pulse may be controlled (e.g., in real time and/or in situ during the 3D printing process). The pulse may comprise a dwell time and an intermission. The dwell time may comprise a time interval. In some examples, at least one-time interval of the pulse may be controlled. The time interval may be a portion of the physical attribute pulse dwell time (e.g., from t₁ to t₂ in FIG. 14A), or the entire pulse dwell time (e.g., from t₁ to t₅ in FIG. 14A). The pulse may be of a processing variable and/or attribute.

The physical attribute may be of (e.g., correspond to), for example, a melt pool, or transformed portion of the material bed. The control may be any control disclosed herein. For example, the control may comprise a closed loop control. The control may comprise a feedback control. The control may be during the 3D printing (e.g., in real time). The control may comprise forming at least two physical attribute pulses (e.g., all the physical attribute pulses) that are substantially identical (e.g., completely identical, or almost identical) in terms of the measured physical attribute profile (as a function of time). FIG. 14B shows an example of three physical attribute pulses (1421, 1422, and 1423, wherein the physical attribute correlates to temperature as a function of time) that are identical with respect to the measured energy (as a function of time). The control may comprise forming at least two physical attribute pulses that are different from one another with respect to the physical attribute profile (as a function of time), in a controlled manner (e.g., by keeping the temperature physical attribute and/or FLS physical attribute controlled). Different may be with respect to the physical attribute amplitude, its duration, or any combination thereof (e.g., within the pulse). Different may be with respect to way in which the physical attribute reaches its maximum, way it reaches its minimum, or any combination thereof (e.g., within the pulse). Different may be with respect to peak maximum, and/or peak minimum of the physical attribute (e.g., a measured energy). FIG. 14C shows an example of measured temperature 1430 over time of three pulses (1431, 1432, and 1433) that are different with respect to the physical attribute amplitude and (e.g., substantially) identical with respect to time-period of the pulse. FIG. 14D shows an example of measured temperature 1440 over time of three physical attribute pulses (1441, 1442, and 1443) that are different in their pulse duration of the physical attribute pulse and (e.g., substantially) identical with respect to their maximum and minimum peak intensities (e.g., minimum and maximum temperatures). FIG. 14C shows an example of two pulses (1431, and 1432) that are different in their minimum peak intensity position (e.g., minimum temperature).

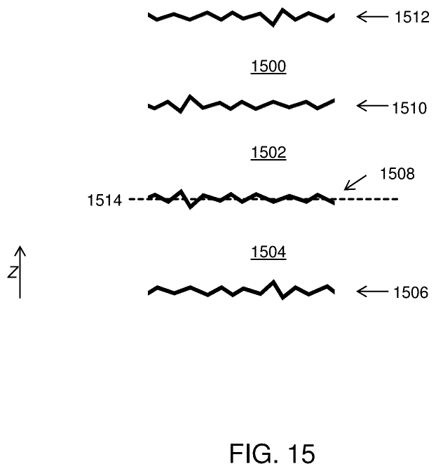

In some embodiments, a (e.g., geometric) model comprises at least two layers. Layers of the geometric model may correspond to (e.g., successive) layers of the formed 3D object (e.g., that formed in a layer-wise manner) and/or (e.g., virtual) slices of the geometric model. In some cases, a layer comprises a layering plane that corresponds to an average layering plane. FIG. 15 shows an example schematic vertical cross section of a portion of a 3D object having layers of hardened material 1500, 1502, and 1504 that are sequentially formed during the 3D forming procedure. Boundaries (e.g., FIG. 15C, 1506, 1508, 1510 and 1512) between the layers may be visible (e.g., by human eye or using microscopy). The microscopy method may comprise optical microscopy, scanning electron microscopy, or transmission electron microscopy. The boundaries between the layers may be evident by a microstructure of the 3D object. The boundaries between the layers may be (e.g., substantially) planar. The boundaries between the layers may have some irregularity (e.g., roughness) due to the transformation (e.g., melting and or sintering) process (e.g., and formation of any microstructure such as melt pools). An average layering plane (e.g., FIG. 15C, 1514) may correspond to a (e.g., imaginary) plane that is an estimated or calculated average. A calculated average may correspond to an arithmetic mean of (e.g., a number of) point locations on a boundary between layers. A calculated average may be calculated using, for example, a linear regression analysis. In some cases, the average layering plane consider deviations from a nominal planar shape.

In some embodiments, a 3D object includes one or more auxiliary features. The auxiliary feature(s) can be supported by the material (e.g., powder) bed. The term “auxiliary feature” or “support structure” as used herein, generally refers to a feature that is part of a printed 3D object, but is not part of the desired, intended, designed, ordered, modeled, or final 3D object. Auxiliary feature(s) (e.g., auxiliary support(s)) may provide structural support during and/or subsequent to the formation of the 3D object. The 3D object may have any number of supports. The supports may have any shape and size. In some examples, the supports comprise a rod, plate, wing, tube, shaft, pillar, or any combination thereof. In some cases, the supports support certain portions of the 3D object and does not support other portions of the 3D object. In some cases, the supports are (e.g., directly) coupled to a bottom surface the 3D object (e.g., relative to the platform). In some embodiments, the supports are anchored to the platform. In some examples, the supports are used to support portions of the 3D object having a certain (e.g., complex or simple) geometry. The 3D object can have auxiliary feature(s) that can be supported by the material bed (e.g., powder bed) and not touch and/or anchor to the base, substrate, container accommodating the material bed, or the bottom of the enclosure. The 3D part (3D object) in a complete or partially formed state can be completely supported by the material bed (e.g., without touching the substrate, base, container accommodating the powder bed, or enclosure). The 3D object in a complete or partially formed state can be completely supported by the powder bed (e.g., without touching anything except the powder bed). The 3D object in a complete or partially formed state can be suspended anchorlessly in the powder bed, without resting on and/or being anchored to any additional support structures. In some cases, the 3D object in a complete or partially formed (e.g., nascent) state can freely float (e.g., anchorlessly) in the material bed. Auxiliary feature(s) may enable the removal of energy from the 3D object that is being formed. In some instances, the auxiliary support is a scaffold that encloses the 3D object or part thereof. The scaffold may comprise lightly sintered or lightly fused powder material. In some examples, the 3D object may not be anchored (e.g., connected) to the platform and/or walls that define the material bed (e.g., during formation). At times, the 3D object may not touch (e.g., contact) to the platform and/or walls that define the material bed (e.g., during formation). The 3D object be suspended (e.g., float) in the material bed. The scaffold may comprise a continuously sintered (e.g., lightly sintered) structure that is at most 1 millimeter (mm), 2 mm, 5 mm or 10 mm. The scaffold may comprise a continuously sintered structure having dimensions between any of the aforementioned dimensions (e.g., from about 1 mm to about 10 mm, from about 5 mm to about 10 mm, or from about 1 mm to about 5 mm). In some examples, the 3D object may be printed without a supporting scaffold. The supporting scaffold may engulf the 3D object. The supporting scaffold may float in the material bed. The printed 3D object may be printed without the use of auxiliary features, may be printed using a reduced number of auxiliary features, or printed using spaced apart auxiliary features. Examples of an auxiliary support structure can be found in Patent Application Serial No. PCT/US15/36802 filed on Jun. 19, 2015, titled “APPARATUSES, SYSTEMS AND METHODS FOR THREE-DIMENSIONAL PRINTING,” which is entirely incorporated herein by reference in its entirety. The printed 3D object may comprise a single auxiliary support mark. The single auxiliary feature (e.g., auxiliary support or auxiliary structure) may be a platform (e.g., a building platform such as a base or substrate), or a mold. The auxiliary support may be adhered to the platform or mold. In some embodiments, the 3D object comprises a layered structure indicative of 3D forming procedure that is devoid of one or more auxiliary support features or one or more auxiliary support feature marks that are indicative of a presence or removal of the one or more auxiliary support features. Examples of auxiliary features comprise heat fins, wires, anchors, handles, supports, pillars, columns, frame, footing, scaffold, flange, projection, protrusion, mold (a.k.a. mould), or other stabilization features.

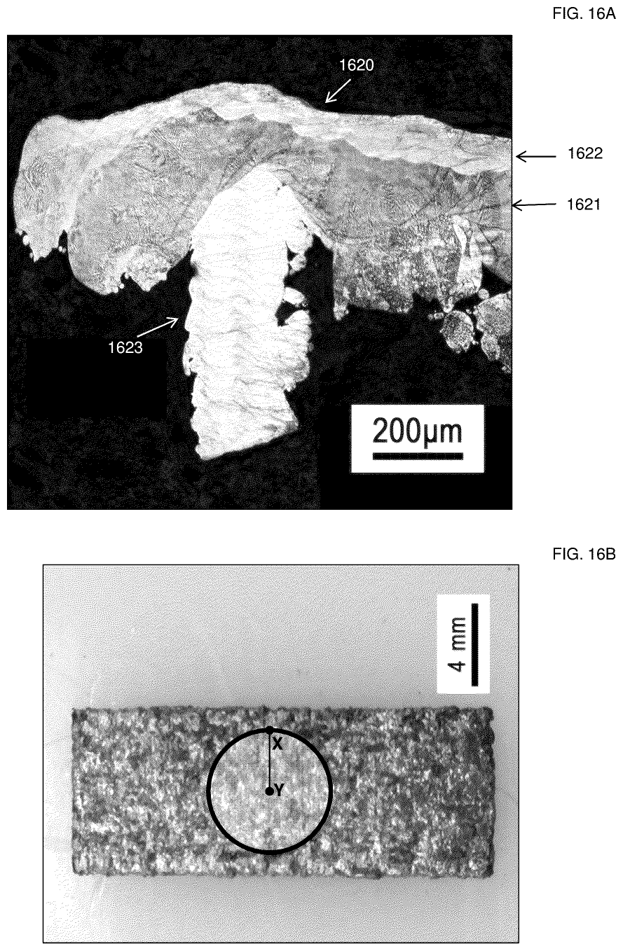

In some cases, the supports (or a portion thereof) are removed from the 3D object after printing. Removal can comprise machining (e.g., cutting, sawing and/or milling), polishing (e.g., sanding) and/or etching. Removal can comprise beam (e.g., laser) etching or chemical etching. In some cases, the supports (or a portion thereof) remain in and/or on the 3D object after printing. In some cases, the one or more supports leave respective one or more support marks on the 3D object that are indicative of a presence or removal of the one or more supports. FIG. 16A shows an example of a vertical cross section of a 3D object that includes a main portion 1620 coupled with a support 1623. In some cases, the main portion comprises multiple layers (e.g., 1621 and 1622) that were sequentially added (e.g., after formation of the support) during a printing operation. In some cases, the support causes one or more layers of the portion of the 3D object to deform during printing. Sometimes, the deformed layers form a detectable (e.g., visible) mark. The mark may be a region of discontinuity in the layer, such as a microstructure discontinuity and/or an abrupt microstructural variation (e.g., FIG. 16A). The discontinuity in the microstructure may be explained by an inclusion of a foreign object (e.g., the support). The microstructural variation may include (e.g., abruptly) altered melt pools and/or grain structure (e.g., crystals, e.g., dendrites) at or near the attachment point of the support. The microstructure variation may be due to differential thermal gradients due to the presence of the support. The microstructure variation may be due to a forced melt pool and/or layer geometry due to the presence of the support. The discontinuity may be at an external surface of the 3D object. The discontinuity may arise from inclusion of the support to the surface of the 3D object (e.g. and may be visible as a breakage of the support when removed from the 3D object (e.g., after printing). In some instances, the 3D object includes two or more support and/or support marks. If more than one support is used, the supports may be spaced apart by a (e.g., pre-determined) distance. FIG. 16B shows an example 3D object having points X and Y on a surface of the 3D object. In some embodiments, X is spaced apart from Y by a support spacing distance. For example, a sphere of radius XY that is centered at X may lack one or more supports (or one or more support marks).

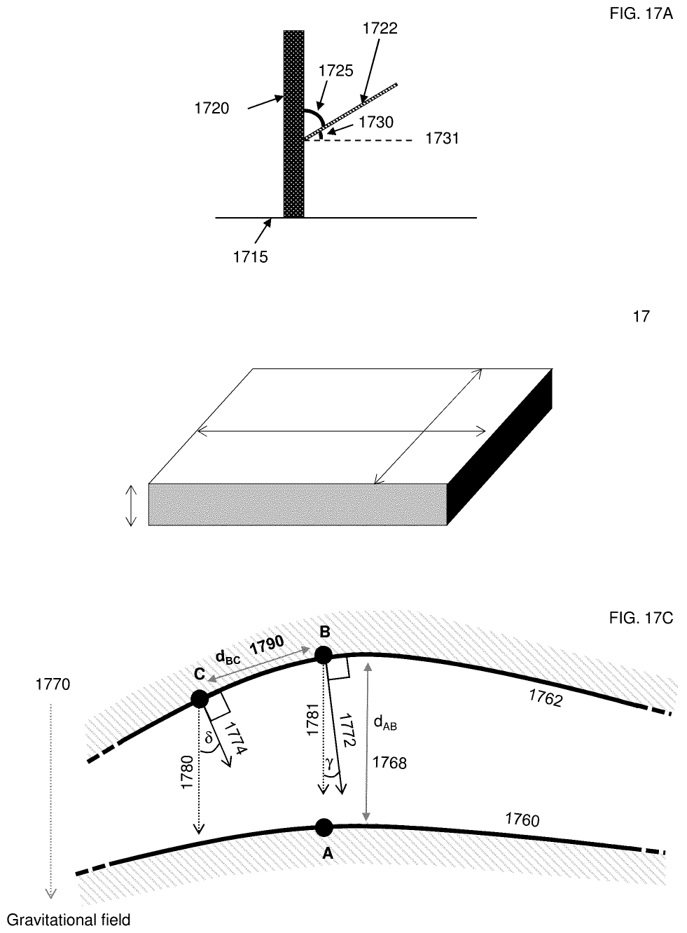

In some embodiments, an overhang is formed on a previously-transformed portion (also referred to herein as rigid portion) of the object. FIG. 17A shows an example schematic depiction of an overhang 1722 connected to a rigid portion 1720. The rigid portion may be connected (e.g., anchored) to a platform (e.g., FIG. 17A, 1715) (e.g., base of the platform). The overhang may be printed without auxiliary supports other than the connection to the one or more rigid portions (e.g., that are part of the 3D object). The overhang may be formed at an angle (e.g., FIG. 17A, 1730) with respect to the build plane and/or platform (e.g., FIG. 17A, 1715). The overhang and/or the rigid portion may be formed from the same or different pre-transformed material (e.g., powder). The overhang can form a first angle (e.g., FIG. 17A, 1725) with respect to the rigid portion (e.g., FIG. 17A, 1720). The overhang can form a second angle (e.g., FIG. 17A, 1730) with respect to a plane (e.g., FIG. 17A, 1731) that is (e.g., substantially) parallel with the support surface of the platform, to the layering plane, and/or normal to global vector (e.g., were the layer refer to the layerwise deposition of the transformed material to form the 3D object). In some embodiments, a plane (e.g., FIG. 17A, 1731) that is (e.g., substantially) parallel with the support surface of the platform corresponds to a layering plane.

In some embodiments, 3D printing methodologies are employed for forming (e.g., printing) at least one 3D object that is substantially two-dimensional, such as a wire or a planar object. The 3D object may comprise a plane-like structure (referred to herein as “planar object,” “three-dimensional plane,” or “3D plane”). The 3D plane may have a relatively small thickness as compared to a relatively large surface area. The 3D plane may have a relatively small height relative to its width and length. For example, the 3D plane may have a small height relative to a large horizontal plane. FIG. 17B shows an example of a 3D plane that is substantially planar (e.g., flat). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface. The one or more layers within the 3D object may be substantially planar (e.g., flat). The planarity of a surface or a boundary the layer may be (e.g., substantially) uniform. Substantially uniform may be relative to the intended purpose of the 3D object. The height of the layer at a position may be compared to an average layering plane. The layering plane can refer to a plane at which a layer of the 3D object is (e.g., substantially) oriented during printing. A boundary between two adjacent (printed) layers of hardened material of the 3D object may define a layering plane. The boundary may be apparent by, for example, one or more melt pool terminuses (e.g., bottom or top). A 3D object may include a plurality of layering planes (e.g., with each layering plane corresponding to each layer). In some embodiments, the layering planes are (e.g., substantially) parallel to one another. An average layering plane may be defined by a linear regression analysis (e.g., least squares planar fit of the top-most part of the surface of the layer of hardened material). An average layering plane may be a plane calculated by averaging the material height at each selected point on the top surface of the layer of hardened material. The selected points may be within a specified region of the 3D object. The deviation from any point at the surface of the planar layer of hardened material may be at most 20% 15%, 10%, 5%, 3%, 1%, or 0.5% of the height (e.g., thickness) of the layer of hardened material.

FIG. 17C shows an example of a first (e.g., top) surface 1760 and a second (e.g., bottom) surface 1762 of a 3D object. At least a portion of the first and second surface may be separated by a gap. At least a portion of the first surface may be separated from at least a portion of the second surface (e.g., to constitute a gap). The gap may be filled with pre-transformed or transformed (e.g., and subsequently hardened) material, e.g., during the formation of the 3D object. The second surface may be a bottom skin layer. FIG. 17C shows an example of a vertical gap distance 1740 that separates the first surface 1760 from the second surface 1762. Point A (e.g., in FIG. 17C) may reside on the top surface of the first portion. Point B may reside on the bottom surface of the second portion. The second portion may be a cavity ceiling or hanging structure as part of the 3D object. Point B (e.g., in FIG. 17C) may reside above point A. Above (e.g., top) may be with respect to a global vector 1700. For example, for two positions in a 3D printing system, a (e.g., second) position (e.g., FIG. 17C, B) that has a lower global vector value than a (e.g., first) position (e.g., FIG. 17, A) is above the (e.g., second) position. The gap may be the (e.g., shortest) distance (e.g., vertical distance) between points A and B. FIG. 17C shows an example of the gap 1768 that constitutes the shortest distance d_{AB} between points A and B. There may be a first normal to the bottom surface of the second portion at point B. FIG. 17C shows an example of a first normal 1772 to the surface 1762 at point B. The angle between the first normal 1772 and a direction of global vector 1770 may be any angle γ. A global vector may be (a) directed to a gravitational center, (b) directed opposite to the direction of a layer-wise deposition to print a three-dimensional object, and/or (c) normal to a platform configured to support the three-dimensional object during its printing, and directed opposite to a surface of the platform that supports the three-dimensional object. Point C may reside on the bottom surface of the second portion. There may be a second normal to the bottom surface of the second portion at point C. FIG. 17C shows an example of the second normal 1774 to the surface 1762 at point C. The angle between the second normal 1774 and the global vector 1770 may be any angle δ. Vectors 1780, and 1781 are parallel to the global vector 1770. The angles γ and δ may be the same or different. The angle between the first normal 1772 and/or the second normal 1774 to the global vector 1700 may be any angle alpha disclosed herein. For example, alpha may be at most about 45°, 40°, 30°, 20°, 10°, 5°, 3°, 2°, 1°, or 0.5°. The angle alpha may be any value of the afore-mentioned values (e.g., at most about 45° to about 0.5°, from about 45° to about 20°, or from about 20° to about 0.5°). Examples of an auxiliary support structure and auxiliary support feature spacing distance (e.g., the shortest distance between points B and C) can be found in Patent Application Serial No. PCT/US15/36802 filed on Jun. 19, 2015, titled “APPARATUSES, SYSTEMS AND METHODS FOR THREE-DIMENSIONAL PRINTING,” which is entirely incorporated herein by reference in its entirety. For example, the shortest distance BC (e.g., d_{BC}) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm 35 mm, 40 mm, 50 mm, 100 mm, 200 mm, 300 mm, 400 mm, or 500 mm. FIG. 17C shows an example of the shortest distance BC (e.g., 1790, d_{BC}). The bottom skin layer may be the first surface and/or the second surface. The bottom skin layer may be the first formed layer of the 3D object. The bottom skin layer may be a first formed hanging layer in the 3D object (e.g., that is separated by a gap from a previously formed layer of the 3D object). The vertical distance of the gap may be at least about 30 μm, 35 μm, 40 μm, 50 μm, 60 μm, 70 μm, 80 μm, 90 μm, 100 μm, 150 μm, 200 μm, 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm or 20 mm. The vertical distance of the gap may be any value between the afore-mentioned values (e.g., from about 30 μm to about 200 μm, from about 100 μm to about 200 μm, from about 30 μm to about 100 mm, from about 80 mm to about 150 mm, from about 0.05 mm to about 20 mm, from about 0.05 mm to about 0.5 mm, from about 0.2 mm to about 3 mm, from about 0.1 mm to about 10 mm, or from about 3 mm to about 20 mm).

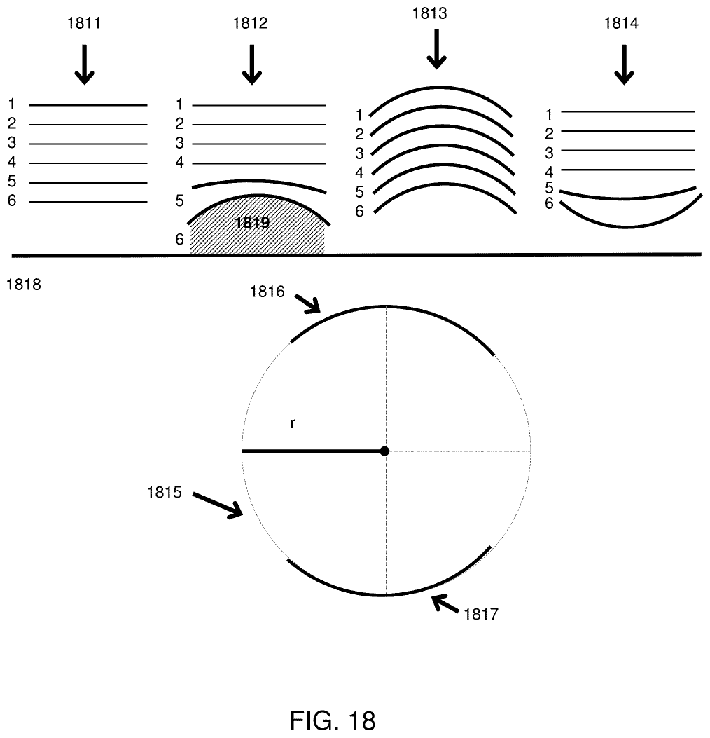

The one or more layers within the 3D object may be (e.g., substantially) planar (e.g., flat). The planarity of the layer may be (e.g., substantially) uniform. The height of the layer at a particular position may be compared to an average plane. The average plane may be defined by a least squares planar fit of the top-most part of the surface of the layer of hardened material. The average plane may be a plane calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The (e.g., substantially) planar one or more layers may have a large radius of curvature. An example of a layering plane can be seen in FIG. 18 showing a vertical cross section of a 3D object 1811 that comprises layers 1 to 6, each of which are substantially planar. FIG. 18 shows an example of a vertical cross section of a 3D object 1812 comprising planar layers (layers numbers 1-4) and non-planar layers (e.g., layers numbers 5-6) that have a radius of curvature. The curvature can be positive or negative with respect to the platform and/or the exposed surface of the material bed. For example, layered structure 1812 comprises layer number 6 that has a curvature that is negative, as the volume (e.g., area in a vertical cross section of the volume) bound from the bottom of it to the platform 1818 is a convex object 1819. Layer number 5 of 1812 has a curvature that is negative. Layer number 6 of 1812 has a curvature that is more negative (e.g., has a curvature of greater negative value) than layer number 5 of 1812. Layer number 4 of 1812 has a curvature that is (e.g., substantially) zero. Layer number 6 of 1814 has a curvature that is positive. Layer number 6 of 1812 has a curvature that is more negative than layer number 5 of 1812, layer number 4 of 1812, and layer number 6 of 1814. Layer numbers 1-6 of 1813 are of substantially uniform (e.g., negative curvature). FIGS. 18, 1816 and 1817 are super-positions of curved layer on a circle 1815 having a radius of curvature “r.” The one or more layers may have a radius of curvature equal to the radius of curvature of the layer surface. The radius of curvature may equal infinity (e.g., when the layer is flat). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or infinity (i.e., flat, or planar layer). The radius of curvature of the layer surface (e.g., all the layers of the 3D object) may have any value between any of the afore-mentioned values of the radius of curvature (e.g., from about 10 cm to about 90 m, from about 50 cm to about 10 m, from about 5 cm to about 1 m, from about 50 cm to about 5 m, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane). In some instances, part of at least one layer within the 3D object has the radius of curvature mentioned herein.

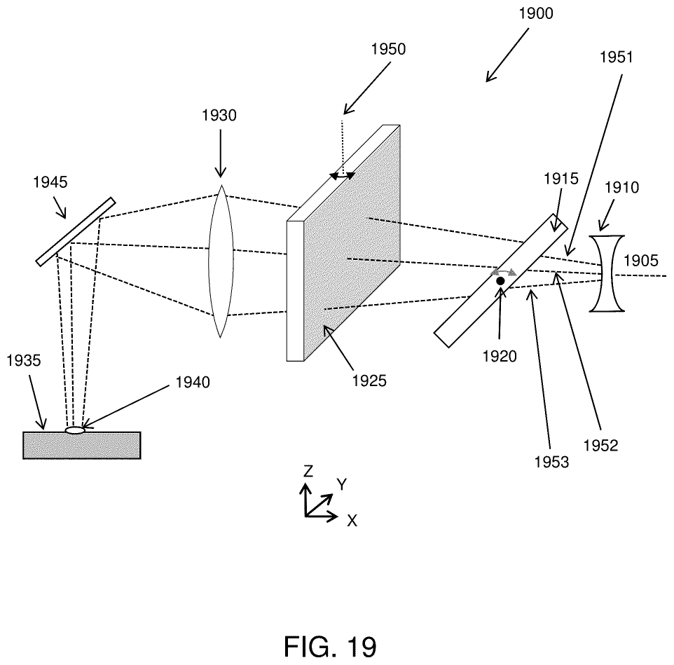

In some embodiments, an astigmatism system (e.g., FIG. 19, 1900) is operatively coupled to a manufacturing device that is configured for forming the 3D object. The astigmatism system may be disposed adjacent (e.g., in, or outside of) a processing chamber (e.g., FIG. 1, 126) in which a transforming agent generates the 3D object. The astigmatism system may be operatively coupled to an energy source, and/or to a controller. At least one element of the astigmatism system may be controlled before, after, and/or during at least a portion of the 3D printing (e.g., in real time). At least one element of the astigmatism system may be controlled manually and/or automatically (e.g., using a controller). The controller may provide integrated and/or adaptive control (e.g., as described herein). The controller may provide a control plan for a setpoint of a (e.g., degree of) astigmatism. The control plan of the astigmatism may be coordinated with a control plan of (i) an energy beam position, (ii) motion, (iii) intensity, and/or (iv) any combination thereof. The energy source may generate an energy beam (e.g., FIG. 19, 1905 depicting an energy beam). The astigmatism system may be used to modify an shape (e.g., cross-section) of the energy beam. For example, the astigmatism system may be used to form an elongated cross-sectional beam (e.g., narrow, and/or long, FIG. 19, 1940) that impinges on the target surface (e.g., 1935). The energy beam may be elongated along the X-Y plane (e.g., FIG. 19). At times, the footprint of the energy beam may be elongated by an energy beam perforation (e.g., an elongated slit) that the energy beam may be promoted to pass through. At times, the movement of the energy beam may be controlled to perform a scan or a retro scan to form an elongated energy beam footprint.

In some embodiments, the astigmatism system includes two or more optical elements (e.g., lenses, FIG. 19, 1910, 1930). The optical elements may diverge or converge an incident energy (e.g., beam) that travels therethrough. The optical elements may have a constant focus. The optical elements may have a variable focus. At times, the optical element may converge the rays of the energy beam. At times, the optical element may diverge the rays of the energy beam. For example, the first optical element may be a diverging lens. The astigmatism system may comprise one or more medias (e.g., 1915, 1925). The medium may have a high refractive index (e.g., a high refractive index relative to the wavelength of the incoming energy beam). At least one medium may be stationary or translating or rotating (e.g., rotating along an axis, FIG. 19, 1920, 1950). Translating and/or rotating may be performed before, after, or during at least a portion of the 3D printing. The first medium may translate and/or rotate along a different axis than the second medium. The translating axes of the mediums may be different than (e.g., perpendicular to) the traveling axis of the irradiating energy. For example, the first medium (e.g., 1915) may translate and/or rotate along the Z axis (e.g., 1920), the second medium (e.g., 1925) may translate and/or rotate along the Y axis (e.g., 1950), and the irradiating energy (e.g., 1905) may travel along the X axis. The distance between the media may be such that they do not collide with each other when translating and/or rotating (e.g., when both media are rotating simultaneously). The irradiating energy may be directed to the second medium after it emerges from the first medium. The first optical element (e.g., 1910) may direct the energy beam to a medium (e.g., an optical window, e.g., 1915). The medium may (e.g., substantially) allow the energy beam to pass through (e.g., may not absorb a substantial portion of the passing energy beam). Substantially may be relative to the intended purpose of the energy beam (e.g., to transform the pre-transformed material).

In some embodiments, the optical astigmatism of the irradiating energy refers to an elliptical cross section of the irradiating energy that differs from a circle. Without wishing to be bound to theory, the different paths (e.g., lengths thereof) of the various irradiating energy rays (e.g., 1951-1953), interacting with various thicknesses of the media (having an effective refractive index), may lead to an elongated cross section of the irradiating energy, and subsequently to an elongated footprint of the irradiating energy on the target surface. The relative position of the first media (e.g., optical window) and the second media may lead to an optical astigmatism. The degree and/or direction of the astigmatism may be varied (e.g., before, after, and/or during at least a portion of the 3D printing) according to a control plan. The variation may be in relation to the relative positioning of the two media. The degree and/or direction of the astigmatism may due to the relative positioning of the two media. The angular position of the media may be controlled (e.g., manually, and/or automatically) according to the control plan. For example, the angular position of the media may be controlled by at least one controllers. Controlling may include altering the angular position of the media relative to each other. Controlling may include altering the angular position not relative to each other (e.g., relative to the target surface and/or to the energy source). Controlling the degree of astigmatism may lead to controlling the length and/or width of the irradiating energy on the target surface. The irradiating energy may be directed to a second optical element (e.g., FIG. 19, 1930) from the (e.g., first or second) medium. The second optical element may be a converging lens. The converging lens may focus the irradiating energy after its emergence from the (e.g., first or second) medium. The converging lens may translatable (e.g., to vary the focus). The focusing power of the lens (e.g., converging lens) may be variable (e.g., electronically, magnetically, or thermally). The second optical element may be placed after the (e.g., first or second) medium. The energy beam may be directed (e.g., converged) on to a reflective element (e.g., mirror, FIG. 19, 1945) and/or a scanner. The energy beam may be directed (e.g., converged) on to a beam directing element. The beam directing (e.g., reflective) element may be translatable. The beam directing element may direct the energy beam to the target surface (e.g., material bed, FIG. 19, 1935). The directed energy beam may be an elongated energy beam. The mirror may be highly reflective mirror (e.g., Beryllium mirror).

At times, one or more controllers are configured to control (e.g., direct) one or more apparatuses and/or operations. Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The controller may comprise an electronic circuitry, and electrical inlet, or an electrical outlet. The configuration may comprise facilitating (e.g., and directing) an action or a force. The force may be magnetic, electric, pneumatic, hydraulic, and/or mechanic. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) that comprises a visual, auditory, olfactory, or a tactile signal.

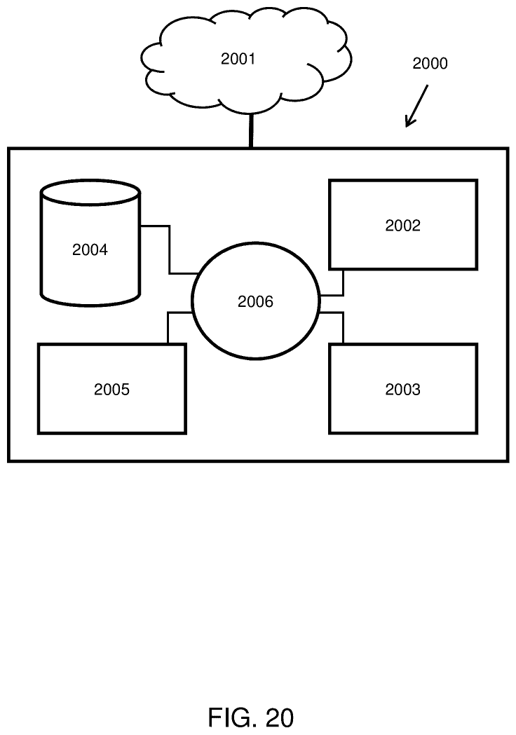

The controller may comprise processing circuitry (e.g., a processing unit). The processing unit may be central. The processing unit may comprise a central processing unit (herein “CPU”). The controllers or control mechanisms (e.g., comprising a computer system) may be configured to, e.g., programmed to implement methods of the disclosure. The controller may control at least one component of the systems and/or apparatuses disclosed herein. FIG. 20 is a schematic example of a computer system 2000 that is programmed or otherwise configured to facilitate the formation of a 3D object according to the methods provided herein. The computer system 2000 can control (e.g., direct and/or regulate) various features of printing methods, apparatuses and systems of the present disclosure, such as, for example, generation of forming instructions for formation of a 3D object. Generated forming instructions may comprise application of a pre-transformed material, application of an amount of energy (e.g., radiation) emitted to a selected location, a detection system activation and deactivation, sensor data and/or signal acquisition, image processing, process parameters (e.g., dispenser layer height, planarization, chamber pressure), or any combination thereof. The computer system 2000 can control at least one control variable (e.g., according to a control plan). The control plan may be formed (e.g., generated) considering forming instructions for a requested 3D object. The control may comprise integrated and/or adaptive control. The computer system 2000 can be part of, or be in communication with, a printing system or apparatus, such as a 3D printing system or apparatus of the present disclosure. The processor may be coupled to one or more mechanisms disclosed herein, and/or any parts thereof. For example, the computer may be coupled to one or more energy sources, optical elements, processing chamber, build module, platform, sensors, valves, switches, motors, pumps, or any combination thereof.

The computer system 2000 can include a processing unit 2006 (also “processor,” “computer” and “computer processor” used herein). The computer system may include memory or memory location 2002 (e.g., random-access memory, read-only memory, flash memory), electronic storage unit 2004 (e.g., hard disk), communication interface 2003 (e.g., network adapter) for communicating with one or more other systems, and peripheral devices 2005, such as cache, other memory, data storage and/or electronic display adapters. The memory 2002, storage unit 2004, interface 2003, and peripheral devices 2005 are in communication with the processing unit 2006 through a communication bus (solid lines), such as a motherboard. The storage unit can be a data storage unit (or data repository) for storing data. The computer system can be operatively coupled to a computer network (“network”) 2001 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 2002. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a system on module (SOM) a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 2000 can be included in the circuit.

The storage unit 2004 can store files, such as drivers, libraries, and saved programs. The storage unit can store user data, e.g., user preferences and user programs. The storage unit may store one or more geometric models. The storage unit may store at least one control variable plan. The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 2002 or electronic storage unit 2004. The machine executable or machine-readable code can be provided in the form of software. During use, the processor 2006 can execute the code. In some cases, the code can be retrieved from the storage unit and stored on the memory for ready access by the processor. In some situations, the electronic storage unit can be precluded, and machine-executable instructions are stored on memory.

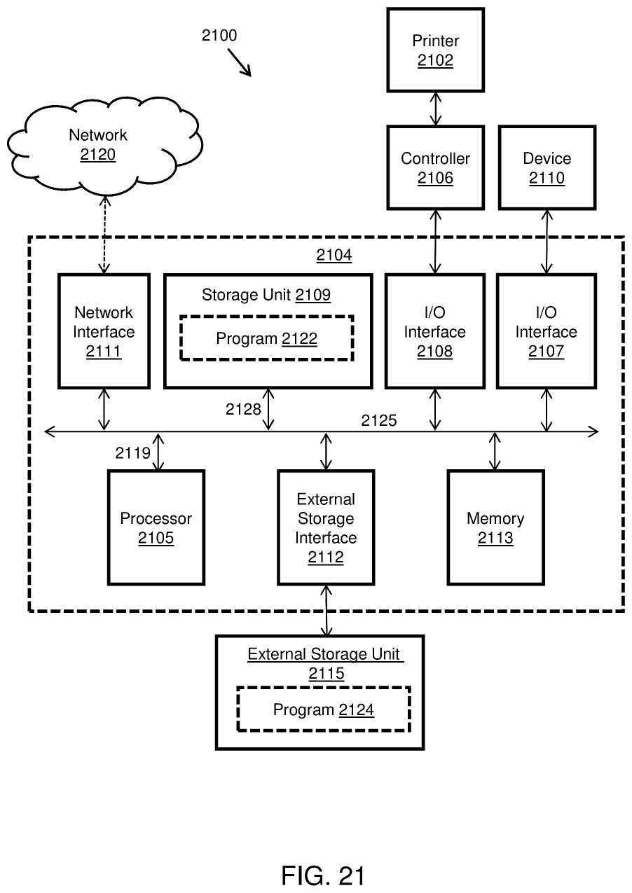

FIG. 21 shows an example computer system 2100, upon which the various arrangements described, can be practiced. The computer system (e.g., FIG. 21, 2100) can control and/or implement (e.g., direct and/or regulate) various features of printing methods, apparatus and/or system operations of the present disclosure. For example, the computer system can be used to instantiate a forming instructions engine. A forming instructions engine may generate instructions to control energy source parameters, processing chamber parameters (e.g., chamber pressure, gas flow and/or temperature), energy beam parameters (e.g., scanning rate, path and/or power), platform parameters (e.g., location and/or speed), layer forming apparatus parameters (e.g., speed, location and/or vacuum), or any combination thereof. A forming instructions engine may generate instructions for forming a 3D object in a layerwise (e.g., slice-by-slice) manner. The generated instructions may according to default and/or designated (e.g., override) forming (e.g., printing) processes. The forming instructions may be provided to at least one controller (e.g., FIG. 21, 2106). The at least one controller may provide integrated and/or adaptive control of at least one control variable. A control plan for the at least one control variable may be generated while considering the forming instructions. The computer system can be part of, or be in communication with, one or more 3D printers (e.g., FIG. 21, 2102) or any of their (e.g., sub-) components. The computer system can include one or more computers (e.g., FIG. 21, 2104). The computer(s) may be operationally coupled to one or more mechanisms of the printer(s). For example, the computer(s) may be operationally coupled to one or more sensors, valves, switches, actuators (e.g., motors), pumps, optical components, and/or energy sources of the printer(s). In some cases, the computer(s) controls aspects of the printer(s) via one or more controllers (e.g., FIG. 21, 2106). The controller(s) may be configured to direct one or more operations of the one or more printer(s). For example, the controller(s) may be configured to direct one or more actuators of printer(s). In some cases, the controller(s) is part of the computer(s) (e.g., within the same unit(s)). In some cases, the controller(s) is separate (e.g., a separate unit) from the computer(s). In some instances, the computer(s) communicates with the controller(s) via one or more input/output (I/O) interfaces (e.g., FIG. 21, 2108). The input/output (I/O) interface(s) may comprise one or more wired or wireless connections to communicate with the printer(s). In some embodiments, the I/O interface comprises Bluetooth technology to communicate with the controller(s).

The computer(s) (e.g., FIG. 21, 2104) may have any number of components. For example, the computer(s) may comprise one or more storage units (e.g., FIG. 21, 2109), one or more processors (e.g., FIG. 21, 2105), one or more memory units (e.g., FIG. 21, 2113), and/or one or more external storage interfaces (e.g., FIG. 21, 2112). In some embodiments, the storage unit(s) includes a hard disk drive (HDD), a magnetic tape drive and/or a floppy disk drive. In some embodiments, the memory unit(s) includes a random access memory (RAM) and/or read only memory (ROM), and/or flash memory. In some embodiments, the external storage interface(s) comprises a disk drive (e.g., optical or floppy drive) and/or a universal serial bus (USB) port. The external storage interface(s) may be configured to provide communication with one or more external storage units (e.g., FIG. 21, 2115). The external storage unit(s) may comprise a portable memory medium. The external storage unit(s) may be a non-volatile source of data. In some cases, the external storage unit(s) is an optical disk (e.g., CD-ROM, DVD, Blu-ray Disc™), a USB-RAM, a hard drive, a magnetic tape drive, and/or a floppy disk. In some cases, the external storage unit(s) may comprise a disk drive (e.g., optical or floppy drive). Various components of the computer(s) may be operationally coupled via a communication bus (e.g., FIG. 21, 2125). For example, one or more processor(s) (e.g., FIG. 21, 2105) may be operationally coupled to the communication bus by one or more connections (e.g., FIG. 21, 2119). The storage unit(s) (e.g., FIG. 21, 2109) may be operationally coupled to the communication bus one or more connections (e.g., FIG. 21, 2128). The communication bus (e.g., FIG. 21, 2125) may comprise a motherboard.

In some embodiments, methods described herein are implemented as one or more software programs (e.g., FIGS. 21, 2122 and/or 2124). The software program(s) may be executable within the one or more computers (e.g., FIG. 21, 2104). The software may be implemented on a non-transitory computer readable media. The software program(s) may comprise machine-executable code. The machine-executable code may comprise program instructions. The program instructions may be carried out by the computer(s) (e.g., FIG. 21, 2104). The machine-executable code may be stored in the storage device(s) (e.g., FIG. 21, 2109). The machine-executable code may be stored in the external storage device(s) (e.g., FIG. 21, 2115). The machine-executable code may be stored in the memory unit(s) (e.g., FIG. 21, 2113). The storage device(s) (e.g., FIG. 21, 2109) and/or external storage device(s) (e.g., FIG. 21, 2115) may comprise a non-transitory computer-readable medium. The processor(s) may be configured to read the software program(s) (e.g., FIGS. 21, 2122 and/or 2124). In some cases, the machine-executable code can be retrieved from the storage device(s) and/or external storage device(s), and stored on the memory unit(s) (e.g., FIG. 21, 2106) for access by the processor (e.g., FIG. 21, 2105). In some cases, the access is in real-time (e.g., during printing). In some situations, the storage device(s) and/or external storage device(s) can be precluded, and the machine-executable code is stored on the memory unit(s). The machine-executable code may be pre-compiled and configured for use with a machine have a processer adapted to execute the machine-executable code, or can be compiled during runtime (e.g., in real-time). The machine-executable code can be supplied in a programming language that can be selected to enable the machine-executable code to execute in a pre-compiled or as-compiled fashion.

In some embodiments, the computer(s) is operationally coupled with, or comprises, one or more devices (e.g., FIG. 21, 2110). In some embodiments, the device(s) (e.g., FIG. 21, 2110) is configured to provide one or more (e.g., electronic) inputs to the computer(s). In some embodiments, the device(s) (e.g., FIG. 21, 2110) is configured to receive one or more (e.g., electronic) outputs from the computer(s). The computer(s) may communicate with the device(s) via one or more input/output (I/O) interfaces (e.g., FIG. 21, 2107). The input/output (I/O) interface(s) may comprise one or more wired or wireless connections. The device(s) can include one or more user interfaces (UI). The UI may include one or more keyboards, one or more pointer devices (e.g., mouse, trackpad, touchpad, or joystick), one or more displays (e.g., computer monitor or touch screen), one or more sensors, and/or one or more switches (e.g., electronic switch). In some cases, the UI may be a web-based user interface. At times, the UI provides a model design or graphical representation of a 3D object to be printed. The sensor(s) may comprise a light sensor, a thermal sensor, an audio sensor (e.g., microphone), and/or a tactile sensor. In some cases, the sensor(s) are part of the printer(s) (e.g., FIG. 21, 2102). For example, the sensor(s) may be located within a processing chamber of a printer (e.g., to monitor an atmosphere therein). The sensor(s) may be configured to monitor one or more signals (e.g., thermal and/or light signal) that is generated during a printing operation. In some cases, the sensor(s) are part of a component or apparatus that is separate from the printer(s). In some cases, the device(s) is a pre-printing processing apparatus. For example, in some cases, the device(s) can be one or more scanners (e.g., 2D or 3D scanner) for scanning (e.g., dimensions of) a 3D object. In some cases, the device(s) is a post-printing processing apparatus (e.g., a docking station, unpacking station, and/or a hot isostatic pressing apparatus). In some embodiments, the I/O interface comprises Bluetooth technology to communicate with the device(s).

In some embodiments, the computer(s) (e.g., FIG. 21, 2104), controller(s) (e.g., FIG. 21, 2106), printer(s) (e.g., FIG. 21, 2102) and/or device(s) (e.g., FIG. 21, 2110) comprises one or more communication ports. For example, one or more I/O interfaces (e.g., FIG. 21, 2107 or 2108) can comprise communication ports. The communication port(s) may be a serial port or a parallel port. The communication port(s) may be a Universal Serial Bus port (i.e., USB). The USB port can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10 h, 11 h, DCh, E0 h, EFh, FEh, or FFh. The communication port(s) may comprise a plug and/or a socket (e.g., electrical, AC power, DC power). The communication port(s) may comprise an adapter (e.g., AC and/or DC power adapter). The communication port(s) may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the computer(s) is configured to communicate with one or more networks (e.g., FIG. 21, 2120). The network(s) may comprise a wide-area network (WAN) or a local area network (LAN). In some cases, the computer(s) includes one or more network interfaces (e.g., FIG. 21, 2111) that is configured to facilitate communication with the network(s). The network interface(s) may include wired and/or wireless connections. In some embodiments, the network interface(s) comprises a modulator demodulator (modem). The modem may be a wireless modem. The modem may be a broadband modem. The modem may be a “dial up” modem. The modem may be a high-speed modem. The WAN can comprise the Internet, a cellular telecommunications network, and/or a private WAN. The LAN can comprise an intranet. In some embodiments, the LAN is operationally coupled with the WAN via a connection, which may include a firewall security device. The WAN may be operationally coupled the LAN by a high capacity connection. In some cases, the computer(s) can communicate with one or more remote computers via the LAN and/or the WAN. In some instances, the computer(s) may communicate with a remote computer(s) of a user (e.g., operator). The user may access the computer(s) via the LAN and/or the WAN. In some cases, the computer(s) (e.g., FIG. 21, 2104) store and/or access data to and/or from data storage unit(s) that are located on one or more remote computers in communication via the LAN and/or the WAN. The remote computer(s) may be a client computer. The remote computer(s) may be a server computer (e.g., web server or server farm). The remote computer(s) can include desktop computers, personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants.

At times, the processor (e.g., FIG. 21, 2105) includes one or more cores. The computer system may comprise a single core processor, a multiple core processor, or a plurality of processors for parallel processing. The processor may comprise one or more central processing units (CPU) and/or graphic processing units (GPU). The multiple cores may be disposed in a physical unit (e.g., Central Processing Unit, or Graphic Processing Unit). The processor may be a single physical unit. The physical unit may be a die. The physical unit may comprise cache coherency circuitry. The processor may include multiple physical units. The physical unit may comprise an integrated circuit chip. The integrated circuit chip may comprise one or more transistors. The integrated circuit chip may comprise at least about 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The multiple cores may be disposed in close proximity. The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processors may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS, or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

At times, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processor(s) may be able to process algorithms comprising a matrix or a vector. The core may comprise a complex instruction set computing core (CISC), or reduced instruction set computing (RISC).

At times, the computer system includes an electronic chip that is reprogrammable (e.g., field programmable gate array (FPGA), e.g., application programming unit (APU)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

At times, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, APU, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

At times, the computing system includes an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the afore-mentioned times (e.g., from about 0.1 μs, to about 1 ms, from about 0.1 μs, to about 100 μs, or from about 0.1 μs to about 10 μs).

In some instances, the controller(s) (e.g., FIG. 21, 2106) uses real time measurements and/or calculations to regulate one or more components of the printer(s). In some cases, the controller(s) regulate characteristics of the energy beam(s). The sensor(s) (e.g., on the printer) may provide a signal (e.g., input for the controller and/or processor) at a rate of at least about 0.1 KHz, 1 KHz, 10 KHz, 100 KHz, 1000 KHz, or 10000 KHz). The sensor(s) may be a temperature and/or positional sensor(s). The sensor(s) may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processor(s) may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during at least a portion of the 3D printing process. The real-time measurements may be in-situ measurements in the 3D printing system and/or apparatus. The real-time measurements may be during at least a portion of the formation of the 3D object. In some instances, the processor(s) may use the signal obtained from the at least one sensor to provide a processor(s) output, which output is provided by the processing system at a speed of at most about 100 minute (min), 50 min, 25 min, 15 min, 10 min, 5 min, 1 min, 0.5 min (i.e., 30 seconds (sec)), 15 sec, 10 sec, 5 sec, 1 sec, 0.5 sec, 0.25 sec, 0.2 sec, 0.1 sec, 80 milliseconds (ms), 50 ms, 10 ms, 5 ms, or 1 ms. In some instances, the processor(s) may use the signal obtained from the at least one sensor to provide a processor(s) output, which output is provided at a speed of any value between the aforementioned values (e.g., from about 100 min to about 1 ms, from about 100 min to about 10 min, from about 10 min to about 1 min, from about 5 min to about 0.5 min, from about 30 sec to about 0.1 sec, or from about 0.1 sec to about 1 ms). The processor(s) output may comprise an evaluation of the attribute (e.g., temperature) at a location, position at a location (e.g., vertical and/or horizontal), or a map of locations. The location may be on the target surface. The map may comprise a topological and/or attribute (e.g., temperature) related map.

At times, the processor(s) (e.g., FIG. 21, 2105) uses the signal obtained from one or more sensors (e.g., on the printer) in an algorithm that is used in controlling the energy beam. The algorithm may comprise the path of the energy beam. In some instances, the algorithm may be used to alter the path of the energy beam on the target surface. The path may deviate from a cross section of a model corresponding to the requested 3D object. The processor may use the output in an algorithm that is used in determining the manner in which a model of the requested 3D object may be sliced. The processor may use the signal obtained from the at least one sensor in an algorithm that is used to configure one or more parameters and/or apparatuses relating to the 3D printing procedure. The parameters may comprise a characteristic of the energy beam. The parameters may comprise movement of the platform and/or material bed. The parameters may include characteristics of the gas flow system. The parameters may include characteristics of the layer forming apparatus. The parameters may comprise relative movement of the energy beam and the material bed. In some instances, the energy beam, the platform (e.g., material bed disposed on the platform), or both may translate. Alternatively, or additionally, the controller(s) (e.g., FIG. 21, 2110) may use historical data for the control. Alternatively, or additionally, the processor may use historical data in its one or more algorithms. The parameters may comprise the height of the layer of pre-transformed material disposed in the enclosure and/or the gap by which the cooling element (e.g., heat sink) is separated from the target surface. The target surface may be the exposed layer of the material bed.

At times, the memory (e.g., FIG. 21, 2106) comprises a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complement to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

At times, all or portions of the software program(s) (e.g., FIG. 21, 2127) are communicated through the WAN or LAN networks. Such communications, for example, may enable loading of the software program(s) from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software program(s). As used herein, unless restricted to non-transitory, tangible “storage” media, terms such as computer or machine “readable medium” refer to any medium that participates in providing instructions to a processor for execution. Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and/or infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

At times, the computer system monitors and/or controls various aspects of the 3D printer(s). In some cases, the control is via controller(s) (e.g., FIG. 21, 2106). The control may be manual and/or programmed. The control may comprise an open loop control or a closed loop control (e.g., including feed forward and/or feedback) control scheme. The closed loop control may utilize signals from the one or more sensors. The control may utilize historical data. The control scheme may be pre-programmed. The control scheme may consider an input from one or more sensors (described herein) that are connected to the control unit (i.e., control system or control mechanism) and/or processor(s). The computer system (including the processor(s)) may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output a (e.g., current, or historical) state of at least one control variable that is controlled via integrated and/or adaptive control. The output may comprise an indication of (e.g., which of) at least two control variables that are controlled via integrated control. The output may comprise an indication of (e.g., any) processing operation that comprises adaptive control. The output may comprise an indication of (e.g., a duration) of an adaptive timing for the processing operation that is under adaptive control. The computer may generate a report comprising various parameters of the 3D printing system, method, and or objects at predetermined time(s), on a request (e.g., from an operator), and/or at a whim. The output unit may comprise a screen, printer, a light source (e.g., lamp), or speaker. The control system may provide a report. The report may comprise any items recited as optionally output by the output unit.

At times, the systems, methods, and/or apparatuses disclosed herein comprise providing coordinated (e.g., integrated) and/or adaptive control of at least one process variable for forming a requested 3D object. The process variable and/or attribute may be (e.g., at least indirectly) controlled as a control variable. The control variable and/or attribute may be controlled according to a control plan. A control plan may be formed considering forming instructions for a requested 3D object. The request can include a geometric model (e.g., a CAD file) of the requested 3D object. Alternatively, or additionally, a model of the requested 3D object may be generated. The model may be used to generate 3D forming instructions. The software program(s) (e.g., FIGS. 21, 2122 and/or 2124) may comprise the 3D forming instructions. The 3D forming instructions may exclude the 3D model. The 3D forming instructions may be based on the 3D model. The 3D forming instructions may take the 3D model into account. The 3D forming instructions may be alternatively or additionally based on simulations (e.g., a predictor model). The 3D forming instructions may use the 3D model. The 3D forming instructions may comprise using a calculation (e.g., embedded in a software program(s)) that considers the 3D model, simulations, historical data, sensor input, or any combination thereof. The 3D forming instructions may be provided to at least one controller (e.g., FIG. 21, 2106) that provides integrated (e.g., coordinated) and/or adaptive control of at least one control variable. The coordinated control may comprise contemporaneous control of (e.g., between) at least two control variables. The integrated and/or adaptive control may comprise computing a calculation. The at least one controller may compute the calculation during the 3D forming procedure (e.g., in real-time), during the formation of the 3D object, prior to the 3D forming procedure, after the 3D forming procedure, or any combination thereof. The at least one controller may compute the calculation in the interval between activations of a transforming agent. For example, between pulses of an energy beam, during the dwell time of the energy beam, before the energy beam translates to a new position, while the energy beam is not translating, while the energy beam does not impinge upon the target surface, while the (e.g., at least one) energy beam impinges upon the target surface, or any combination thereof. For example, between depositions of a binding agent, during a persistence time of the binding agent, before a dispenser (e.g., that provides the binding agent) translates to a new position, while the dispenser is not translating, while the binding agent is not provided to the target surface, while the binding agent is provided to the target surface, or any combination thereof. The processor may compute the calculation in the interval between a movement of at least one guidance (e.g., optical) element from a first position to a second position, while the at least one optical element moves (e.g., translates) to a new (e.g., second) position. For example, the processor(s) may compute the calculation while the energy beam translates and does substantially not impinge upon the exposed surface. For example, the processor(s) may compute the calculation while the energy beam does not translate and impinges upon the exposed surface. For example, the processor(s) may compute the calculation while the energy beam does not substantially translate and does substantially not impinge upon the exposed surface. For example, the processor(s) may compute the calculation while the energy beam does translate and impinges upon the exposed surface. The transforming agent may be provided along a path that corresponds to a cross section of the model of the 3D object. For example, a translation of the energy beam may be translation along at least one energy beam path. For example, a dispenser movement may be along at least one dispenser path.

### EXAMPLES

The following are illustrative and non-limiting examples of methods of the present disclosure.

### Example 1

In a 320 mm diameter and 400 mm maximal height container at ambient temperature, Inconel 718 powder of average particle size 35 μm was deposited in a container to form a powder bed. The container was disposed in an enclosure to separate the powder bed from the ambient environment. The enclosure was purged with Argon gas. A controller (e.g., FIG. 11, 1100) was used to command a 1000 W fiber laser beam to melt a portion of the powder bed in a series of five (5) processing operations (e.g., FIGS. 12, 1230, 1235, 1240, 1245, and 1250) to form a portion of a 3D object above a platform. The controller employed a power forwarding operation at the completion of the first processing operation (e.g., FIG. 12, 1230) to modify the power setpoint of the fiber laser (e.g., during the inactive operation 1235) to a value corresponding to the initial value of the third processing operation (e.g., FIG. 12, 1240). The portion of the 3D object was printed using 3D printing that included layer-wise melting powder material disposed in sequential layers, according to slices of a requested 3D object. The power layers had an average thickness of about 50 μm.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-188. (canceled)

189. An apparatus for printing a three-dimensional object, the apparatus comprising at least one controller configured to:
(a) operatively couple with (i) a first component utilized during the printing of the three-dimensional object, (ii) a second component utilized during the printing of the three-dimensional object, (iii) at least one sensor, and (iv) a transforming agent;
(b) direct the first component to execute a first process parameter at a first time according to a first plan;
(c) direct the second component to execute a second process parameter at a second time according to a second plan;
(d) direct the at least one sensor to measure an attribute of the printing of the three-dimensional object, wherein the three-dimensional object is printed at least in part by using the transforming agent to transform a pre-transformed material to a transformed material; and
(e) coordinate the first time with the second time to reach a target attribute profile of the attribute at least in part by being configured to direct use of skywriting during a first period, wherein during the skywriting the at least one controller is configured to direct the transforming agent not to transform the pre-transformed material to the transformed material while the transforming agent propagates along a trajectory of the skywriting during the first period; and wherein during a second period the at least one controller is configured to direct the transforming agent to transform the pre-transformed material to the transformed material to print the three-dimensional object.

190. The apparatus of claim 189, wherein the transforming agent comprises an energy beam; and wherein during the skywriting, the at least one controller is configured to direct the energy beam to, while propagating along the trajectory, (i) not irradiate the pre-transformed material, or (ii) irradiate the pre-transformed material in an intensity insufficient to transform the pre-transformed material to the transformed material.

191. The apparatus of claim 189, wherein the trajectory is a first trajectory, and wherein the at least one controller is configured to direct the transforming agent to transform the pre-transformed material to the transformed material while the transforming agent propagates along a second trajectory and along a third trajectory, the first trajectory being disposed between (a) the second trajectory and (b) the third trajectory.

192. The apparatus of claim 191, wherein the at least one controller is configured to direct the use of the skywriting along the first trajectory at least in part by being configured to execute, or direct execution of, blending (i) a first control variable values of the second trajectory and (ii) a second control variable values of the third trajectory.

193. The apparatus of claim 192, wherein the at least one controller is configured to (i) direct the first component to execute the first process parameter at least in part by executing a first command, and (ii) direct the second component to execute the second process parameter at least in part by executing a second command; and wherein the at least one controller is configured to coordinate, or direct coordination of, the printing during propagation along the second trajectory with the printing during propagation along the third trajectory to reach the target attribute profile of the attribute at least in part by using the skywriting during the first period.

194. The apparatus of claim 193, wherein the at least one controller is configured to execute, or direct execution of, the blending at least in part by being configured to transition, or direct the transition, between the first command and the second command via a skywriting command join occurring during the skywriting of the first period.

195. The apparatus of claim 189, wherein the attribute of the printing comprises (i) a temperature at a target surface or (ii) an intensity of the transforming agent.

196. The apparatus of claim 189, wherein the at least one controller is configured to (a) execute, or direct execution of, the first process parameter while measuring the attribute of the printing, and (b) execute, or direct execution of, the second process parameter while measuring the attribute of the printing.

197. The apparatus of claim 189, further comprising utilizing the first period of the skywriting to adjust one or more control variables comprising (i) at least one transforming agent characteristic, (ii) a setpoint of an output power of a source of the transforming agent, or (iii) a setpoint of the attribute being a temperature.

198. The apparatus of claim 189, wherein (I) the pre-transformed material comprises a material comprising an elemental metal, a metal alloy, a ceramic, or an allotrope of elemental carbon, and/or (II) the pre-transformed material comprises a particulate material.

199. The apparatus of claim 189, wherein the printing is conducted in an enclosure comprising an internal atmosphere different than an ambient atmosphere external to the enclosure.

200. The apparatus of claim 199, wherein the internal atmosphere comprises a reactive species configured to react during the printing (i) with the transformed material and/or (ii) with the pre-transformed material, the reactive species being in the internal atmosphere at a level below its level in the ambient atmosphere external to the enclosure.

201. The apparatus of claim 189, wherein the attribute is of the three-dimensional object, the attribute comprising a crystal phase, a surface morphology, a solid morphology, stress, strain, or a defect.

202. The apparatus of claim 201, wherein the solid morphology comprises a metallurgical phase.

203. The apparatus of claim 201, wherein the attribute comprises a change in polarization of reflected light from a target surface.

204. The apparatus of claim 203, wherein the target surface comprises: (i) an exposed surface of a material bed from which the three-dimensional object is printed, (ii) a surface of the three-dimensional object, (iii) a surface of a melt pool generated to print the three-dimensional object, (iv) a surface of a portion of the transformed material, or (v) any combination of (i) (ii) (iii) and (iv).

205. The apparatus of claim 203, wherein the target surface comprises an exposed surface of a material bed from which the three-dimensional object is printed.

206. The apparatus of claim 189, wherein the attribute comprises specular reflection.

207. The apparatus of claim 206, wherein the specular reflection is from a target surface.

208. The apparatus of claim 207, wherein the target surface comprises: (i) an exposed surface of a material bed from which the three-dimensional object is printed, (ii) a surface of the three-dimensional object, (iii) a surface of a melt pool generated to print the three-dimensional object, (iv) a surface of a portion of the transformed material, or (v) any combination of (i) (ii) (iii) and (iv).

209. The apparatus of claim 207, wherein the target surface comprises an exposed surface of a material bed from which the three-dimensional object is printed.

210. The apparatus of claim 189, wherein the attribute includes a metrology comprising (I) a target surface height at a position or (II) a target surface planarity being an average of the target surface planarity or a mean of the target surface planarity.

211. The apparatus of claim 210, wherein the target surface comprises (i) an exposed surface of a material bed from which the three-dimensional object is printed, (ii) a surface of the three-dimensional object, (iii) a surface of a melt pool generated to print the three-dimensional object, (iv) a surface of a portion of the transformed material, or (v) any combination of (i) (ii) (iii) and (iv).

212. The apparatus of claim 210, wherein the target surface comprises an exposed surface of a material bed from which the three-dimensional object is printed.

213. A system for printing a three-dimensional object, the system comprising a three-dimensional printer and the apparatus of claim 189.

214. A method of printing the three-dimensional object, the method comprising: (a) providing the apparatus of claim 189; and (b) using the apparatus for printing the three-dimensional object.

215. Non-transitory computer readable program instructions, the program instructions, when executed by at least one processing unit operatively coupled with a three-dimensional printer, cause the at least one processing unit to execute one or more operations associated with the apparatus of claim 189, the non-transitory computer readable program instructions being inscribed on at least one medium.
